(19) United States
(12) Patent Application Publication
(10) Pub. No.: US 2025/0307627 A1
(43) Pub. Date: Oct. 2, 2025

(54) UPDATING OF PARAMETERS OF NEURAL NETWORK MODEL FOR EFFICIENT EXECUTION ON NEURAL PROCESSING UNIT

(71) Applicant: DEEPX CO., LTD., Seongnam-si (KR)

(72) Inventors: Jang Min SON, Suwon-si (KR); Lok Won KIM, Yongin-si (KR); You Jun KIM, Suwon-si (KR)

(21) Appl. No.: 18/824,024

(22) Filed: Sep. 4, 2024

(30) Foreign Application Priority Data
Mar. 26, 2024 (KR) 10-2024-0041146

(51) Int. Cl. G06N 3/08; G06N 3/042

(52) U.S. Cl. CPC G06N 3/08; G06N 3/042

(57) ABSTRACT

Embodiments relate to converting functions or function call instructions of a first neural network (NN) model into graph module. The relationship between one or more inputs and one or more outputs of the graph modules are analyzed. A second neural network (NN) model in a form of a directed acyclic graph (DAG) including using the graph modules is generated by mapping inputs and outputs of the graph modules based on the relationship. Markers are added to the graph modules in the second NN model. First calibration data is generated by collecting input values and output values of each of the graph modules using the markers. An adjustment value for outlier alleviation for each of the graph modules is generated based on the first calibration data. For each graph module of the second NN model, an input parameter and a weight parameter are updated based on the adjustment value.

### CROSS-REFERENCE TO RELATED APPLICATION

This application claims priority to Republic of Korea Patent Application No. 10-2024-0041146 filed on Mar. 26, 2024, in the Korean Intellectual Property Office, which is incorporated herein by reference in its entirety.

### BACKGROUND OF THE DISCLOSURE

### Technical Field

The present disclosure relates to techniques for optimizing neural network models operating on low-power neural processing units at the edge devices.

### Background Art

The human brain is made up of tons of nerve cells called neurons. Each neuron is connected to hundreds to thousands of other neurons through connections called synapses. To mimic human intelligence, modeling the behavior of biological neurons and the connections between them is called a neural network (NN) model. In other words, a neural network is a system of nodes that mimic neurons, connected in a layer structure.

These neural network models are categorized into “single-layer neural networks” and “multi-layer neural networks” based on the number of layers. A typical multilayer neural network consists of an input layer, a hidden layer, and an output layer. The input layer is the layer that receives external data, and the number of neurons in the input layer can correspond to the number of input variables. At least one hidden layer is located between the input and output layers and receives signals from the input layer, extracts characteristics and passes them to the output layer. The output layer receives signals from the at least one hidden layer and outputs them to the outside world. The input signals between neurons are multiplied by their respective connection strengths, which have a value between 0 and 1, and then summed up, and if the sum is greater than the neuron's threshold, the neuron is activated and output as an output value through the activation function.

On the other hand, in order to realize higher artificial intelligence, the number of hidden layers of neural networks is increased, and it is called a deep neural network (DNN). There are many types of DNNs, but a convolutional neural network (CNN) is known to easily extract features of input data and identify patterns of features. A CNN is a neural network that functions similarly to how the visual cortex of the human brain processes images. CNNs are well suited for image processing.

A CNN may include a loop of convolutional and pooling channels. In a CNN, most of the computation time is taken up by convolutional operations. CNNs recognize objects by extracting the features of each channel's image by a matrix-like kernel and providing homeostasis such as translation and distortion by pooling. In each channel, a feature map is obtained by convolution of the input data and the kernel, and an activation function such as rectified linear unit (ReLU) is applied to generate an activation map for that channel and pooling can then be applied thereafter. The neural network that classifies the pattern is located at the end of the feature extraction neural network and is called the fully connected layer. In the computational processing of a CNN, most of the computation is done through convolutional or matrix operations.

With the development of AI inference capabilities, various electronic devices such as AI speakers, smartphones, smart refrigerators, VR devices, AR devices, AI CCTV, AI robot vacuum cleaners, tablets, laptops, self-driving cars, bipedal robots, quadrupedal robots, industrial robots, and the like are providing various inference services such as sound recognition, speech recognition, image recognition, object detection, driver drowsiness detection, danger moment detection, and gesture detection using AI.

With the recent development of deep learning technology, the performance of neural network inference services is improving through big data-based learning. These neural network inference services repeatedly train a large amount of training data on a neural network, and infer various complex data through the trained neural network model. Therefore, various services are being provided to the above-mentioned electronic devices by utilizing neural network technology. In addition, in recent years, neural processing units (NPUs) have been developed to accelerate the computation speed for artificial intelligence (AI).

However, as the capabilities and accuracy required for inference services utilizing neural networks are increasing, the data size, computational power, and training data of neural network models are increasing exponentially. As a result, the performance requirements of processors and memory to handle the inference operations of these neural network models are becoming increasingly demanding.

### SUMMARY OF THE DISCLOSURE

Embodiments relate to converting one or more functions or function call instructions of a first neural network (NN) model into one or more graph modules where one or more inputs and outputs of the one or more graph modules are traceable. The relationship between the one or more inputs and the one or more outputs of the one or more graph modules is analyzed. A second neural network (NN) model including the one or more graph modules as one or more nodes of a directed acyclic graph (DAG) is generated by coupling the one or more inputs and outputs of the graph modules according to the relationship. One or more markers for collecting values from at least part of the one or more inputs and outputs of the one or more graph modules in the second NN model are added. A first calibration data is determined by analyzing the collected values. Based on the first calibration data, an adjustment value to mitigate outliers for at least one of the graph modules is determined. An input parameter and a weight parameter for the at least one of the graph modules of the second NN model are updated into an updated input parameter and an updated weight parameter based on the adjustment value to improve performance of the second NN model.

In one or more embodiments, the at least one of the graph modules performs a multiply and accumulate (MAC) operation using the updated input parameter and the updated weight parameter as operands.

In one or more embodiments, a result of the MAC operation by the at least one of the graph modules using the input parameter and the weight parameter as operands and is the same as the MAC operation result using the updated input parameter and the updated weight parameter as operands.

In one or more embodiments, the adjustment value is determined using a maximum of absolute values for each channel of the input parameter and a maximum of absolute values for each channel of the weight parameter.

In one or more embodiments, the adjustment value is a set comprising a plurality of constant values for the input parameter and the weight parameter. The number of elements in the set of the adjustment value corresponds to a number of channels of the input parameter and the weight parameter.

In one or more embodiments the adjustment value is obtained by a mathematical formula

$$adPi = \sqrt{\frac{\vert {Amax}_{i} \vert}{\vert {Wmax}_{i} \vert}} ,$$

wherein adPi is an adjustment value for channel i, Amaxi represents a maximum value among absolute values of all elements of the channel i of the input parameter, and Wmaxi represents a maximum value among absolute values of all elements of the channel i of the weight parameter.

In one or more embodiments, wherein the updated input parameter is multiplication of the input parameter by a reciprocal of the adjustment value, and the updated weight parameter is multiplication of the weight parameter by the adjustment value.

In one or more embodiments, a second calibration data is generated by collecting input values and output values of the at least one of the graph modules according to a dataset for calibration using corresponding ones of the one or more markers. A scale value and an offset value applicable to the second NN model are determined based on the second calibration data.

In one or more embodiments, the scale value and the offset value are obtained by an equation below,

$$scale = \frac{max - min}{{2}^{bitwidth} - 1} , offset = \frac{- min}{scale}$$

where max represents a maximum value among the input values and output values collected for the second calibration data, min represents a minimum value among the input values and output values collected for the second calibration data, and bitwidth represents a target quantization bitwidth.

In one or more embodiments, a convolution operation in the second NN model is expressed as:

$${feature\_out}_{fp} = ( ⌊ \frac{{feature\_in}_{fp} - {o}_{f}}{{s}_{f}} ⌋ \times {s}_{f} + {o}_{f} ) ⊗ ⌊ \frac{{weight}_{fp}}{{s}_{w}} ⌋ \times {s}_{w}$$

where feature_in_{fp} represents an input feature map parameter in a form of floating-point, weight_{fp} represents a weight parameter in a form of floating-point, of represents an offset value for an input feature map, s_{f} represents a scale value for the input feature map, s_{w} represents the scale value for a weight, and └ ┘ represents a round and clip operation.

In one or more embodiments, generating, based on the scale value and the offset value, a third neural network (NN) model including a quantized weight parameter as an integer is generated, based on the second NN model.

In one or more embodiments, a convolution operation in the third NN model is expressed as: feature_outᵢₙₜ=feature_inᵢₙₜ ⊗weightᵢₙₜ

where feature_outᵢₙₜ represents an output feature map parameter as an integer, feature_inᵢₙₜ represents an input feature map parameter as an integer, and weightᵢₙₜ represents a weight parameter as an integer.

### BRIEF DESCRIPTION OF THE DRAWINGS

FIG. 1 is a schematic diagram illustrating a neural network model as an example.

FIG. 2A is a drawing to illustrate the basic structure of a convolutional neural network.

FIG. 2B is a schematic diagram to illustrate the behavior of a convolutional neural network.

FIG. 3 is a schematic diagram illustrating a neural processing unit, according to one embodiment.

FIG. 4A is a schematic diagram illustrating e a processing element of a plurality of processing elements, according to one embodiment.

FIG. 4B is a schematic diagram illustrating a special function unit (SFU), according to one embodiment.

FIG. 5 is a diagram illustrating a neural processing unit, according to another embodiment.

FIG. 6 is an illustrative diagram depicting a neural network model optimization unit and an edge device, according to one embodiment.

FIG. 7 is an illustrative diagram detailing a compiler of FIG. 6, according to one embodiment.

FIG. 8 is an illustrative diagram detailing a first translator of FIG. 7, according to one embodiment.

FIG. 9A is a conceptual diagram illustration the operation of a marker adding portion of FIG. 7, according to one embodiment.

FIG. 9B is a conceptual diagram illustrating the operation of the marker adding portion of FIG. 7, according to another embodiment.

FIG. 10 is a graph illustrating the importance of choosing appropriate scale and offset values, according to one embodiment.

FIG. 11 is a diagram illustrating the optimization unit of FIG. 7, according to one embodiment.

FIGS. 12A, 12B, and 12C are conceptual diagrams illustration each step of the operation performed by the outlier alleviation unit, according to one embodiment.

FIG. 13 is a conceptual diagram illustrating the operation of the parameter refinement unit, according to one embodiment.

FIG. 14A is a conceptual diagram illustrating performing of a convolution operation in a first neural network model, according to one embodiment.

FIG. 14B is a conceptual diagram illustrating performing of a convolutional product operation in a second neural network model, according to one embodiment.

FIG. 14C is a conceptual diagram of performing a convolutional product operation in a third neural network model, according to one embodiment.

FIG. 14D is a conceptual diagram illustrating convolution, deconvolution, and quantization operations in a third neural network model, according to one embodiment.

FIG. 15 is a block diagram illustrating a neural network model performance evaluation system, according to one embodiment.

FIG. 16 is a block diagram illustrating a neural network model optimization apparatus, according to one embodiment.

FIG. 17 is a block diagram illustrating a compiler of the neural network model optimization device, according to one embodiment.

FIG. 18 is a block diagram illustrating an optimization module of the neural network model processing device, according to one embodiment.

FIG. 19A is a user interface diagram for selecting one or more neural processors and selecting a compilation option, according to one embodiment.

FIG. 19B is a user interface diagram for displaying a performance report and recommendation on the one or more neural processing units, according to one embodiment.

FIGS. 20A through 20D are block diagrams illustrating various configurations of neural processing units of a neural network model processing apparatus, according to embodiments.

FIG. 21 is a block diagram illustrating a plurality of neural processing units, according to one embodiment.

FIG. 22 is a flowchart illustrating a method of evaluating performance of a neural network model instantiated on one or more neural processing units, according to another example of the present disclosure.

FIG. 23 is a flowchart illustrating a method of evaluating performance of, according to another example of the present disclosure.

FIG. 24 is a flowchart illustrating a method of evaluating performance of, according to another example of the present disclosure.

FIG. 25 is a flowchart illustrating a method of updating a neural network model for improved performance, according to another example of the present disclosure.

### DETAILED DESCRIPTION OF THE EMBODIMENT

Certain structural or step-by-step descriptions of the examples of the present disclosure are intended only to illustrate examples according to the concepts of the present disclosure. Accordingly, the examples according to the concepts of the present disclosure may be practiced in various forms. Examples according to the concepts of the present disclosure may be implemented in various forms. The present disclosure should not be construed as limiting to the examples of this disclosure.

Various modifications can be made to the examples according to the concepts of the present disclosure and can take many different forms. Accordingly, certain examples have been illustrated in the drawings and described in detail in the present disclosure or application. However, this is not intended to limit the examples according to the present disclosure to any particular disclosure form. The present disclosure according to the concepts of the present disclosure should be understood to include all modifications, equivalents, or substitutions that fall within the scope of the ideas and techniques of the present disclosure.

Terms such as first and/or second may be used to describe various elements, but the elements are not to be limited by the terms. the terms may be used only to distinguish one element from another. Without departing from the scope of the rights under the concepts of the present disclosure, a first elements may be named as a second elements, and similarly, a second elements may be named as a first elements.

When an elements is referred to as being “connected” or “plugged in” to another element, it may be directly connected or connected to the other element. However, it should be understood that other elements may exist in the middle of the plurality of elements. On the other hand, when an elements is the to be “directly connected” or “directly connected” to another element, it should be understood that there are no other elements in between. Other expressions describing relationships between elements, such as “between” and “directly between” or “adjacent to” and “directly adjacent to” should be interpreted similarly.

The terminology used in this disclosure is intended only to describe specific examples and is not intended to limit the present disclosure. Expressions in the singular include the plural unless the context clearly indicates otherwise. In the present disclosure, terms such as “includes” or “has” are intended to designate the presence of a described feature, number, step, action, element, part, or combination thereof, and should be understood as not precluding the possibility of the presence or addition of one or more other features, numbers, steps, actions, elements, parts, or combinations thereof.

Unless otherwise defined, all terms used herein, including technical or scientific terms, have the same meaning as commonly understood by one of ordinary skill in the art to which this disclosure belongs. Terms such as those defined in commonly used dictionaries shall be construed to have meanings consistent with their meaning in the context of the relevant art. Terms such as those defined in commonly used dictionaries are not to be construed in an idealized or overly formal sense unless expressly defined in this disclosure.

In describing the examples, technical details that are well known to those skilled in the art and not directly related to the present disclosure are omitted. This is done so that the main points of the present disclosure are more clearly conveyed without obscuring them by omitting unnecessary explanations.

### Definitions of Terms

The following is a brief summary of the terms used in this disclosure to facilitate understanding of the disclosures presented in this disclosure.

NPU: An abbreviation for neural processing unit, which may refer to a dedicated processor specialized for computing neural network models apart from a CPU (central processing unit) or GPU.

NN: Abbreviation for neural network, which can refer to a network of nodes connected in a layer structure that mimics the way neurons in the human brain connect through synapses to mimic human intelligence.

DNN: Abbreviation for deep neural network, which can refer to an increase in the number of hidden layers in a neural network to achieve higher artificial intelligence.

CNN: Abbreviation for convolutional neural network, a neural network that functions similarly to how the human brain processes images in the visual cortex. Convolutional neural networks are known for their ability to extract features from input data and identify patterns in the features.

Transformer: The transformer neural network is one of the most popular neural network architectures for natural language processing tasks. A transformer contains parameters such as input, query (Q), key (K), and value (V). The input to a transformer model consists of a sequence of tokens. Tokens can be words, sub-words, or characters. Each token in the input sequence is embedded into a high-dimensional vector. This embedding allows the model to represent the input tokens in a continuous vector space. Since the transformer does not intrinsically understand the order of the input tokens, a positional encoding is added to the embedding. This gives the model information about the position of the tokens in the sequence. At the core of the transformer model is a self-attention mechanism. This mechanism allows the model to decide how much attention to pay to different parts of the sequence when processing a particular token when making a prediction. The attendance mechanism includes a set of three vectors: query (Q), key (K), and value (V). For each input token, the transformer computes the three vectors: query (Q), key (K), and value (V). These vectors are used to compute an attention score, which determines how much emphasis should be placed on different parts of the sequence when processing a particular token when making a prediction. The attention score is calculated by taking the inner product of the query (Q) and the key (K) and dividing by the square root of the dimensionality of the key (K) vector. This result is passed through a softmax function to obtain an attentional weight (i.e., scaled dot-product attentions), which is used to compute a weighted sum of the value (V) vectors to produce the final output at each position. To capture different relationships between words, the self-attention mechanism is usually performed multiple times in parallel. This is done using different sets of query (Q), key (K), and value (V) parameters, and the outputs of these different attentional heads (i.e., multi-head attentions) are concatenated and linearly transformed. The self-attention layer is typically followed by a position-wise feedforward network. This is a fully connected layer that is applied independently to the sequence of each position. Layer regularization and residual concatenation are applied around each sub-layer to help with the stability of the training and facilitate the flow of the gradient. Transformers are commonly used as an encoder-decoder architecture for tasks such as machine translation. An encoder processes an input sequence, and a decoder produces an output sequence. In summary, the transformer model adopts a self-attention mechanism using query (Q), key (K), and value (V) vectors to capture the contextual information of the input sequence, and uses a multi-head attention mechanism and feedforward network to learn complex relationships in the data.

Visual Transformer (ViT) is an extension of the original transformer model for computer vision tasks. While transformers were primarily developed for natural language processing, ViT recognizes that the transformer architecture can be applied to a variety of tasks. Like transformers, the input to ViT is a sequence of tokens. In computer vision, the input tokens represent patches of an image. Instead of processing the entire image as a single input, ViT divides the image into non-overlapping patches of fixed size (i.e., image patch embedding). Each patch is linearly embedded and made into a vector to produce a sequence of embeddings. Since the order of the patches is not inherently understood by the ViT model, a positional encoding is added to the patch embedding to provide information about their spatial arrangement (i.e., positional encoding). Here, the patch embedding is linearly projected into a higher dimensional space to capture the relationships between complex patches. The patch embeddings are used as input to a transformer encoder. Each patch embedding is treated as a token in the sequence. Similar to the transformer, ViT utilizes a self-attention mechanism using Query (Q), Key (K), and Value (V) vectors. These vectors are computed for each patch embedding to compute an attachment score and capture dependencies between different parts of the image. Multiple attentional heads are used to capture the relationships between different patches (i.e., multi-head attentions). The outputs of these heads are concatenated and linearly transformed. After self-attention, a position-wise feedforward network is commonly used, which is applied to each patch embedding independently. This allows the model to learn local features. Similar to transformers, VIT uses layer regularization and residual concatenation to enhance training stability and facilitate gradient flow. The ViT encoder stack processes the patch embedding sequence through multiple layers. Each layer may include self-attention, feedforward, regularization, and residual concatenation. Unlike transformers, ViT does not use the entire sequence output for prediction. Instead, it applies a global average pooling layer to obtain a fixed-size representation for classification.

### <Artificial Intelligence>

Humans have the intelligence to recognize, classify, infer, predict, and control/decision making. Artificial intelligence (AI) refers to the artificial imitation of human intelligence.

The human brain is composed of a large number of nerve cells called neurons. Each neuron is connected to hundreds to thousands of other neurons through connections called synapses. To mimic human intelligence, the behavior of biological neurons and the connections between neurons are modeled in a neural network model. In other words, a neural network is a system of nodes connected in a layer structure that mimics neurons.

These neural network models are categorized into ‘single-layer neural networks’ and ‘multi-layer neural networks’ depending on the number of layers. A typical multilayer neural network consists of an input layer, a hidden layer, and an output layer. The input layer is a layer that receives external data, and the number of neurons in the input layer is the same as the number of input variables. The hidden layer is located between the input layer and the output layer and receives signals from the input layer, extracts characteristics, and passes them to the output layer. The output layer receives signals from the hidden layer and outputs the result. The input signals between neurons are multiplied by their respective connection strengths, which have a value between 0 and 1, and then summed. If this sum is greater than the neuron's threshold, the neuron is activated and implemented as an output value through the activation function.

On the other hand, in order to realize higher artificial intelligence, the number of hidden layers of a neural network is increased, which is called a deep neural network (DNN).

DNNs are being developed in a variety of structures. For example, convolutional neural network (CNN), which is an example of DNN, is known to be easy to extract features of input data (video or image) and identify patterns in the extracted output data. A CNN can be composed of convolutional operations, activation function operations, and pooling operations processed in a specific order.

For example, in each layer of a DNN, the parameters (i.e., input values, output values, weights, or kernels) may be a matrix of a plurality of channels. The parameters may be processed on the a neural processing unit (NPU) by convolution or matrix multiplication. At each layer, an output value is generated after the operations are processed.

For example, a visual transformer or transformer is a DNN based on attention techniques. Transformers utilize many matrix multiplication operations. A transformer can use input values and parameters such as query (Q), key (K), and value (V) to obtain an output value, an attentions (Q,K,V). The transformer can perform various inference operations based on the output values (i.e., the attributes (Q,K,V)). Transformers tend to have better inference performance than CNNs.

The computation of conventional neural network models may have issues such as high-power consumption, heat generation, bottlenecks in processor operations due to relatively low memory bandwidth, and latency in memory. To alleviate touch issues, embodiments relate to improving neural network models to relieve these issues. Specifically, when the data size of a neural network model is large, delays can occur frequently due to the inability to prepare the necessary data in advance. In such cases, the processor is starved or idle, unable to perform actual computations because it is not supplied with data to process, resulting in reduced computational performance. This problem can be exacerbated by the wide variety of electronic devices utilized in edge computing. Edge computing refers to the edge, or periphery, where computing takes place, and may include a variety of electronic devices that are located in close proximity to the devices that directly produce data. In addition, in a cloud computing system, a computing system that is located at the end of the cloud computing system, away from the servers in the data center, and communicates with the servers in the data center can be defined as an edge device. Edge devices may be utilized to perform tasks that require immediate and reliable performance, such as autonomous robots or self-driving cars that need to process vast amounts of data in less than 1/1000th of a second. Accordingly, the number of applications for edge devices is rapidly increasing.

Embodiments relate to lightweighting neural network models that fit into standalone, low-power, low-cost neural processing units. In other words, embodiments relate to reducing the parameters of neural network models in order to allow them to be embedded in each electronic device and operate independently.

On the other hand, there are various problems that need to be resolved in order to commercialize the neural processing unit (NPU) that drives the neural network model. First, there is a lack of information for selecting a neural processing unit to drive a user-developed neural network model. Second, NPUs are just beginning to be commercialized, and to know whether a GPU-based neural network model will work on a specific NPU, users need to review various questionnaires, data sheets, and technical support from engineers. In particular, the number of layers, the size of parameters, and special functions can be changed according to the user's needs, making it difficult to generalize the neural network model. Third, it is difficult to know in advance whether the neural network model developed by the user will run on a specific NPU, which means that after purchasing an NPU, it may not be possible to run it because it does not support certain operations or calculations. Fourth, it is difficult to know in advance how a user-developed neural network model will perform when running on a specific NPU, i.e., whether it will meet the desired power consumption and desired frame per seconds (FPS). In particular, it is difficult to know the desired performance in advance because the size of the weight of the neural network model, the size of the feature map, the number of channels, the number of layers, and the characteristics of the activation function are different for each neural network model.

Embodiments also relate to enabling faster determination of the preferred NPU product selection and model update conditions on the selected NPU by providing a solution or service that provides the best convenience and value to the user by performing a series of tasks performed by the user online in batches when the AI code (e.g., TensorFlow™, PyTorch™, ONNX™ model file, and the like) is dropped (uploaded) to a specific online simulation service. Embodiments relate to lightening the neural network model so that it can infer certain functions with a predetermined accuracy, while using a reduced amount of power and memory.

Embodiments also relate to improving a neural network model running on a neural processing unit by simulating various options for the neural network model. The parameters of each layer of a neural network model may be updated in order to efficiently quantize a graph-based neural network model.

The present disclosure will now be described in detail with reference to the accompanying drawings, which illustrate preferred embodiments of the present disclosure. Hereinafter, examples of the present disclosure will be described in detail with reference to the attached drawings.

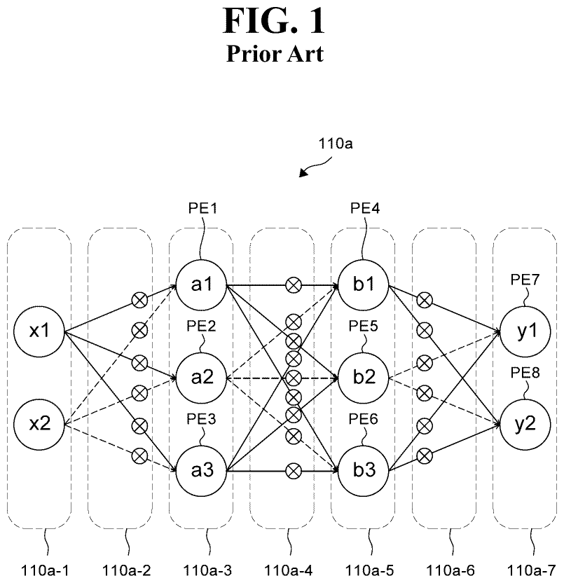

FIG. 1 is a schematic diagram illustrating an example neural network model. Operations of an neural network model 110a that can be operated in the neural processing unit 100 will be described as an example. The neural network model 110a of FIG. 1 as an example may be a neural network trained to perform various inference functions such as object recognition and speech recognition. The neural network model 110a may be a deep neural network (DNN). However, the neural network model 110a according to examples of the present disclosure is not limited to a deep neural network. For example, the neural network model 110a may be Siamese Network, Triplet Network, Contrastive Loss, FaceNet, DeepID, SphereFace, ArcFace, Florence-2, Da ViT, MobileViT, VIT, Swin-Transformer, Transformer, YOLO, CNN, PIDNet, BiseNet, RCNN, VGG, VGG16, DenseNet, SegNet, DeconvNet, DeepLAB V3+, U-net, SqueezeNet, Alexnet, ResNet18, MobileNet-v2, GoogLeNet, Resnet-v2, Resnet50, Resnet101, Inception-v3, and other models. The present disclosure is not limited to the models described above. The neural network model 110a may also be an ensemble model based on at least two different models.

In the following, an inference process performed by the neural network model 110a will be described as an example. The neural network model 110a is a deep neural network model including an input layer 110a-1, a first connection network 110a-2, a first hidden layer 110a-3, a second connection network 110a-4, a second hidden layer 110a-5, a third connection network 110a-6, and an output layer 110a-7 as an example. However, the present disclosure is not limited to the neural network model shown in FIG. 1. The first hidden layer 110a-3 and the second hidden layer 110a-5 may also be referred to as a plurality of hidden layers.

The input layer 110a-1 may include, for example, x1 and x2 input nodes, i.e., the input layer 110a-1 may include information about two input values. The first connection network 110a-2 may, for example, include information about six weight values for connecting each node of the input layer 110a-1 to each node of the first hidden layer 110a-3. Each weight value is multiplied with the input node value, and an accumulated value of the multiplied values is stored in the first hidden layer 110a-3. The weight values and input node values may be referred to as parameters of the neural network model. The first hidden layer 110a-3 may for example, include a1, a2, and a3 nodes, i.e., the first hidden layer 110a-3 may include information about three node values.

The first processing element PE1 of FIG. 1 may process operations on the a1 node. The second processing element PE2 of FIG. 1 may process the operations of the a2 node. The third processing element PE3 of FIG. 1 may process the operations of the a3 node. The second connection network 110a-4 may include, for example, information about nine weight values for connecting each node of the first hidden layer 110a-3 to each node of the second hidden layer 110a-5. The weight values of the second connection network 110a-4 are each multiplied with the node values input from the first covert layer 110a-3, and the accumulated value of the multiplied values is stored in the second covert layer 110a-5.

The second hidden layer 110a-5 may exemplarily include nodes b1, b2, and b3, i.e., the second hidden layer 110a-5 may include information about three node values. The fourth processing element PE4 of FIG. 1 may process operations on the b1 node. The fifth processing element PE5 of FIG. 1 may process the operations of the b2 node. The sixth processing element PE6 of FIG. 1 may process the operations of node b3. The third connection network 110a-6 may include information about six weight values that connect each node of the second hidden layer 110a-5 with each node of the output layer 110a-7, for example. The weight values of the third connection network 110a-6 are each multiplied with the node values input from the second hidden layer 110a-5, and the accumulated value of the multiplied values is stored in the output layer 110a-7. The output layer 110a-7 may exemplarily include nodes y1, and y2, i.e., the output layer 110a-7 may include information about two node values. The seventh processing element PE7 of FIG. 1 may process operations on the y1 node. The eighth processing element PE8 of FIG. 1 may process the operation of the y2 node.

Each node may correspond to a feature value, and the feature value may correspond to a feature map.

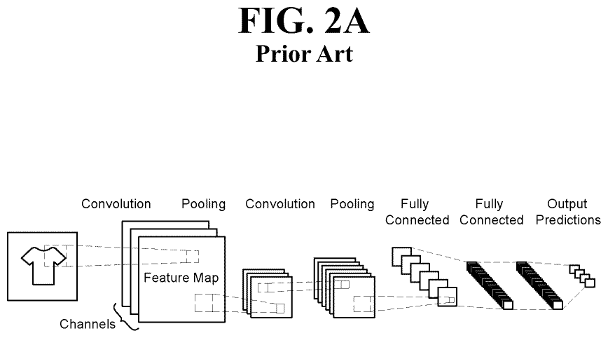

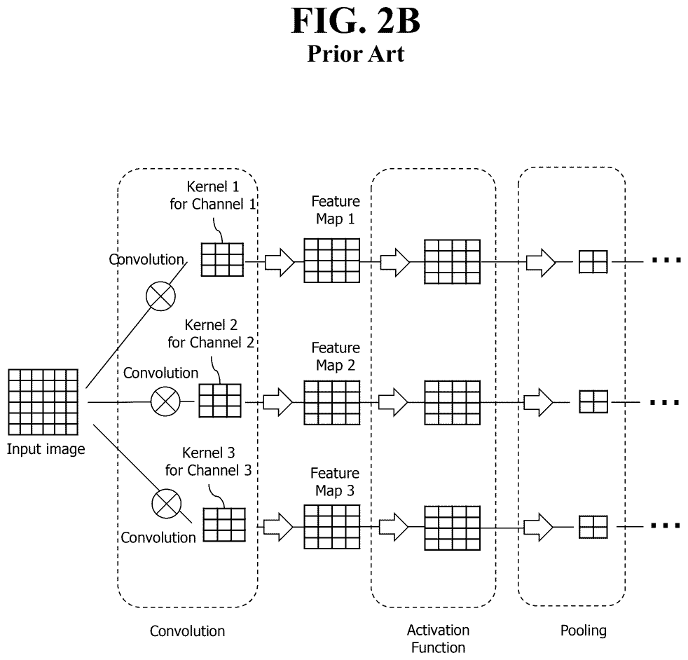

FIG. 2A is a diagram to illustrate the basic structure of a convolutional neural network (CNN). Referring to FIG. 2A, an input image may be represented as a two-dimensional matrix comprising rows of a particular size and columns of a particular size. The input image may have a plurality of channels, where the channels may represent the number of color components of the input data image. The process of convolution involves a kernel traversing the input image at specified intervals.

A convolutional neural network can have a structure that passes the output value (convolution or matrix multiplication) of the current layer as the input value of the next layer. For example, a convolutional or matrix multiplication is defined by two main parameters: the input feature map and the kernel. Parameters can include input feature map, output feature map, activation map, weights, kernel, and attributes (Q, K, V). The convolution slides a kernel window over the input feature map. The size of the step by which the kernel slides over the input feature map is called the stride. After convolution, pooling may be applied. In addition, a fully-connected (FC) layer may be placed at the end of the convolutional neural network.

For the sake of simplicity, convolutional operations will be discussed below, but other operations such as matrix multiplication can be included in specific layers of a neural network model.

FIG. 2B is a diagram illustrating the operation of a convolutional neural network. Referring to FIG. 2B, it is shown that an input image is a two-dimensional matrix with a size of 6×6 as an example. Also, in FIG. 2B, three nodes are used, namely channel 1, channel 2, and channel 3 as an example. The input image (exemplarily shown as 6×6 in FIG. 2B) is convolved with kernel 1 (exemplarily shown as 3×3 in FIG. 2B) for channel 1 at the first node, and feature map 1 (exemplarily shown as 4×4 in FIG. 2B) is output as a result. Further, the input image (exemplarily represented in FIG. 2B as 6×6 in size) is convolved with a kernel 2 (exemplarily represented in FIG. 2B as 3×3 in size) for channel 2 at a second node, and feature map 2 (exemplarily represented in FIG. 2B as 4×4 in size) is output as a result. Further, the input image is convolved with a kernel 3 (exemplarily represented in FIG. 2B as being 3×3 in size) for channel 3 at the third node, and a feature map 3 (exemplarily represented in FIG. 2B as being 4×4 in size) is output as a result. To process each convolution, the processing elements PE1 to PE12 of the neural processing unit 100 are configured to perform MAC operations.

The activation function may be applied to the feature map 1, feature map 2, and feature map 3 (each of which is shown in FIG. 2B as having a size of 4×4 as an example) output from the convolutional operation. The output after the activation function is applied may be a size of 4×4 as an example.

Feature map 1, feature map 2, and feature map 3 (each of which is 4×4 in the example of FIG. 2B), which are output from the above activation function, are input to three nodes. By taking the feature maps output from the activation function as input, pooling can be performed. The pooling can be done to reduce the size or to emphasize certain values in the matrix. Pooling methods include maximum value pooling, average pooling, and minimum value pooling. Maximum pooling is used to collect the maximum number of values within a certain region of the matrix, while average pooling can be used to average the values within a certain region.

In the example of FIG. 2B, a feature map of size 4×4 is shown to be reduced to a size of 2×2 by pooling. Specifically, the first node takes as input the feature map 1 for channel 1, performs pooling and outputs, for example, a 2×2 matrix. The second node takes as input the feature map 2 for channel 2, performs the pooling, and outputs, for example, a 2×2 matrix. The third node takes as input the feature map 3 for channel 3, performs pooling and outputs, for example, a 2×2 matrix.

The aforementioned convolution, activation function, and pooling are repeated, and finally, the output can be fully connected as shown in FIG. 2A.

Among the various deep neural network (DNN) methods, CNN is widely used in the field of computer vision. In particular, CNN has shown remarkable performance in various research areas performing various tasks such as image classification and object detection.

### <Hardware Resources Required for Computation of the NN>.

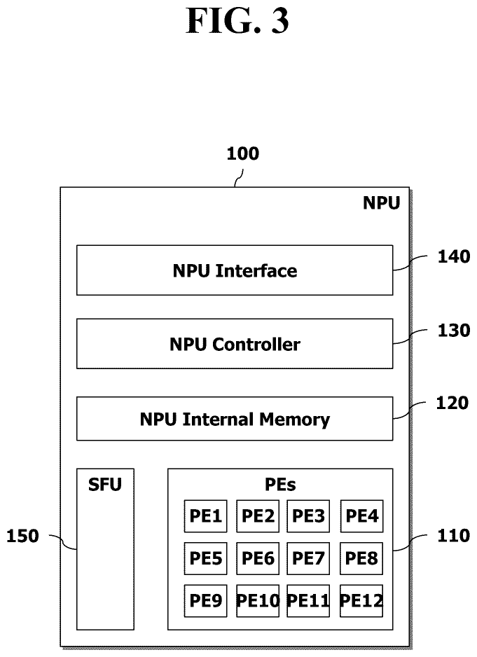

FIG. 3 is a schematic diagram illustrating a neural processing unit, according to an example of the present disclosure. The neural processing unit (NPU) 100 illustrated in FIG. 3 is a processor specialized to perform operations for a neural network.

A neural network refer to a network of artificial neurons that receives multiple inputs or stimuli, adds them together by multiplying their weights, and then transforms and delivers the sum of the deviations through an activation function. The trained neural network can then be used to output inference results from the input data. The neural processing unit 100 may be a semiconductor implemented as an electrical/electronic circuit. An electrical/electronic circuit may include a number of electronic elements, e.g., transistors, capacitors.

In the case of a neural network model based on a ViT, transformer, and/or CNN, the neural processing unit 100 may perform matrix multiplication operations, convolutional operations, and the like, depending on the graph structure of the neural network. For example, in each layer of a convolutional neural network (CNN), the input feature map corresponding to the input data and the kernel corresponding to the weights may be a tensor or matrix comprising a plurality of channels. A convolutional operation is performed on the input feature map and the kernel, and a convolutional operation and pooled output feature map are generated on each channel. An activation function is applied to the output feature map to generate an activation map for that channel. Pooling can then be applied to the activation map. The activation map may be collectively referred to herein as the output feature map. For convenience in the following description, the activation map will be referred to as the output feature map. Examples of the present disclosure are not limited thereto, and the output feature map may be subjected to a matrix multiplication operation or a convolution operation.

Furthermore, the output feature map according to the examples of the present disclosure should be interpreted as non-limiting. For example, the output feature map may be the result of a matrix multiplication operation or a convolution operation. Accordingly, the plurality of processing elements 110 may be modified to further include processing circuitry for additional algorithms, such that some circuit units of the special function unit (SFU) 150, which will be described later, may be included in the plurality of processing elements 110.

The neural processing unit 100 may include a plurality of processing elements 110 for processing convolutional and matrix multiplications required for the neural network operations described above. The neural processing unit 100 may include a respective processing circuit specialized for matrix multiplication operations, convolutional operations, activation function operations, pooling operations, stride operations, batch normalization operations, skip connection operations, concatenation operations, quantization operations, clipping operations, and padding operations required for the above-described neural network operations. For example, the neural processing unit 100 may be configured to include an SFU 150 for processing at least one of the above algorithms: activation function operation, pooling operation, stride operation, batch normalization operation, skip connection operation, concatenation operation, quantization operation, clipping operation, and padding operation. Specifically, the neural processing unit 100 may include a plurality of processing elements (PEs) 110, SFU 150, NPU internal memory 120, NPU controller 130, and NPU interface 140. Each of the plurality of processing elements 110, SFU 150, NPU internal memory 120, NPU controller 130, and NPU interface 140 may be a semiconductor circuit with numerous transistors connected thereto. As such, some of them may be difficult to identify and distinguish with the naked eye, and may be identified only by their behavior. For example, any of the circuits may operate as a plurality of processing elements 110, or may operate as an NPU controller 130. The NPU controller 130 may be configured to perform the functions of a control unit configured to control the neural network inference operations of the neural processing unit 100.

The neural processing unit 100 may include an NPU internal memory 120 for storing parameters of a neural network model that may be inferred by the plurality of processing elements 110 and the SFU 150, and an NPU controller 130 configured to control a computation schedule of the plurality of processing elements 110, the SFU 150, and the NPU internal memory 120.

The neural processing unit 100 may process feature maps in response to encoding and decoding schemes using scalable video coding (SVC) or scalable feature-map coding (SFC). The above methods are techniques for varying the amount of data transmission based on the effective bandwidth and signal to noise ratio (SNR) of the communication channel or communication bus. That is, the neural processing unit 100 may further include an encoder and a decoder.

The plurality of processing elements 110 may perform some of the operations for the neural network. The SFU 150 may perform other portions of the operations for the neural network. The neural processing unit 100 may perform hardware accelerate computation of the neural network model using the plurality of processing elements 110 and the SFU 150.

The NPU interface 140 may communicate with various elements connected to the neural processing unit 100, such as memory, via a system bus.

The NPU controller 130 may control the order of operations of the plurality of processing elements 110, operations of the SFU 150, and reads and writes to the NPU internal memory 120 for inference operations of the neural processing unit 100. The NPU controller 130 may control the plurality of processing elements 110, the SFU 150, and the NPU internal memory 120 based on control information included in a compiled neural network model.

The NPU controller 130 may analyze the structure of the neural network model to be operated on the plurality of processing elements 110 and SFU 150, or may be provided with information that has already been analyzed. The analyzed information may be information generated by the compiler. For example, the data of the neural network that the neural network model may include may include at least some of the following: node data of each layer (i.e., feature map), batch data of the layers, locality information or information about the structure, and weight data (i.e., weight kernel) of each of the connection networks connecting the nodes of each layer. The data of the neural network may be stored in memory provided within the NPU controller 130 or in the NPU internal memory 120. However, without limitation, the data of the neural network may be stored in a separate cache memory or register file provided in the NPU or an SoC including the NPU.

The NPU controller 130 may obtain scheduling information that schedules the order of operations of the neural network model to be performed by the neural processing unit 100 based on a directed acyclic graph (DAG) of the neural network model compiled by the compiler. The NPU controller 130 may be provided with scheduling information of a sequence of operations of the neural network model to be performed by the neural processing unit 100 based on information about data locality or structure of the compiled neural network model. For example, the scheduling information may be information generated by a compiler. The scheduling information generated by the compiler may be referred to as machine code, binary code, or the like.

The NPU controller 130 may obtain scheduling information that schedules the order of operations of the neural network model to be performed by the neural processing unit 100 based on the directed acyclic graph (DAG) of the neural network model compiled by the compiler. Here, the compiler may determine a computation schedule that can accelerate the computation of the neural network model based on the number of processing elements 110 of the neural processing unit 100, the size of the NPU internal memory 120, the size of the parameters of each layer of the neural network model, and the like. Based on the computation schedule, the NPU controller 130 may control the required number of processing elements 110 for each computation step and to control the read and write operations of the parameters required in the NPU internal memory 120 for each computation step.

In other words, the scheduling information utilized by the NPU controller 130 may be information generated by the compiler based on the data locality information or structure of the neural network model. The compiler may efficiently perform scheduling for the neural processing unit 100 based on how well it understands and reconstructs the neural network data locality, which is a unique property of the neural network model. Additionally, the compiler can efficiently schedule the NPU based on how well it understands the hardware architecture and performance of the neural processing unit 100. Additionally, when the neural network model is compiled by the compiler to be executed on the neural processing unit 100, the neural network data locality may be reconstructed. The neural network data locality may be reconfigured based on the algorithms applied to the neural network model and the operational characteristics of the processor.

The scheduling information may be reconstructed based on how the neural processing unit 100 processes the neural network model, e.g., feature map tiling technique, stationary type (e.g., weight stationary, input stationary, or output stationary) for processing of processing elements, and the like. Additionally, the scheduling information may be reconfigured based on the number of processing elements in the neural processing unit 100, the capacity of the internal memory, and the like. Furthermore, the scheduling information may be reconfigured based on the bandwidth of the memory communicating with the neural processing unit 100. This is because each of the factors described above may cause the neural processing unit 100 to determine a different order of data required for each clock of a clock signal, even when computing the same neural network model.

The compiler may determine the order of data required to compute the neural network model based on the order of operation of the layers, unit convolutions, and/or matrix multiplications of the neural network to determine data locality and generate the compiled machine code.

The NPU controller 130 may be configured to utilize the scheduling information contained in the machine code. Based on the scheduling information, the NPU controller 130 may obtain a memory address value where the feature map and weight data of the layers of the neural network model are stored. For example, the NPU controller 130 may obtain the memory address value where the feature maps and weight data of the layers of the neural network model stored in the memory. Thus, the NPU controller 130 may fetch the feature maps and weight data of the layers of the neural network model to be executed from the main memory and store them in the NPU internal memory 120. For example, based on the data locality information of the neural network model, the neural processing unit 100 may set a memory map of the main memory for efficient read/write operations of the parameters (e.g., weights and feature maps) of the neural network model to reduce the latency of data transmission between the main memory and the NPU internal memory 120.

Each layer's feature map can have a corresponding memory address value. Each weight data may have a corresponding respective memory address value.

The NPU controller 130 may be provided with scheduling information about the order of operations of the plurality of processing elements 110 based on information about data locality or structure of the neural network model, such as batch data of layers of the neural network of the neural network model, locality information, or information about structure. The scheduling information may be generated in a compilation step.

Because the NPU controller 130 operates based on scheduling information based on information about data locality or structure of the neural network model, it may operate differently from the scheduling concepts of a typical CPU. The scheduling of a conventional CPU operates to achieve the best efficiency by considering fairness, efficiency, stability, and response time, e.g., it schedules the most processing to be performed in the same amount of time by considering priority, computation time, and the like.

Conventional CPUs use algorithms to schedule tasks by considering data such as the priority of each task and the processing time of the task. In contrast, the NPU controller 130 can control the neural processing unit 100 in a processing order of the neural processing unit 100 determined based on information about data locality or structure of the neural network model. Further, the NPU controller 130 may drive the neural processing unit 100 in a processing order determined based on the information about the data locality information or structure of the neural network model and/or the information about the data locality information or structure of the neural processing unit 100 to be used. In other words, caching strategies (e.g., LRU, FIFO, LFU) used in von Neumann structures are inefficient for controlling the NPU internal memory 120 of the neural processing unit 100. Since the neural network model has a directed acyclic graph (DAG) algorithmic structure rather than a simple chain-structured algorithm, the operation of the neural processing unit 100 is efficient with a caching strategy that recognizes the data locality of the neural network model. However, the present disclosure is not limited to information about data locality or structure of the neural processing unit 100.

The NPU controller 130 may be configured to store information about the data locality information or structure of the neural network. In other words, the NPU controller 130 can determine the processing order by utilizing at least the information about the data locality information or structure of the neural network of the neural network model. Further, the NPU controller 130 may determine the processing order of the neural processing unit 100 by considering information about the data locality information or structure of the neural network model and information about the data locality information or hardware structure of the neural processing unit 100. Furthermore, it is possible to improve the processing of the neural processing unit 100 in the determined processing order. That is, the NPU controller 130 may operate based on machine code compiled from a compiler, but in another example, the NPU controller 130 may include an embedded compiler. According to the configurations described above, the neural processing unit 100 may be configured to generate machine code by receiving input files in the form of frameworks of various AI software. For example, AI software frameworks include TensorFlow, PyTorch, Keras, XGBoost, mxnet, DARKNET, ONNX, and the like.

The plurality of processing elements 110 refers to a configuration of a plurality of processing elements (PE1 to PE12) configured to compute the feature map and weight data of the neural network. Each processing element may include a multiply and accumulate (MAC) operator and/or an arithmetic logic unit (ALU) operator. However, examples according to the present disclosure are not limited thereto. Each processing element may be configured to optionally further include additional special function unit circuitry to handle additional specialized functions. For example, the processing element PE may be modified to further include a batch-regularization unit, an activation function unit, an interpolation unit, and the like.

The SFU 150 may include a functional unit for skip-connection operations, a functional unit for activation function operations, a functional unit for pooling operations, a functional unit for dequantization operations, a functional unit for quantization operations, and a functional unit for non-maximum suppression (NMS) operations, a functional unit for a batch-normalization operation, a functional unit for an interpolation operation, a functional unit for a concatenation operation, and a functional unit for a bias operation, may be selected according to the graph module of the neural network model and may include circuitry configured to process them. In other words, the SFU 150 may include a plurality of specialized functional computation processing circuit units. The SFU 150 may include circuitry to process various operations that are difficult to process in a processing element.

While a plurality of processing elements is shown in FIG. 3 as an example, it is also possible to configure a plurality of operators implemented as a plurality of multiplier and adder trees in parallel, replacing the MAC within a single processing element. In such cases, the plurality of processing elements 110 may be referred to as at least one processing element comprising a plurality of operators.

The plurality of processing elements 110 is configured to include a plurality of processing elements PE1 to PE12. The plurality of processing elements PE1 to PE12 shown in FIG. 3 are illustrative only, and the number of the plurality of processing elements PE1 to PE12 is not limited. The number of the plurality of processing elements PE1 to PE12 may determine the size or number of the plurality of processing elements 110. The size of the plurality of processing elements 110 may be implemented in the form of an N×M matrix. Where N and M are integers greater than zero. The plurality of processing elements 110 may include N×M processing elements, i.e., there may be more than one processing element.

The size of the plurality of processing elements 110 can be designed taking into account the characteristics of the neural network model in which the neural processing unit 100 operates.

The plurality of processing elements 110 are configured to perform functions such as addition, multiplication, accumulation, and the like that are necessary for computing the neural network. In other words, the plurality of processing elements 110 may be configured to perform multiplication and accumulation (MAC) operations.

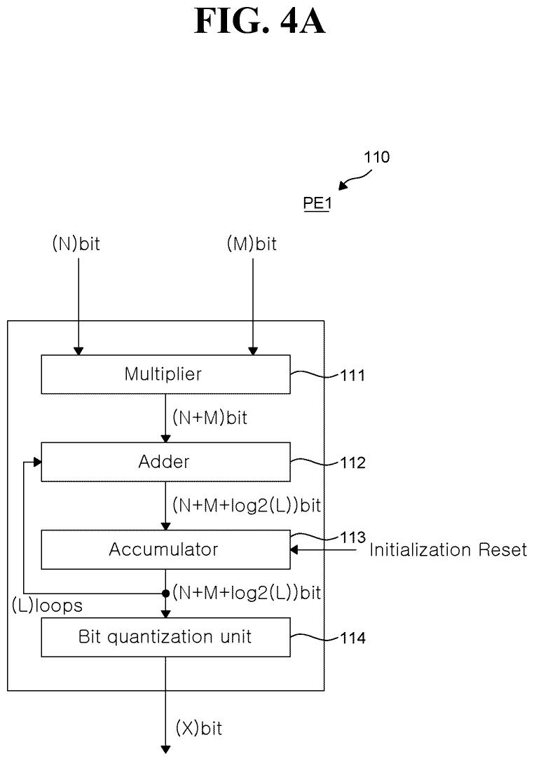

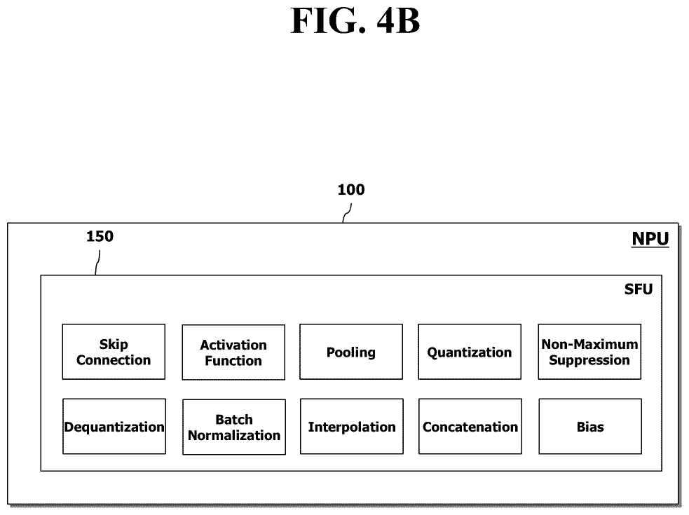

A first processing element PE1 of the plurality of processing elements 110 will be described by way of example. FIG. 4A is a schematic diagram illustrating e a processing element of a plurality of processing elements, according to one embodiment. A neural processing unit 100 according to an example of the present disclosure may include, among other components, a plurality of processing elements 110, an NPU internal memory 120 configured to store a neural network model that may be inferred by the plurality of processing elements 110, and an NPU controller 130 configured to control the plurality of processing elements 110 and the NPU internal memory 120, the plurality of processing elements 110 configured to perform MAC operations, and the plurality of processing elements 110 configured to quantize and output results of the MAC operations. However, examples of the present disclosure are not limited thereto.

The NPU internal memory 120 may store all or part of the neural network model depending on the memory size and the data size of the neural network model.

The first processing element PE1 may include a multiplier 111, an adder 112, an accumulator 113, and a bit quantization unit 114. However, examples according to the present disclosure are not limited, and the plurality of processing elements 110 may be modified to account for the computational characteristics of the neural network.

The multiplier 111 multiplies the input N-bit data and the M-bit data. The result of the operation of the multiplier 111 is output as (N+M)-bit data. The multiplier 111 may be configured to receive one weight parameter and one feature map parameter as input. The multiplier 111 may be configured to operate in a zero skipping manner when a value of zero for a parameter is input to one of the inputs of the first input and the second input of the multiplier 111. In such a case, the multiplier 111 may be disabled when the multiplier 111 receives an input of a weight parameter or feature map parameter having a value of zero. Thus, the multiplier 111 may be configured to reduce power consumption of the plurality of processing elements 110 when processing a weight parameter with a pruning algorithm applied, or when the feature map parameter has a value of zero. Accordingly, the processing element including the multiplier 111 may be disabled.

The accumulator 113 accumulates the operation value of the multiplier 111 and the operation value of the accumulator 113 using the adder 112 for a number of L-loops. Thus, the bit width of the data at the output and input of the accumulator 113 may be output as (N+M+log 2(L)) bit, where Lis an integer greater than zero. When the accumulator 113 finishes accumulating, the accumulator 113 may receive an initialization signal (initialization reset) to initialize the data stored inside the accumulator 113 to zero. However, the examples according to the present disclosure are not limited thereto.

The bit quantization unit 114 may reduce the bit width of the data output from the accumulator 113. The bit quantization unit 114 may be controlled by the NPU controller 130. The bit width of the quantized data may be output as X-bit, where X is an integer greater than zero. According to the configuration described above, the plurality of processing elements 110 are configured to perform a MAC operation, and the plurality of processing elements 110 has the effect that the results of the MAC operation can be quantized and output. In particular, this quantization has the effect of further reducing power consumption as the number of L-loops increases. Also, reducing power consumption has the effect of reducing heat generation. In particular, reducing heat generation has the effect of reducing the possibility of malfunctions caused by high temperatures in the neural processing unit 100.

The output data X-bit of the bit quantization unit 114 can be the node data of the next layer or the input data of the convolutional processor. If the neural network model is quantized, the bit quantization unit 114 may be configured to receive the quantized information from the neural network model. However, without limitation, the NPU controller 130 may also be configured to analyze the neural network model to extract the quantized information. Thus, the output data X-bit may be converted to a quantized bit width to correspond to the quantized data size. The output data X-bit of the bit quantization unit 114 may be stored in the NPU internal memory 120 in the quantized bit width.

The plurality of processing elements 110 of the neural processing unit 100 according to an example of the present disclosure may include a multiplier 111, an adder 112, and an accumulator 113. A bit quantization unit 114 may be selected depending on whether quantization is to be applied. In other examples, the bit quantization unit may be configured to be included in the SFU 150.

FIG. 4B is a schematic diagram illustrating a special function unit (SFU), according to one embodiment. Referring to FIG. 4B, the SFU 150 may include multiple functional units. Each functional unit may be selectively actuated. Each functional unit may be selectively turned on or off, i.e., each functional unit is configurable. In other words, the SFU 150 may include a variety of circuitry units necessary for performing neural network inference operations. For example, the circuit units of the SFU 150 may include a functional unit for skip-connection operations, a functional unit for activation function operations, a functional unit for pooling operations, a functional unit for dequantization operations, a functional unit for quantization operations, a functional unit for non-maximum suppression (NMS) operations, a functional unit for batch-normalization operations, a functional unit for interpolation operations, a functional unit for concatenation operations, and a functional unit for bias operations. In addition, since certain functional unit need to be processed with floating-point parameters, conversion of floating-point parameters to integer parameters may optionally be performed in the SUF 150. Each functional unit may comprise a respective circuitry. The functional unit for the quantization operation and the functional unit for the de-quantization operation may be integrated into one circuit. The functional units of the SFU 150 may be selectively turned on and/or off based on the data locality information of the neural network model. The data locality information of the neural network model may include control information related to turning on or off a corresponding functional unit when computation for a particular layer is performed. Among the functional units of the SFU 150, an active unit may be turned on. In this way, selectively turning off some functional units of the SFU 150 may reduce power consumption of the neural processing unit 100. Alternatively, power gating may be utilized to turn off some functional units. Alternatively, clock gating may be performed to turn off some functional units.

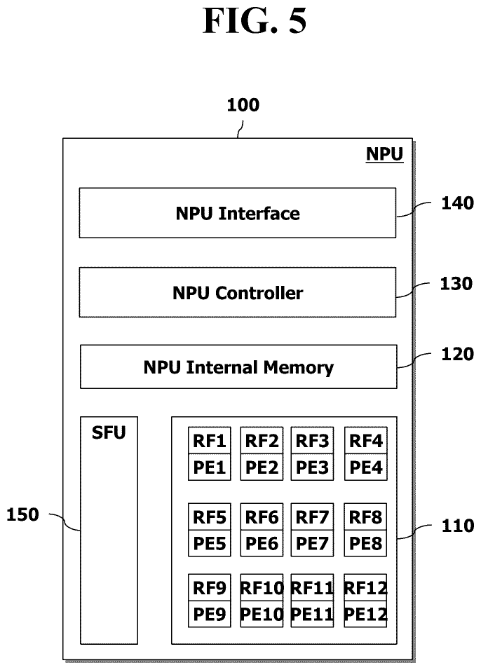

FIG. 5 is a diagram illustrating a variation of the neural processing unit 100 shown in FIG. 3 as an example. Since the neural processing unit 100 shown in FIG. 5 is substantially the same as the processing unit 100 exemplified in FIG. 3, with the exception of the plurality of processing elements 110, redundant description may be omitted herein for ease of explanation only.

The plurality of processing elements 110 exemplarily shown in FIG. 5 may further include, in addition to the plurality of processing elements PE1 to PE12, respective register files RF1 to RF12 corresponding to each of the processing elements PE1 to PE12. The plurality of processing elements PE1 to PE12 and the plurality of register files RF1 to RF12 shown in FIG. 5 are illustrative only, and the number of the plurality of processing elements PE1 to PE12 and the plurality of register files RF1 to RF12 is not limited.

The number of the plurality of processing elements PE1 to PE12 and the number of the plurality of register files RF1 to RF12 may determine the size or number of the plurality of processing elements 110. The size of the plurality of processing elements 110 and the plurality of register files RF1 to RF12 may be implemented in the form of an N×M matrix, where N and M are integers greater than zero. The array size of the plurality of processing elements 110 may be designed in consideration of the characteristics of the neural network model in which the neural processing unit 100 operates. In particular, the memory size of the register file may be determined by considering the data size of the neural network model to be operated, the required operation speed, the required power consumption, and the like.

The register files RF1 to RF12 of the neural processing unit 100 are static memory units directly connected to the processing elements PE1 to PE12. The register files RF1 to RF12 may comprise, for example, flip-flops and/or latches. The register files RF1 to RF12 may be configured to store MAC operation values of the corresponding processing elements PE1 to PE12. The register files RF1 to RF12 may be configured to provide or receive weight data and/or node data with the NPU internal memory 120. The register files RF1 to RF12 may also be configured to function as temporary memory for the accumulator during MAC operations.

In order to accelerate AI computation, the neural processing unit 100 specialized for AI computation may have various hardware circuit configurations. On the other hand, a conventional neural network model is a neural network model that is trained without considering the hardware characteristics of the neural processing unit 100. That is, the conventional neural network model is trained without considering the hardware limitations of the neural processing unit 100. Therefore, when processing a conventional neural network model, the processing performance on the corresponding neural processing unit 100 may not be lower than desired. For example, processing performance degradation may be due to inefficient memory management and processing of large computational volumes of the neural network model. Therefore, the conventional neural processing unit 100 for processing a conventional neural network model may use high power consumption and/or have a low computational processing speed problem.

### Examples of the Present Disclosure

A neural network model optimization device 1500 according to an example of the present disclosure improves a neural network model by utilizing structural data of the neural network model or hardware characteristic data of the neural processing unit 100.

Thus, when the improved neural network model when processed in the neural processing unit 100 provides relatively improved performance with reduced power consumption compared to those of the unimproved neural network model.

The neural network model executed in the neural processing unit 100 may be processed in a corresponding dedicated circuit unit of the neural processing unit 100 at each step, and quantization and de-quantization of the input/output parameters processed in each dedicated circuit unit may be performed, which has the effect of reducing power consumption of the neural processing unit 100, improving processing speed, reducing memory bandwidth, minimizing deterioration of inference accuracy, and the like.

The neural network model optimization unit 1500 may be configured to improve a neural network model for the neural processing unit 100.

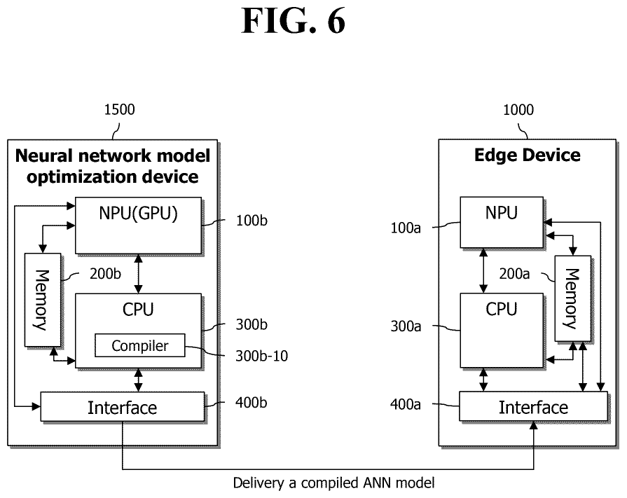

FIG. 6 is a diagram illustrating a neural network model optimization device 1500 and an edge device 1000 as an example, according to an example of the present disclosure. As shown, the neural network model optimization device 1500 is a separate, external system configured to improve a neural network model used by the neural processing unit 100a in the edge device 1000 according to an example of the present disclosure. Thus, the neural network model optimization device 1500 may also be referred to as a dedicated neural network model emulator or neural network model simulator of the neural processing unit 100a in the edge device 1000.

The edge device 1000 may include the neural processing unit 100a, the memory 200a, the CPU 300a, and the interface 400a.

The neural network model optimization device 1500 may include a neural processing unit (NPU) or graphics processing unit (GPU) 100b, memory 200b, CPU 300b, and interface 400b.

The neural network model optimization device 1500 may be in communication with the neural processing unit 100a in the edge device 1000. To this end, the interface 400b of the neural network model optimization device 1500 may establish a link or session with the interface 400a of the edge device 1000. The interface may be an interface based on IEEE 802.3 for wired LAN or IEEE 802.11 for wireless LAN. Alternatively, the interface may be a peripheral component interconnect express (PCIe) based interface or a personal computer memory card international association (PCMCIA) based interface. Alternatively, the interface may be a universal serial bus (USB) based interface. However, the examples of the present disclosure are not limited to any particular interface and various interfaces may be employed.

The neural network model optimization device 1500 may improve a neural network model to be driven by the neural processing unit 100a in the edge device 1000. To this end, the neural network model optimization device 1500 may receive the neural network model from the edge device 1000. Alternatively, the neural network model optimization device 1500 may be configured to separately receive a neural network model from an external device.

When the neural network model optimization device 1500 receives the neural network model to be executed by the neural processing unit 100a in the edge device 1000, the model may be stored in the memory 200b in the neural network model optimization device 1500.

If the provided neural network model is generated by a particular machine learning framework, the neural network model may not be immediately operable on the edge device 1000. Therefore, the compiler 300b-10 of the neural network model optimization device 1500 may be configured to compile the neural network model to generate machine code that is operable on the neural processing unit 100a of the edge device 1000.

The compiler 300b-10 may be embodied as a semiconductor circuit. Alternatively, the compiler 300b-10 may be embodied as software stored in the memory 200b and executed by the CPU 300b. The CPU 300b in the neural network model optimization device 1500 may execute the compiler 300b-10. The compiler 300b-10 may be a software or a group of software that work together. For example, certain submodules of the compiler 300b-10 may be included in the first software, and other submodules may be included in the second software. The compiler 300b-10 may compile a neural network model stored in the memory 200b by improving it for the neural processing unit 100a of the edge device 1000.

To improve the neural network model, the neural network model optimization device 1500 may analyze the neural network model to be updated. Specifically, the compiler 300b-10 of the neural network model optimization device 1500 may analyze the neural network model. The neural network model optimization device 1500 may analyze parameter information of each layer of the neural network model. The neural network model optimization device 1500 may analyze the size of the weight parameters and feature map parameters of each layer. The neural network model optimization device 1500 may also analyze the connectivity between the respective layers. The neural network model optimization device 1500 may analyze the magnitude of the input parameters and output parameters of each layer. Here, a parameter of the multidimensional matrix may be referred to as a tensor. The neural network model optimization device 1500 may analyze the function modules applied to each layer. The neural network model optimization device 1500 may analyze the bifurcation points of a particular layer. The neural network model optimization device 1500 may analyze the merge points of the particular layers.

Further, the neural network model optimization device 1500 may analyze non-graph-based function modules applied to each layer. The neural network model optimization device 1500 may convert the non-graph-based function modules into graph-based modules. For example, the non-graph-based functions included in each layer may include, for example, add function, subtract function, multiply function, divide function, convolution function, matrix multiplication function, slice function, concatenation function, tensor view function, reshape function, transpose function, softmax function, permute function, chunk function, split function, clamp function, flatten function, tensor mean function, and sum function. The slice function may extract a portion of the tensor. The slice function may be used to select a particular element or range in a particular dimension of the tensor. The concatenation function can combine two or more tensors along a specified axis. The concatenation function is used to connect tensors to create a larger tensor, and can often be utilized to combine data along batch or feature dimensions. The tensor view function can reshape a tensor without changing the data. The tensor view function can change the appearance of a tensor by providing a different representation of the same data, making it compatible with different operations. The reshape function can change the shape of a tensor. The reshape function is used to modify the dimensions of a tensor and can change the existing data if the new shape is incompatible with the existing data. The transpose function can swap the dimensions of a tensor. The transpose function can be used to swap the dimensions of a tensor, primarily for operations such as matrix multiplication. The softmax function can transform a vector of real numbers into a probability distribution. The softmax function is often used in multi-class classification problems to obtain class probabilities from the output layer of a neural network. The permute function can change the dimensions of a tensor in a specified order. The permute function is similar to the transpose function, but the dimensions can be reordered arbitrarily. The chunk function can break the tensor into a specific number of chunks along the specified dimensions. The chunk function can be used to divide a tensor into chunks of equal size or a specified size. The split function can split a tensor into multiple tensors along a specified dimension. Unlike chunk, the split function can provide more flexibility to specify the size of the resulting chunks. The clamp function can clip the values of a tensor to within a specified range. The clamp function can be useful for constraining the value of a tensor to a specific range in updating scenarios. The flatten function can convert a multidimensional tensor to a one-dimensional tensor. The flatten function is often used in neural networks to transition from a convolutional layer to a fully connected layer. The tensor mean function can compute the average of a tensor along a specified dimension. The tensor mean function is often used for normalization or data summarization and can be useful for obtaining the average value of a tensor along a particular axis. These functions may be provided as non-graph-based functions in certain machine learning framework. The neural network model optimization device 1500 may explore the non-graph-based functions.

The neural network model optimization device 1500 may further receive data about the hardware of the neural processing unit 100a within the edge device 1000. Data about the hardware of the neural processing unit 100a may include, for example, information about the internal memory 120 within the neural processing unit 100a (e.g., size of the internal memory, bitwidth of read/write operations to the internal memory, information about the type/structure/speed of the internal memory), information about whether integer or floating-point operations are supported, and if so, how many bits of integer can be operated on (e.g., int8, and the like), information about whether it can operate on floating-point numbers, and if so, how many bits of floating-point numbers can be supported, information about the frequency of operation, information about the number of PEs, information about the type of special function unit, and the like. However, the present disclosure is not limited thereto.

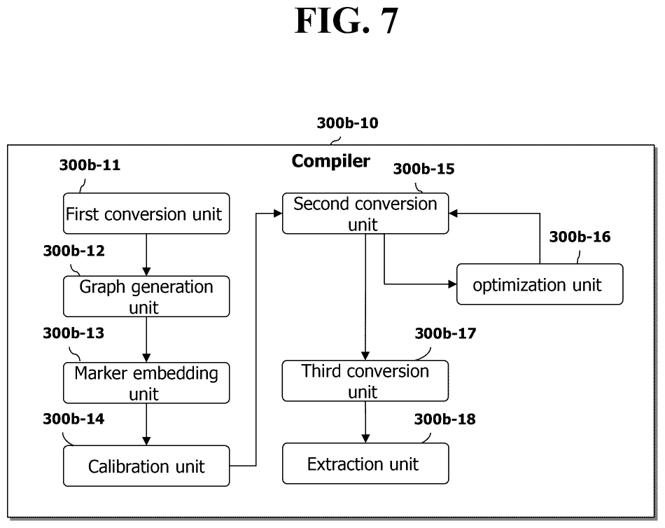

To improve the neural network model, the compiler 300b-10 may include the components shown in FIG. 7. The memory 200b in the neural network model optimization device 1500 may store the software when the compiler 300b-10 is implemented as software, as described above. The CPU 300b of the neural network model optimization device 1500 may execute the software. The memory 200b in the neural network model optimization device 1500 may store a neural network model to be driven by the neural processing unit 100a in the edge device 1000. Further, when updating the neural network model is completed in the neural network model optimization device 1500, the memory 200b in the neural network model optimization device 1500 may store the updated neural network model.

FIG. 7 is a diagram illustrating the compiler 300b-10 of FIG. 6, according to one embodiment. As can be seen with reference to FIG. 7, the compiler 300b-10 may include, among other components, a first conversion unit 300b-11, a graph generation unit 300b-12, a marker embedding unit 300b-13, a calibration unit 300b-14, a second conversion unit 300b-15, an optimization unit 300b-16, a third conversion unit 300b-17, and an extraction unit 300b-18. The optimization portion 300b-16 may be optionally executed depending on compilation options. Each components in FIG. 7 may be implemented as software, firmware and/or hardware.

In a non-graph-based neural network model, at least some of the operations of each layer of the plurality of layers are processed using a function call technique. The function call method is a way to process neural network operations by calling a predefined function and feeding corresponding input parameters to the function. This method can be convenient in terms of coding when designing a neural network model. However, in order to compile a non-graph-based neural network model (i.e., a first neural network model) for accelerated computation on the neural processing unit 100a of the edge device 1000, several technical issues need to be addressed.

First, a non-graph-based (i.e., function-calling) neural network model may not be compilable by a compiler of the neural processing unit 100a of a particular structure, e.g., a compiler for the neural processing unit 100a of a particular structure may be designed to compile only graph-based neural network models, e.g., the compiler may not be able to compile a function-calling neural network model. The reason for this is that in a function-calling neural network model, the connections between the computational steps of each layer are not clearly defined, e.g., the flow of the computational steps of each layer (i.e., the connections between each graph module) of a non-graph-based (i.e., function-calling) neural network model may not be clearly defined. Specifically, because function-calling methods only operate when a function is called, the inputs and outputs outside of the neural network model may not be traceable. When a function of such a function call method is converted to a graph module, the compiler 300b-10 can track the inputs and outputs of the graph modules of the neural network model to be compiled. The graph module for a function call may be defined in advance. Also, for the above graph modules, a function that inherits a module class can be defined in advance, so that a directed acyclic graph (DAG) can be generated by connecting the graph modules.

Next, in the case of the neural processing unit 100a of the edge device 1000, the internal memory (on-chip memory) may have a limited capacity, and in the case of an operation scenario with a small memory capacity, the caching efficiency of the data may have a significant impact on the performance of the edge device 1000. That is, if a neural network model is compiled without analyzing the connective relationship between each operation step in advance, the caching efficiency of the data may be reduced in the neural processing unit 100a of the edge device 1000. If the caching efficiency decreases, the amount of data transfer between the NPU internal memory 120 and the main memory 200a of the neural processing unit 100a of the edge device 1000 may increase unnecessarily (e.g., copying redundant data, moving unnecessary data, and deleting data to be used later).

In the case of a graph-based neural network model (e.g., a second neural network model) utilizing the graph modules converted in the first conversion unit 300b-11 of the compiler 300b-10 according to an example of the present disclosure, the connective relationship between each layer may be clearly analyzed. For example, the compiler 300b-10 may analyze the connectivity of the output data of the first layer of a typical neural network model, the output data of the first layer is utilized as input data for the second layer associated with the first layer. Furthermore, since the series of computational steps contained within each layer may also be represented by graph modules, the connective relationships within each layer may also be clearly defined. Thus, the compiler 300b-10 may utilize the above connectivity relationships during the compilation to improve memory management (e.g., caching) of the NPU internal memory 120 of the neural processing unit 100a of the edge device 1000. Additionally, the compiler 300b-10 may determine job-scheduling of the neural processing unit 100a processing a particular neural network model based on the above connectivity relationships during the compilation.

Therefore, in order to improve the computational acceleration of the neural network model in the neural processing unit 100a of the edge device 1000, the non-graph-based neural network model may be converted into a graph-based neural network model. Furthermore, compiling a graph-based neural network model may be more efficient than compiling a function-calling neural network model because the number of unexpected cases may be reduced during compilation.

The following describes a method for converting a function call type neural network model into a graph-based neural network model through a compiler 300b-10, and then quantizing the parameters of the neural network model. First, the first conversion unit 300b-11 receives a first neural network model as input. At least one layer of the first neural network model may include at least one function call instruction. That is, the first neural network model may be a neural network model including at least one function call instruction. The compiler 300b-10 performs a series of steps to improve the first neural network model.

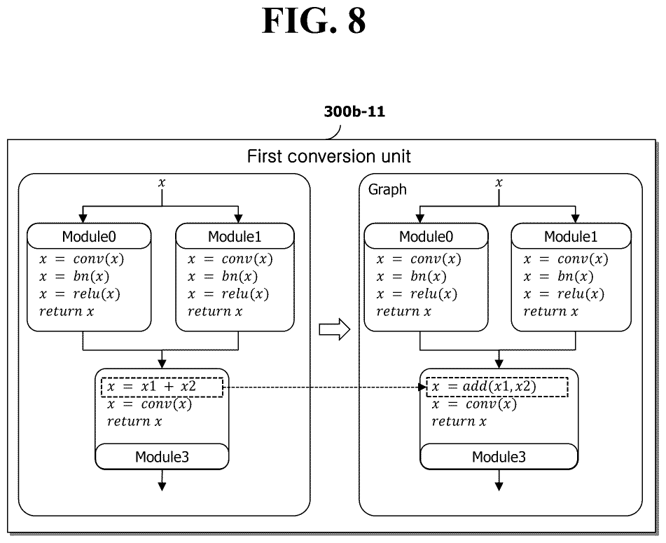

The first conversion unit 300b-11 may convert multiple function call instructions in the first neural network model into corresponding graph modules. The first conversion unit 300b-11 is described with reference to FIG. 8.

The compiler 300b-11 according to an example of the present disclosure may receive input of a non-graph-based or graph-based first neural network model. The first neural network model may be a neural network model generated based on a first machine learning framework. The first machine learning framework may be software that supports graph-based and non-graph-based neural network models.

The compiler 300b-10 according to an example of the present disclosure may be software configured to receive a non-graph-based neural network model as input, convert it to a graph-based neural network model, and then perform quantization. For example, the first neural network model may be a neural network model generated based on machine learning framework, such as PyTorch™, TensorFlow™, and the like. However, the present disclosure is not limited to any particular machine learning framework.

According to an example of the present disclosure, the first conversion unit 300b-11 may convert various operation functions in the first neural network model into corresponding graph modules. Accordingly, a compiler 300b-10 can connect the converted graph modules to form a graph-based neural network model. The first conversion unit 300b-11 may convert all function calls of the first neural network model into corresponding graph modules.

Next, the graph generation unit 300b-12 may utilize the graph modules converted by the first conversion unit 300b-11 to analyze the relationships (e.g., connectivity) between the inputs and outputs of the various modules in the first neural network model. Accordingly, the graph modules whose relationships with each other have been analyzed can be connected to each other according to the relationships.

The graph generation unit 300b-12 may generate a graph-based second neural network model based on the converted graph modules and the analyzed relationship. The second neural network model may be generated based on the first neural network model. Specifically, based on the analyzed connective relationship of the converted graph modules in the first conversion unit 300b-11, the graph generation unit 300b-12 may generate a second neural network model based on a graph in which graph modules are connected. More specifically, the graph generation unit 300b-12 may generate a second neural network model including a plurality of modules of connected graphs by mapping at least one input of the plurality of modules to at least one output of the plurality of modules. The graph-based modules already present in the first neural network model can be included in the second neural network model without any conversion. The graph modules may also be referred to hereinafter as “modules.” Thus, by constructing the second neural network model, the compiler 300b-10 can analyze a sequence of operations that could not be analyzed in the first neural network model.

The non-graph-based function calls may include, for example, non-graph-based function call instructions such as add function, subtract function, multiply function, divide function, slice function, concatenation function, tensor view function, reshape function, transpose function softmax function, permute function, chunk function, split function, clamp function, flatten function, tensor mean function, sum function, and the like.

The compiler 300b-10 may receive the neural network model generated by the first machine learning framework as input and convert the non-graph-based function calls into corresponding graph modules, and connects the graph modules to each other according to the analyzed relationships of each module. In this way, the second neural network model can be represented as a directed acyclic graph (DAG) with connected graph modules.

FIG. 8 is a block diagram illustrating the first conversion unit 300b-11 shown in FIG. 7. Referring to FIG. 8, the first conversion unit 300b-11 may convert various computational functions in the first neural network model into corresponding graph-based modules (e.g., graph modules). For example, the function call instructions of the first machine learning framework shown on the left side of FIG. 8 can be converted to the graph modules shown on the right side of FIG. 8. Specifically, x=x1+x2 on the left side of FIG. 8 is an undefined function. Since these functions are utilized only when the above functions are called, their inputs and outputs are not traceable outside of the neural network model.

On the other hand, the add(x1,x2) graph module on the right side of FIG. 8 is predefined, so its input and output can be traced. In addition, for the above graph module, a function inheriting from the module class is defined in advance to generate the graph, which can be configured to selectively add markers to the input and output as needed.

Additionally, the first machine learning framework includes basic arithmetic operations and function call instructions, but is accessed on a module-by-module basis rather than on the basis of an operation as a unit. Before the conversion, the inputs and outputs of the smallest unit of operation may not be monitored. However, when converted to a graph-based module, the inputs and outputs of all operations can be monitored, and a graph can be generated. In other words, one of the main differences between function calls and graph-based modules is the ability to monitor and trace values in all associated operations.

Specifically, the graph of the first machine learning framework shown on the left side of FIG. 8 includes the operations conv, bn, relu, and plus (+). In FIG. 8, conv, bn, relu are graph modules, but the plus (+) operation is a function call. Therefore, the plus (+) operation can be converted to an add graph module. conv stands for convolution graph module. bn stands for batch-normalization graph module. relu stands for the ReLU activation function graph module. The plurality of graph modules may be grouped, and the grouped graph modules may be referred to as subgraph modules of the group. That is, the first conversion unit 300b-11 is configured to convert all the function call instructions into corresponding graph modules.

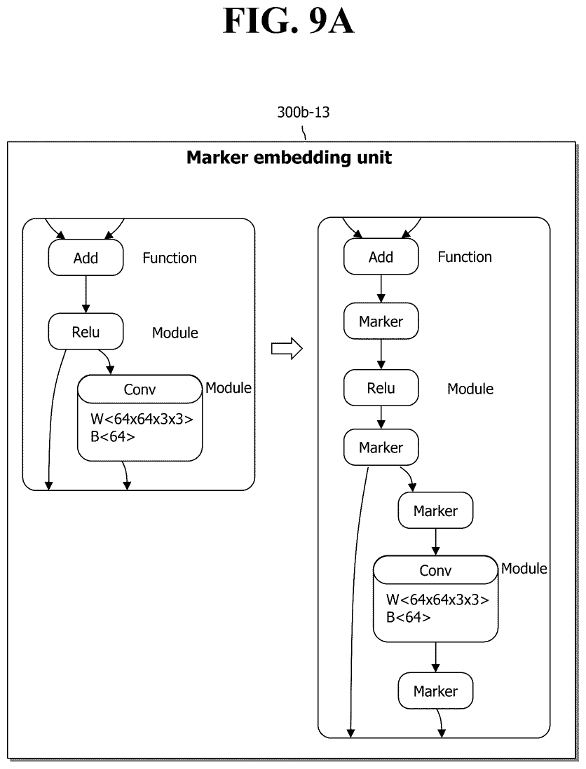

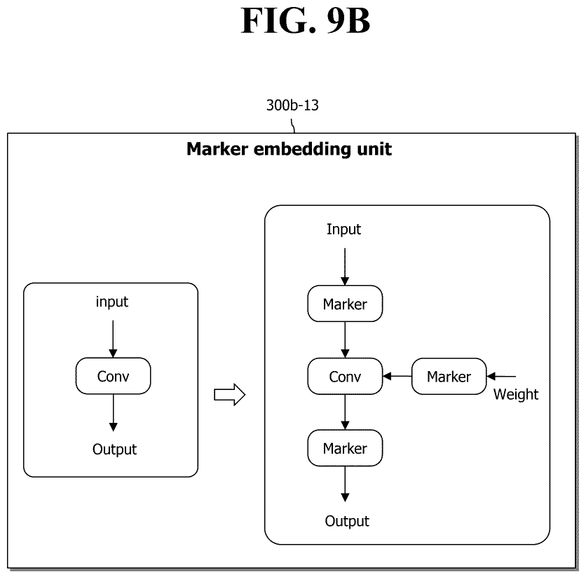

Next, the marker embedding unit 300b-13 may add markers for tracking to each module of the second neural network model. By using the markers added to the second neural network model, calibration data may be collected at the input and output of each graph module. The markers are described below with reference to FIGS. 9A and 9B. As an example, the calibration data may be utilized to reduce inference accuracy degradation when quantizing the parameters of the second neural network model. The marker may also be referred to as tracking module, tracker, observer, and scope.

FIG. 9A is a diagram illustrating the marker embedding unit 300b-13 shown in FIG. 7 as an example. The marker embedding unit 300b-13 can add a module for tracking, e.g., a marker, to each module of the second neural network model. As can be seen with reference to FIG. 9A, markers may be added to the input and output ends of the Relu module and the input and output ends of the Conv module, respectively. The markers added to each module can collect input and output values, respectively.

FIG. 9B is another diagram illustrating the marker embedding unit 300b-13 shown in FIG. 7 as an example. As can be seen with reference to FIG. 9B, markers may be added to the input and the output of the Conv module, respectively. In this case, a marker may also be added to the input where the weight parameters are input to the Conv module.

Next, a module that collects calibration data by adding markers to the second neural network model may be referred to as a calibration unit 300b-14. Markers may be selectively embedded to modules to be collected with calibration data and markers may not necessarily be added to all graph modules. Markers may be added to both the input and output of a single graph module. Thus, calibration data may be obtained from the inputs and outputs of each of the corresponding graph modules. For example, markers may be added to each graph module where quantized parameters are used in the second neural network model.

Referring to FIG. 7, calibration data may be obtained by the calibration unit 300b-14 by inputting a calibration dataset into the second neural network model. The calibration dataset may be, for example, a batch of tens or hundreds of images for an inference test. The more relevant the calibration dataset is to the dataset that trained the second neural network model, the better.

For example, if the second neural network model is a neural network model trained for autonomous driving, it is desirable that the training dataset include datasets related to autonomous driving. If the second neural network model is a neural network model trained for object detection by a camera of a drone, the training dataset preferably include a dataset related to object detection by a camera of a drone. If the second neural network model is a neural network model trained to distinguish the gender of a person, the calibration dataset preferably includes a dataset related to the gender of the person. If the second neural network model is a neural network model trained to detect defects in a particular product, the calibration dataset preferably includes datasets related to the product. If the second neural network model is a neural network model trained to determine the license plate of a vehicle, the training dataset preferably includes datasets related to the license plate of the vehicle. In other words, the calibration dataset can be the dataset that corresponds to the inference purpose of the second neural network model.

When feeding the calibration dataset into the second neural network model, the calibration unit 300b-14 may collect calibration data (e.g., input values and output values of the graph modules to which the markers are embedded) from each of the graph modules to which the markers are added, respectively. In other words, the calibration data may be generated independently for each marker, and the calibration data includes respective calibration data collected by a plurality of markers.

The calibration unit 300b-14 of the compiler 300b-11 may generate the calibration data by feeding the calibration dataset to the second neural network model and collecting the measured values. In one embodiment, the number of calibration data may correspond to the number of markers added to the second neural network model. For example, if a marker is added to each of the input and output of one graph module, the calibration data may be generated to correspond to each of the input and output of the graph module.

The calibration data obtained by inputting the calibration dataset into the second neural network model may be stored in the memory 200b. The calibration dataset may also be stored in the memory 200b. Thus, the respective calibration data collected from the respective graph modules may be stored in the memory 200b. Thus, the generation of the calibration data of the second neural network model in the calibration unit 300b-14 may be completed.

Next, the second conversion unit 300b-15 simulates quantization of the parameters of the second neural network model. In one embodiment, the parameters of the second neural network model are in the floating-point format, but the result of quantization of the parameters can be simulated (e.g., pseudo-quantization). For example, the parameter of the second neural network model input to the second conversion unit 300b-15 may be a 32-bit floating-point. The parameters of the neural network models may include feature maps (e.g., activations), weights, and the like. The feature maps may be referred to as input feature maps, output feature maps, activation maps, and the like. Since the output feature map may be the input feature map for the next layer, the output feature map and the input feature map may in some cases refer to substantially the same parameter. Weights may also be referred to as kernels. If the neural network model is a transformer, the parameters may be referred to as query (Q), key (K), and value (V), and attentions (Q,K,V), and the like.

Accordingly, the second conversion unit 300b-15 may calculate a corresponding quantized parameter based on the calibration data generated by the calibration unit 300b-14 for the parameter in the form of floating-point of the second neural network model. A method of quantization simulation of the parameters of the second neural network model will be described in detail below.

The compiler 300b-10 may calculate a scale value and an offset value for quantization in the form of floating-point parameter based on the calibration data. In detail, the scale value and the offset value may be calculated according to Equation 1 below. The scale value and the offset value may be calculated for each calibration data generated at each marker. For example, a first scale value and a first offset value for a particular graph module associated with a first marker can be calculated based on a first maximum value, a first minimum value, and a targeted bitwidth of quantization of the first calibration data measured at the first marker. For example, a second scale value and a second offset value for a particular graph module associated with the second marker can be calculated based on a second maximum value, a second minimum value, and a targeted bitwidth of quantization of the second calibration data measured at the second marker. The first marker may collect input values of the first graph module and the second marker may be configured to collect output values of the first graph module. In other words, in the example described above, a first scale value and a first offset value corresponding to the input values of the first graph module may be calculated, and a second scale value and a second offset value corresponding to the output values of the first graph module may be calculated. Referring to Equation 1 below, the calculation is described in detail.

$$scale = \frac{max - min}{{2}^{bitwidth} - 1} , offset = \frac{- min}{scale} \qquad Equation 1$$

In Equation 1, max represents the maximum value, min represents the minimum value, and bitwidth represents the target quantization bitwidth among the calibration data collected at a particular marker. This means that a single graph module can have the same or different quantization levels for input and output. Furthermore, the quantization degree of each graph module can be the same or different.

Thus, the max and min values of a particular calibration data corresponding to a particular graph module can be entered into Equation 1. The scale value and the offset value may be utilized to reduce inference accuracy degradation due to quantization errors when quantizing the parameters of the second neural network model (e.g., feature maps and weights). Furthermore, if the quantization is performed using a scale value and an offset value that reflect data distribution characteristics of a particular graph module, the deterioration of inference accuracy due to quantization errors may be reduced. Furthermore, if quantization is performed by utilizing scale values and offset values reflecting data distribution characteristics of a plurality of graph modules included in the second neural network model, the deterioration of inference accuracy due to quantization of the second neural network model can be further reduced. Further, the collected calibration data may include at least one of a distribution histogram, a minimum value, a maximum value, and a mean value of the data.

The scale value corresponding to the feature map may be referred to as s_{f}. A scale value corresponding to a weight may be referred to as s_{w}. The offset value corresponding to the feature map may be referred to as o_{f}. The offset value corresponding to the weight may be referred to as o_{w}.

This is followed by Equation 2, which quantizes the feature map parameter feature_{fp} into featureᵢₙₜ reflecting the calibration data.

$${feature}_{int} = ⌊ \frac{{feature}_{fp} - {o}_{f}}{{s}_{f}} ⌋ = clip \{ round ( \frac{{feature}_{fp} - {o}_{f}}{{s}_{f}} ) , {Q}_{min} , {Q}_{max} \} \qquad Equation 2$$

where featureᵢₙₜ represents the quantized feature map, feature_{fp} represents the feature map in a form of floating-point to be quantized, of represents the offset value of Equation 1 for the feature map in the form of floating-point to be quantized, s_{f} represents the scale value of Equation 1 for the feature map in a form of floating-point to be quantized, and └ ┘ represents the round and clip operations, where Qₘᵢₙ represents −2n−1, Qₘₐₓ represents 2n−1−1, where n is the bitwidth.

Therefore, the feature map in a form of floating-point reflecting the calibration data can be quantized using Equation 2. However, the featureᵢₙₜ is a value that simulates the quantization, and in practice, it may be stored in the memory 200b in the form of floating-point. In addition, the value calculated by Equation 2 may have a quantized integer value, but may be processed by the compiler 300b-10 substantially as a floating-point value. That is, in the second conversion unit 300b-15, the featureᵢₙₜ may be a pseudo-integer and the featureᵢₙₜ may represent a substantially quantized value, but may be stored in the memory 200b as a floating-point value.

The feature map may further include outliers based on the input data. These outliers may cause quantization errors to be amplified during quantization. Therefore, it is desirable that the outliers are appropriately compensated. For example, outliers may be compensated for by applying a moving average algorithm to the calibration data. By applying the moving average algorithm to the respective calibration data, minimum and maximum values can be obtained from which outliers are mitigated. However, the examples of the present disclosure are not limited to this and can be configured to compensate for outliers in the feature map through various compensation algorithms. That is, it is possible to reduce the impact of outliers in the feature map by truncating the outliers in the calibration data during quantization. According to one example of the present disclosure, a step 300b-16 may be added to update the parameters (e.g., input parameters, weight parameters) by mitigating outliers. Accordingly, in an example of the present disclosure, each of the calibration data corresponding to a feature map utilizing Equation 1 and Equation 2 may include max and min values for which outliers are compensated. Accordingly, the feature map may be the input value (e.g., input feature map) or the output value (e.g., output feature map) of a corresponding graph module.

The quantized feature map may be stored in memory 200b.

Next, Equation 3 is described, which may quantize a weight parameter weight_{fp} into weightᵢₙₜ reflecting calibration data.

$${weight}_{int} = ⌊ \frac{{weight}_{fp}}{{s}_{w}} ⌋ = clip \{ round ( \frac{{weight}_{fp}}{{s}_{w}} ) , {Q}_{min} , {Q}_{max} \} \qquad Equation 3$$

where weightᵢₙₜ represents the quantized weight, weight_{fp} represents the weight in a form of floating-point to be quantized, s_{w} represents the scale value in Equation 1 for the weight in a form of floating-point to be quantized, and └ ┘ represents the round and clip operations, where Qₘᵢₙ means −2n−1, Qₘₐₓ means 2n−1−1, where n is the bitwidth.

The weight parameters reflecting the calibration data can be quantized via Equation 3. However, weightᵢₙₜ may be a value that simulates quantization and may be stored in the memory 200b in a data format that is actually a floating-point. That is, the value calculated using Equation 3 has a quantized integer value, but may be processed by the compiler 300b-10 in a substantially floating-point form. That is, in the second conversion unit 300b-15, weightᵢₙₜ may be a pseudo-integer, i.e., weightᵢₙₜ may represent a substantially quantized value, but the stored data in memory 200b may be in a form of floating-point.

The quantized weights may be stored in memory 200b.

The second neural network model may include a plurality of layers, each layer including at least one graph module. When the plurality of graph modules are interconnected, the quantization error may accumulate each time a graph module is traversed. Therefore, as the structure of the second neural network model becomes more complex and the number of layers increases, the quantization according to Equation 1 to Equation 3 may reduce the accumulation of the deterioration of the inference accuracy due to the quantization error of the second neural network model. In other words, if a floating-point parameter is quantized to an integer parameter by analyzing the data distribution, the deterioration of the inference accuracy of the second neural network model due to quantization may be reduced.

According to an example of the present disclosure, quantization using calibration data generated by analyzing the data distribution may be referred to as clipping quantization. Clipping quantization according to Equation 1 to Equation 3 may utilize the maximum and minimum values of the calibration data to quantize within a valid data distribution. Clipping quantization can be particularly useful when there are outliers that can affect the accuracy of the quantization. Compiler 300b-10 may optionally perform clipping quantization to handle outliers in the feature map.

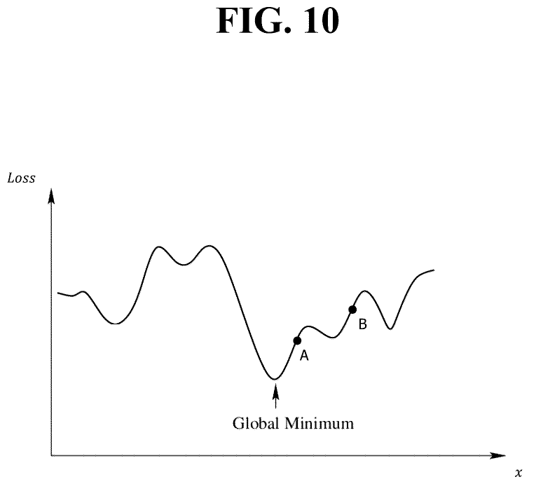

Referring to FIG. 10, the X-axis indicates the degree of outliers. The point with zero outlier indicates a global minimum of the loss value. The further away the outlier is from the global minimum, the higher the loss of the quantized neural network model. Using Equation 1 or Equation 3, the floating-point parameter of the second neural network model quantized to a certain bitwidth (point A in FIG. 10) can increase the probability that the value is relatively close to the global minimum of the quantization error. If quantization is performed without utilizing Equation 1 or Equation 3, the quantized value may be a value (point B in FIG. 10) that is further away from the global minimum than the value (point A in FIG. 10) that is relatively close to the global minimum.

When the quantization calculation of the parameters of the second neural network model is completed, the second conversion unit 300b-15 may remove the markers added for tracking in the second neural network model. The markers added to the second neural network model may be deleted in the second conversion unit 300b-15 after obtaining the calibration data through the calibration unit 300b-14. After the quantized parameters are obtained based on the calibration data, the markers are no longer needed in the second neural network model. However, the examples of the present disclosure are not limited thereto.

Referring again to FIG. 7, the optimization unit 300b-16 may perform an optimization on the quantization parameters calculated by the second conversion unit 300b-15. When the optimization unit 300b-16 performs the operations to improve the quantization parameters (e.g., the scale value and/or the offset value), the second conversion unit 300b-15 may generate a third neural network model comprising quantized weight parameters in an integer format based on the second neural network model, based on the updated scale value and the updated offset value.

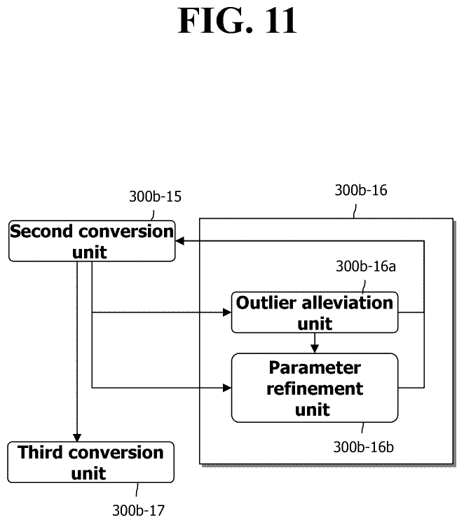

FIG. 11 is a diagram illustrating the optimization unit 300b-16 shown in FIG. 7 as an example. The second conversion unit 300b-15 may calculate the corresponding quantization parameters of the floating-point parameters of the second neural network model based on the calibration data generated by the calibration unit 300b-14. The compiler 300b-10 may optionally update the input parameters, the weight parameters, the scales and offsets of the input parameters, the scales of the weight parameters, and the like for improved quantization in the optimization unit 300b-16 according to the compilation options.

The input parameters are the input values for each graph module, which may include outliers according to the actual data. Outliers can be meaningful values, but they can cause quantization errors to be amplified when quantizing. In other words, outliers may not be an issue when they are floating-point numbers, but may become a larger issue after being quantized into integers. In particular, outliers can become more problematic as the bitwidth of the quantization is reduced. In this case, outliers can be compensated for. On the other hand, simply removing outliers for the sake of quantization may result in the removal of potentially meaningful outliers. The optimization unit 300b-16 according to one example of the present disclosure may mitigate some of the outliers of the input parameters by transferring some of the outliers of the input parameters to the weighting parameters corresponding to the input parameters using an adjustment value for adjusting the outliers, while maintaining some of the outliers in the weight parameters. In this case, the outliers are not removed, but rather the burden of the outliers is shared among the operands of the operator. In general, if outliers above a certain range are removed to compensate for outliers fairly, the computational results before and after outlier compensation may differ, but according to the present disclosure, the computational results before and after outlier mitigation are the same. Thus, in effect, it is possible to perform quantization in the graph module with outliers in the operands of the MAC operation while only reducing the quantization error.

The optimization unit 300b-16 may include the outlier alleviation unit 300b-16a and/or the parameter refinement unit 300b-16b. According to the compilation option, if only outlier alleviation is performed, the second conversion unit 300b-15 may determine the scale and offset after the outlier alleviation unit 300b-16a performs outlier alleviation on the second neural network model. If only parameter refinement is performed according to the compilation option, the parameter refinement unit 300b-16b may refine the scales and offsets after the second conversion unit 300b-15 determines the scales and offsets for the second neural network model. If both outlier alleviation and parameter refinement are performed according to the compilation option, after the outlier alleviation unit 300b-16a performs outlier alleviation for the second neural network model, the second conversion unit 300b-15 may determine the scale and offset, and the parameter refinement unit 300b-16b may perform parameter refinement for the determined scale and offset. In one example of the present disclosure, instead of the optimization unit 300b-16 determining the scale and offset values for the second neural network model in the second conversion unit 300b-15, the optimization unit 300b-1 may determine the scale and offset after the outlier alleviation unit 300b-16a performs outlier alleviation for the second neural network model, and the parameter refinement unit 300b-16b performs parameter refinement for the determined scale and offset.

The outlier alleviation unit 300b-16a may, with respect to a graph module comprising a multiply and accumulate (MAC) operation (e.g., a convolutional or matrix multiplication operation), use an adjustment value for adjusting the outliers to mitigate a portion of the outliers included in the input parameters, while weighting the weight parameters by the amount by which the outliers in the input parameters are mitigated. For example, the outlier alleviation unit 300b-16a may partially process a portion of the outliers included in the input values to be applied with the weight values by calculating an adjustment value for adjusting the outliers with respect to the input values of the first graph module of the second neural network model and the weight values of the first graph module, multiplying the input values of the first graph module by the reciprocal of the adjustment value, and multiplying the weight values of the first graph module by the adjustment value. The adjustment value for adjusting outliers with respect to the weight value may be referred to as the first adjustment value, and the reciprocal of the adjustment value corresponding to the input value may be referred to as the second adjustment value. However, according to one case, the first adjustment value may be referred to as the second adjustment value, and the second adjustment value may be referred to as the first adjustment value. The outlier alleviation unit 300b-16a may not remove outliers, but rather share changes across the variables of the MAC operation due to outliers, and as a result, the result of the MAC operation includes outliers even if quantization of the parameters is performed. Accordingly, the degree of quantization error may be reduced by the adjustment values.

The outlier alleviation unit 300b-16a may collect the values of the input parameters and the values of the weight parameters using the markers added to each graph module to generate the first calibration data, and may calculate the adjustment value based on the first calibration data.

The form of the adjustment value for outlier adjustment may be determined according to the form of the operands of the MAC operations included in the graph module. If the operands are in the form of a matrix, the adjustment value may be defined as a matrix of appropriate size to be involved in the operation. The dimensionality of the matrix here can be one or more dimensions, and can be two, three, or multi-dimensional. The adjustment value may be calculated using the maximum of the absolute values of each channel of the input parameters and the maximum of the absolute values of each channel of the weight parameters. The adjustment value may be a set including a plurality of constants for the input parameter and the weight parameter, where the number of elements of the set of the adjustment values may correspond to the number of channels of the input parameter and the weight parameter. The set of adjustment values may be defined in the form of a matrix.

The adjustment value may be calculated by dividing the maximum of the absolute values for each channel of the input parameter by the maximum of the absolute values for each channel of the weight parameter based on the first calibration data. To appropriately maintain the scale of the adjustment value, the maximum of the absolute values of each channel of the input parameter may be divided by the maximum of the absolute values of each channel of the weight parameter, and may be taken as a logarithm.

The outlier alleviation unit 300b-16a may update the input parameters and weight parameters based on the adjustment value for each graph module of the second neural network model, taking quantization into account. Specifically, the input parameters of each graph module may be multiplied by the reciprocal of the adjustment value, and the weight parameters may be multiplied by the adjustment value to update each parameter. Since the data range (between a minimum value and a maximum value) of the input parameter is typically larger than the data range (between a minimum value and a maximum value) of the weight parameter, the adjustment value may be a number greater than one, and may have the effect of decreasing the data range of the input parameter and increasing the data range of the weight parameter, e.g., a first example adjustment value corresponding to the input parameter may have a value that decreases the magnitude of the input parameter, and a second example adjustment value corresponding to the weight parameter may have a value that increases the magnitude of the weight parameter. In some examples, when the data range of the input parameter is smaller than the data range of the weight parameter, the adjustment value may be a number less than one, decreasing the data range of the weight parameter and increasing the data range of the input parameter. If the adjustment value is one, the values of the input parameter and the weight parameter remain unchanged.

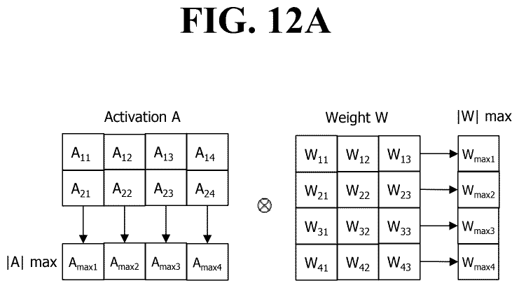

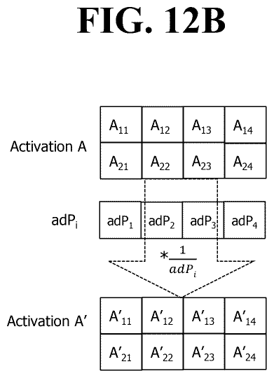

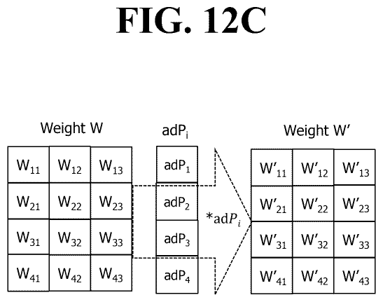

The second conversion unit 300b-15 may calculate scales, offsets, and the like for quantization based on the updated (i.e., outlier alleviated) input parameters and weight parameters. The second conversion unit 300b-15 may calculate the scale and offset values of the parameters for each graph module using the second calibration data obtained by the calibration unit 300b-14. In FIGS. 11 to 12C, for convenience of explanation, the calibration data collected by the outlier alleviation unit 300b-16a using the markers added to each graph module may be referred to as the first calibration data, and the calibration data collected by the calibration unit 300b-14 using the markers added to each graph module may be referred to as the second calibration data.

FIGS. 12A, 12B, and 12C are examples to illustrate each step of operation of the outlier alleviation unit 300b-16a according to one example of the present disclosure.

The outlier alleviation unit 300b-16a may alleviate outliers included in the operands of the MAC operation by transferring some of the outliers among the operands, such that the outliers in each operand are alleviated while the result of the MAC operation remains the same. In one example, this is the same as converting an A⊗W operation to (A*ad⁻¹)⊗(W*adP) where adP represents the outlier adjustment.

The outlier alleviation unit 300b-16a may calculate an adjustment value based on the first calibration data that collects input parameters and weight parameters using markers added to each graph module. In one example, the outlier alleviation unit 300b-16a may perform 50 calibrations to collect the first calibration data using the markers added to each graph module. In one example, the outlier alleviation unit 300b-16a may obtain an adjustment value using the maximum value of the input parameter and the maximum value of the weight parameter. The adjustment value may be for adjusting the data range, and the outlier alleviation unit 300b-16a may obtain a maximum value of the absolute value of the input parameter and a maximum value of the absolute value of the weight parameter to obtain a positive maximum value.

The format of the adjustment value may be determined according to the format of the operands. For example, if the operands are matrices, the adjustment value may also be a matrix. If the first operand is an M*I matrix and the second operand is an I*N matrix, an adjustment value matrix 1*I can be generated for channel I. Referring to FIG. 12A, activation A is a 2*4 matrix, weight W is a 4*3 matrix, and corresponds to the operands of a convolutional operation.

The outlier alleviation unit 300b-16a may obtain the maximum of the channel-specific absolute values for each of the first operand and second operand of the MAC operation. For example, the set of channel-wise maximum values for the A matrix may be {Aₘₐₓ₁, Aₘₐₓ₂, Aₘₐₓ₃, Aₘₐₓ₄}. For example, the set of channel-wise maximum values for the W matrix may be {Wₘₐₓ₁, Wₘₐₓ₂, Wₘₐₓ₃, Wₘₐₓ₄}.

In one example of the present disclosure, the adjustment value may be obtained as shown in Equation 4. However, the examples of the present disclosure are not limited to Equation 4, and the adjustment value may be determined utilizing various formulas.

$$adPi = \sqrt{\frac{\vert {Amax}_{i} \vert}{\vert {Wmax}_{i} \vert}} \qquad Equation 4$$

where adPᵢ is the adjustment value for channel i, Aₘₐₓᵢ represents the maximum value among the absolute values of all elements of channel i of the above input parameters, and Wₘₐₓᵢ represents the maximum value among the absolute values of all elements of channel i of the above weight parameters.

In order to update the input parameters and weight parameters to reduce the quantization error based on the adjustment value for adjusting outliers for each graph module of the second neural network model, the outlier alleviation unit 300b-16a may multiply the input parameters of the first graph module including the MAC operation by the reciprocal of the adjustment value (e.g., the first adjustment value) and the weight parameters of the first graph module by the adjustment value (e.g., the second adjustment value).

In one example, the outlier alleviation unit 300b-16a may update the input parameters and the weight parameters of the first graph module before performing the operation of the first graph module. The outlier alleviation unit 300b-16a may allow the parameter update operation to be performed in conjunction with existing operations by incorporating the adjustments into the multiplication operation performed before the first graph module, rather than adding a separate operation.

In one example, the step prior to the first graph module may further include a layer-normalization graph module. The layer-normalization step may include a multiplication operation, and may utilize the multiplication operation included in the layer-normalization to reflect the adjustment without adding a separate multiplication operation. Accordingly, the layer-normalization graph module may perform an operation to multiply the input parameters by the first adjustment value. The first graph module may then perform an operation to multiply an input parameter by a weight parameter reflecting the second adjustment value. For example, if the graph included in the layer-normalization that precedes the MAC operation contains the function

$$y = \frac{x - E [ x ]}{\sqrt{Var [ x ] + ϵ}} * γ + β ,$$

the γ and β variables in the multiplication operation can be multiplied by the first adjustment value

$$\frac{1}{{adP}_{i}} ,$$

modifying the functions to

$$γ = γ * \frac{1}{{adP}_{i}} and β = β * \frac{1}{{adP}_{i}} ,$$

respectively. Since γ and β variables are constants, they may be calculated in the optimization unit 300b-16 and stored as constant parameters. This can reduce the resource overhead of performing multiplication operations for parameter update (e.g., multiplying the input parameter by the first adjustment value) separately. Also, the multiplication operation of the second adjustment value and the weight parameter can be calculated and stored as a constant parameter. This reduces the resource that would have been consumed by performing the multiplication operation for parameter update separately.

In various examples, the outlier alleviation unit 300b-16a may apply the parameter update operation to a multiplication operation scheduled prior to the operation in the graph module. In another example, if the graph module does not include a MAC operation (e.g., a matmul operation), or if the immediately preceding step of the graph module does not include a multiplication operation, the parameter update may not be performed due to the cost associated with performing the multiplication operation for parameter update separately.

By applying the adjustment values, the input parameters and weight parameters may be updated to reduce quantization error of outliers. Each of the adjustment values (e.g., the first adjustment value and the second adjustment value) may be calculated in the compilation step of the neural network model and stored as a constant parameter. In particular, adjustment values are preferably calculated and stored as constant parameters in advance to reduce the power consumption of the inference operation of the neural processing unit and to improve the inference speed.

Referring to FIG. 12B, the outlier alleviation unit 300b-16a may update the input parameter values by multiplying each element of the input parameter by the reciprocal of the adjustment value. For example, A₁₁*(adP₁)⁻¹=A′₁₁, A′₂₁*(adP₁)⁻¹=A′₂₁, A₁₂*(adP₂)⁻¹=A′₁₂, and the like may be calculated. The above calculations may be performed in the layer-normalization step, which is performed immediately before the operation of the graph module. The outlier alleviation unit 300b-16a may incorporate the parameter update operation into the multiplication operation included in the layer-normalization step immediately before the operation of each graph module. Since the parameter update is included in the existing multiplication operation, no additional computational cost is incurred. In other words, the outlier adjustment of the input parameters can be provided to the third neural network model without increasing additional inference resources by pre-adjusting/variable in the case of layer regularization before the MAC operation. Thus, the third neural network model generated by the third conversion unit 300b-17 applied with the outlier alleviation value may involve substantially no increase in resources for outlier alleviation.

Referring to FIG. 12C, the outlier alleviation units 300b-16a may update the weight parameter values by multiplying each element of the weight parameter by an adjustment value. For example, W₁₁*adP₁=W′₁₁, W₁₂*adP₁=W′₁₂, W₂₁*adP₂=W′₂₁, and so on.

In one example of the present disclosure, the input parameters and weight parameters applied with outlier mitigation may be applied both in the quantization step and in subsequent steps. For example, if the outlier alleviation unit 300b-16a has performed outlier mitigation on the second neural network model by the optimization unit 300b-16, the input value feature_inᵢₙₜ of the third neural network model may indicate that outlier alleviation has been applied.

In one example of the present disclosure, the outlier alleviation unit 300b-16a may further include a component separate from the calibration unit 300b-14 for acquiring calibration data for outlier alleviation. The calibration data can be obtained as input values and weight values collected from markers included in each graph module using any of the calibration datasets. The calibration data generated by the calibration unit 300b-14 may be utilized by the second conversion unit 300b-15 to calculate a scale value and an offset value for each parameter. The outlier alleviation unit 300b-16a may alleviate outliers for the input parameters and the weight parameters independently of the operation of the second conversion unit 300b-15. The optimization unit 300b-16 may perform parameter refinement after performing the outlier alleviation, and the quantization simulation for the second neural network model may reflect both the outlier alleviation and the parameter refinement. When outlier alleviation is performed, the quantization simulation process of the second neural network model and the process may reflect the input parameters with the outlier alleviated, that is, the third conversion unit may generate the third neural network model based on the quantization simulation of the second neural network model with the input parameters and weight parameters reflecting the adjustment value that alleviates the outlier. Once the outlier alleviation values are determined, the third conversion unit may reflect the respective adjustment values in the input parameters and weight parameters of the corresponding neural network model.

The parameter refinement unit 300b-16b may calculate updated values for each of the scale value and the offset value for quantization of the floating point parameter calculated by the second conversion unit 300b-15. For convenience in the following description, the scale value calculated by the second conversion unit 300b-15 may be referred to as Scale_{default}, and the offset value calculated by the second conversion unit 300b-15 is referred to as Offset_{default}.

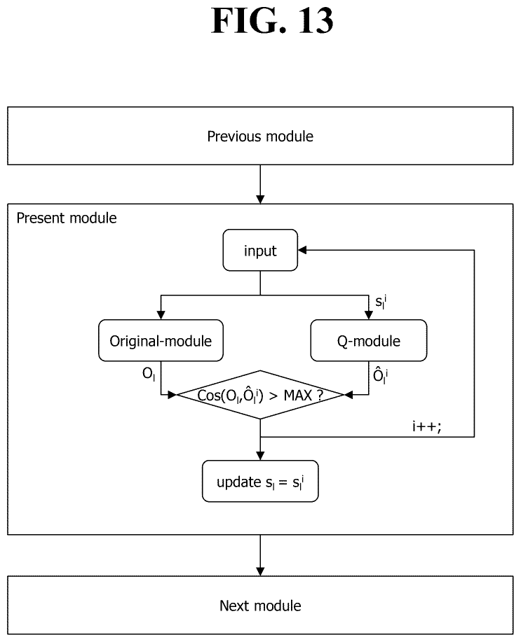

Cosine similarity is a measure of the similarity between two vectors in an inner space. Cosine similarity can be measured by the cosine value of the angle between two vectors, and determines whether they are pointing in approximately the same direction. The parameter refinement unit 300b-16b may determine that the higher the cosine similarity between the output values without quantization and with quantization, the smaller the quantization error, and consequently the inference accuracy of the neural network model can be maintained. In other words, the parameter refinement unit 300b-16b may update the scale value and the offset value for performing the quantization, based on the cosine similarity of the output values of the case without performing the quantization and the case with performing the quantization. The parameter refinement unit 300b-16b may obtain an updated value for each of the scale value Scale_{default}, calculated by the second conversion unit 300b-15, and the offset value Offset_{default}, calculated by the second conversion unit 300b-15. In one example, the parameter refinement unit 300b-16b may select an updated value from among neighboring values of Scale_{default}, which is a scale value calculated by the second conversion unit 300b-15. Further, the parameter refinement unit 300b-16b may select an updated value from neighboring values of Offset_{default}, which is an offset value calculated by the second conversion unit 300b-15. A method of selecting a neighboring value for the scale value or offset value to be updated, and a method of comparing the result of a quantization simulation using neighboring values to the result without quantization, will be described in detail in FIG. 13 of the present disclosure hereinafter.

The second neural network model may include a plurality of layers and each layer may include at least one graph module. The compiler 300b-10 may calculate a scale value and an offset value for a particular graph module associated with a marker based on calibration data measured at the marker added to each graph module. Referring to FIG. 9B, markers have been added to each of an input, an output and a weight input for the weight parameters of the Conv module, and scale values and offset values may be calculated based on calibration data measured at each marker, respectively.

For example, a first scale value and a first offset value for the input parameters of the Conv module can be calculated using Equation 1 based on the first maximum, first minimum, and target quantization bitwidth of the first calibration data measured at the first marker added to the input of the Conv module in FIG. 9B. A second scale value and a second offset value for the weight parameters of the Conv module can be calculated using Equation 1 based on the second maximum, second minimum, and target quantization bitwidth of the second calibration data measured at the second marker added to the weight input of the Conv module in FIG. 9B. The output parameters of the Conv module of FIG. 9B may be calculated from the first scale and first offset value for the input parameters of the Conv module and the second scale value for the weight parameter. The output of the Conv module comes out as an integer, which can be dequantized to get the first and second scale/offset values. After dequantizing, the output of the Conv module corresponds to the first scale of the next module because it is the input to the following graph module.

The parameter refinement unit 300b-16b may update the first scale value and the first offset value for the input parameters of the Conv module, and on the second scale value for the weight parameter of the Conv module, respectively. The output parameters of the Conv module may correspond to the input parameters of the next graph module connected to the Conv module, and the update may be performed in the next graph module.

For example, the output parameters of the Conv module in FIG. 9B can be calculated from the first scale value and the first offset value for the input parameters and the second scale value for the weight parameter of the Conv module. The output of the Conv module is an integer, which can be dequantized using the scale and offset values as the first and second scale/offset. After dequantizing, the output of the Conv module corresponds to the first scale value of the following module since it is the input to the following graph module.

The parameter refinement unit 300b-16b may update the first scale value and the first offset value for the input parameters of the Conv module, and the second scale value for the weight parameters of the Conv module, respectively. The output parameters of the Conv module may correspond to the input parameters of the next graph module connected to the Conv module, and the update may be performed in the next graph module.

The optimization unit 300b-16 may optionally perform outlier alleviation and parameter refinement depending on compilation options. In one example, when only outlier alleviation is performed, the outlier alleviation unit 300b-16a may perform outlier alleviation for the quantized parameter based on the calibration data before the parameter is quantized by the second conversion unit 300b-15. When only parameter refinement is performed, the parameter refinement unit 300b-16b may update the quantization parameter after quantizing the parameter by the second conversion unit 300b-15. However, when outliers exist in the parameters, it may cause severe quantization error when calculating the scale value and the offset value according to Equation 1 using the maximum and minimum values of the calibration data. When the optimization unit 300b-16 performs both outlier alleviation and parameter refinement, the outlier alleviation may be performed first, and the parameter refinement may be performed subsequently.

In one example, the optimization unit 300b-16 may update the parameters by the following sequence: 1) alleviating the outliers contained in the input parameters by the outlier alleviation unit 300b-16a, while adjusting the weight parameters by the amount by which the outliers are alleviated, 2) calculating quantization parameters (scale values and offset values) based on the calibration data using Equation 1 by the second conversion unit 300b-15, and 3) updating of the calculated parameters (e.g., a scale value for an input parameter, an offset value for an input parameter, and/or a scale value for a weight parameter) by the parameter refinement unit 300b-16b.

FIG. 13 is an illustrative diagram detailing the operation of the parameter refinement unit 300b-16b in accordance with one example of the present disclosure.

The parameter refinement unit 300b-16b may update corresponding scale values or offset values for quantization parameters for each graph module of the second neural network model. In one example, the parameter refinement unit 300b-16b may determine updated values for the scale values or offset values in the order of the first graph module to the last graph module, based on a connective relationship between each graph module included in the second neural network model. For example, the parameter refinement unit 300b-16b may update offset values for a plurality of graph modules included in the second neural network model, in the order of the first graph module to the last graph module based on a connective relationship between the graph modules. The order of updating for the graph modules may be one of forward, backward, or a particular order. After updating the offset values, the parameter refinement unit 300b-16b may update the scale values in order from the first layer to the last layer. The order of updating may be one of forward, reverse, or a specific order.

In one example, the parameter refinement unit 300b-16b may update some of the connected graph modules. For example, the parameter refinement unit 300b-16b may perform updating for a first graph module, no updating for a second graph module, and perform updating for a third graph module out of the entire set of connected graph modules. The parameter refinement unit 300b-16b may proceed with parameter refinement for the entire graph module in this manner.

The parameter refinement unit 300b-16b may select the order of updating in an experimental manner. In one example, the parameter refinement unit 300b-16b may determine the order of updating for a plurality of quantization parameters. The parameter refinement unit 300b-16b may first update the offset values of the parameters, and then update the scale values of the parameters. The parameter refinement unit 300b-16b may first update the input parameters, and then update the weight parameters. For example, the parameter refinement unit 300b-16b may, for a layer comprising an input activation map, a weight, 1) first update an offset value of the activation map, 2) next update a scale value of the activation map, and 3) finally update a scale value of the weights. The parameter refinement unit 300b-16b may first determine values to be updated for the offset values of the plurality of layers included in the second neural network model, and then determine values to be updated for the scale values of the second neural network model reflecting the improved offset value for each of the plurality of layers.

The parameter refinement unit 300b-16b may generate update candidates by selecting neighboring values for the scale value or offset value to be updated. The parameter refinement unit 300b-16b may determine one of the update candidates as the update value by comparing the result value of performing the quantization simulation using the update candidates with the result value of not performing the quantization. That is, the parameter refinement unit 300b-16b calculate the cosine similarity of the calculation result values for each graph module of the second neural network model and the calculation result values of the quantization simulation performed for each graph module of the second neural network model using each candidate included in the update candidate group. Thus, the candidate with the highest cosine similarity value among the candidates in the update candidates can be selected as the update value.

The parameter refinement unit 300b-16b may determine the candidates for the scale value or offset value to be updated by experimental measurements. The parameter refinement unit 300b-16b may select a predetermined number of candidates for the scale value to be updated within a predetermined range, that is, a neighboring range that including the scale value calculated using Equation 1. Further, the parameter refinement unit 300b-16b may select a predetermined number of update candidates for the offset value to be updated, within a certain range, such as a periphery that including the offset value calculated using Equation 1.

In one example, the parameter refinement unit 300b-16b may brute force select candidates according to the search space within an under bound factor α and an upper bound factor β. The parameter refinement unit 300b-16b may select as many candidates as the number of search spaces within a range from Scale_{default}*α to Scale_{default}*β. The parameter refinement unit 300b-16b may select as many candidates as the number of search spaces evenly within the range from Scale_{default}*α to Scale_{default}*β. For example, for a scale value S of 3, a of 0.5, B of 2, and a search space of 10, the candidates may be {1.5, 2, 2.5, 3, 3.5, 4, 4.5, 5, 5.5, 6}. In the example above, a scale value S may be included in the candidates, but in some cases, scale value S are not included in the candidates, in which case scale value S can be included in the candidates. For example, if the scale value S is 3, a is 0.5, B is 3, and the search space is 10, the candidates can be {1.5, 2.33, 3, 3.16, 3.99, 4.82, 5.65, 5.65, 6.48, 6.48, 7.31, 7.31, 8.14, 9}. The parameter refinement unit 300b-16b may utilize array generation functions. For example, the parameter refinement unit 300b-16b may generate the candidates using the function np.linspace (scale*α, scale*β, search_space). In another example, the parameter refinement unit 300b-16b may determine the candidates unequally among neighboring values based on the scale value or offset value calculated by the second conversion unit 300b-15.

Referring to FIG. 13, the parameter refinement unit 300b-16b describes a specific method for updating a scale value for the current graph module. An example for illustrative purposes is as follows: assuming that the parameter to be updated has a scale value Scale_{default} calculated by the second conversion unit 300b-15 is 3, α is 0.5, β is 2, and the search space 10, the update candidates of the scale value are {1.5, 2, 2.5, 3, 3.5, 4, 4.5, 5, 5.5, 6}. The current scale value S₁ may be set to 0. The parameter refinement unit 300b-16b may use some of the calibration datasets as input data for the update process. For example, if the calibration dataset includes 50 samples of data, the parameter refinement unit 300b-16b may use two randomly selected samples of data of the calibration dataset as input data for the update process. The parameter refinement unit 300b-16b may experimentally determine the type and number of input data.

The parameter refinement unit 300b-16b may calculate a value O₁ as a result of an operation by the original module that does not perform quantization on the first input value of the input data.

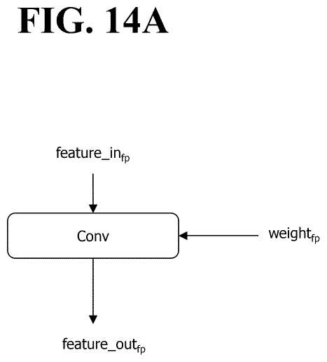

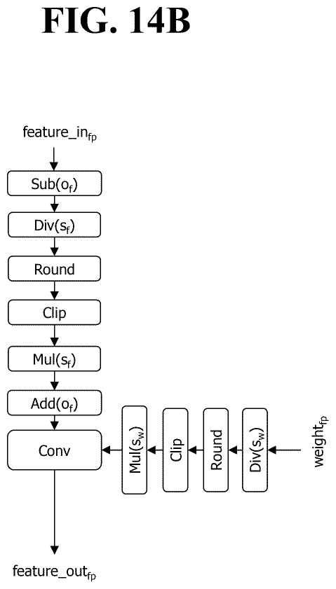

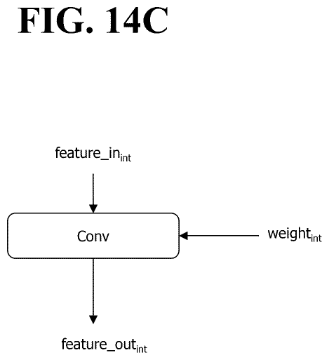

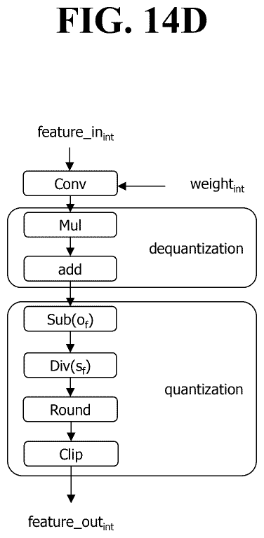

The parameter refinement unit 300b-16b may calculate a value Ô₁ as a result of an operation by a module performing a quantization simulation using each candidate included in the candidate group for the first input value. The Q-module performing the quantization simulation may be the second conversion unit 300b-15. Referring to FIG. 13, the parameter refinement unit 300b-16b may calculate Ô₁_{ⁱ} as a result of performing the quantization simulation using the first candidate s₁ⁱ. In this case, Ô₁_{ⁱ} is an integer value, and cosine similarity can be calculated after performing dequantization in the form of floating point. The specific method of performing the dequantization of the quantization simulation operation result is described later in the detailed description of Equations 8 to 9 and FIG. 14D.

The parameter refinement unit 300b-16b may calculate a cosine similarity for the calculation result O₁ in the case of not performing quantization and the calculation result Ô₁_{ⁱ} in the case of performing quantization simulation using the update candidate s₁ⁱ, and compare it with the current scale value S₁, which is a reference value, and the cosine similarity value MAX in the case of not performing quantization. The parameter refinement unit 300b-16b may update the current scale value S₁ to the update candidate s₁ⁱ if the cosine similarity of the calculation result according to the update candidate s₁ⁱ and the calculation result O₁ in the case of not performing quantization is greater than a reference value. The parameter refinement unit 300b-16b may repeat the above process for the next update candidate s₁ⁱ⁺¹. The parameter refinement unit 300b-16b may repeat the above process for all the candidates included in the update candidate group, and may calculate an update value for the scale value Scale_{default} calculated by the second conversion unit 300b-15.

The module (i.e., Q-module) performing the quantization simulation may be a separate module from the second conversion unit 300b-15. In this case, the separate module may include the steps of quantizing each input value of each graph module using the scale and offset values, performing the operation of each graph module with the quantized input value, and then dequantizing the operation result again. In other words, if the module is a separate module, it may include both the second conversion unit 300b-15 and further configured to perform the dequantization step.

The parameter refinement unit 300b-16b may repeat the above process for the second input value of the input data. The parameter refinement unit 300b-16b may perform updating on the scale value Scale_{default} calculated by the second conversion unit 300b-15, and may pass to the second conversion unit 300b-15 a second neural network model with an updated scale value for each connected graph module based on the connective relationship of all graph modules.

FIG. 14A and Equation 5 are examples of convolutions of a first neural network model to illustrate an example of the present disclosure.

The convolution of the first neural network model may be represented by FIG. 14A and Equation 5. In FIG. 14A, graph modules Conv corresponding to the convolution are shown. Each graph module has parameters to be input. The input/output parameters of the graph module may refer to Equation 4. The graph module shown in FIG. 14A can form a one-way acyclic graph (DAG). The first neural network model is an example of a typical neural network model, which is a neural network model in which all operations are performed with floating-point parameters. The first neural network model may be a model that is only executable on the GPU 100b of the neural network model optimizer 1500, and may include function call instructions.

$${feature\_out}_{fp} = {feature\_in}_{fp} ⊗ {weight}_{fp} \qquad Equation 5$$

where feature_out_{fp} is the output feature map in a form of floating-point, feature_in_{fp} is the input feature map in a form of floating-point, and weight_{fp} is the weight in a form of floating-point, where ⊗ means convolution. Equation 5 expresses substantially the same operation as in FIG. 14A.

FIG. 14B and Equation 6 are examples of convolutions of a second neural network model to illustrate an example of the present disclosure. The convolution of the second neural network model can be represented by FIG. 14B and Equation 6. In FIG. 14B, a graph module corresponding to convolution Conv, a graph module corresponding to subtraction Sub, a graph module corresponding to division Div, a graph module corresponding to round Round, a graph module corresponding to clip Clip, and a graph module corresponding to addition Add are shown. Each graph module is configured with input parameters. The parameters of each graph module may refer to Equation 6. Some of the graph modules in FIG. 14B may be converted function call instructions from the graph generation unit 300b-12. Each of the graph modules shown in FIG. 14B may be connected to each other to form a directed acyclic graph (DAG). The second neural network model is an example of a neural network model that can simulate quantization of the first neural network model, and is a neural network model in which all operations are processed with floating-point parameters, and can calculate inference accuracy deterioration due to quantization, quantization errors, and the like.

$${feature\_out}_{fp} = ( ⌊ \frac{{feature\_in}_{fp} - {o}_{f}}{{s}_{f}} ⌋ \times {s}_{f} + {o}_{f} ) ⊗ ⌊ \frac{{weight}_{fp}}{{s}_{w}} ⌋ \times {s}_{w} \qquad Equation 6$$

where feature_out_{fp} represents the output feature map in a form of floating-point for which quantization is simulated, feature_in_{fp} represents the input feature map in a form of floating-point, of represents the offset value of Equation 1 for the input feature map in a form of floating-point to be quantized, and s_{f} represents the scale value of Equation 1 for the input feature map in a form of floating-point to be quantized, weight_{fp} represents the weight in a form of floating-point to be quantized, s_{w} represents the scale value of Equation 1 for the weight in a form of floating-point to be quantized, └ ┘ represents the round and clip operations, and ⊗ represents a convolution. Equation 6 expresses substantially the same operations as in FIG. 14B.

Thus, the compiler 300b-10 may simulate quantization of the first neural network model using the second neural network model. By simulating the quantization using the second neural network model, the compiler 300b-10 may evaluate the degree of inference accuracy degradation. The degree of inference accuracy degradation may depend on the level of target quantization (e.g., 16-bit, 8-bit, 4-bit, 2-bit quantization level) and the degree of clipping. Depending on the settings of the compiler 300b-10, quantization of various bitwidth can be simulated.

Additionally, the compiler 300b-10 may set the same degree of quantization for each graph module. Alternatively, the compiler 300b-10 may set different quantization degrees for each graph module. The compiler 300b-10 may set different quantization degrees for the input parameters and output parameters of the graph modules. The compiler 300b-10 may set the degree of quantization degrees of the input parameters and the output parameters of the graph module to be the same.

Next, the third conversion unit 300b-17 may convert the second neural network model into a third neural network model executable on the neural processing unit 100a of the edge device 1000. That is, the third conversion unit 300b-17 may perform an operation to generate the third neural network model based on the quantization simulation result of the second neural network model.

The first neural network model and the second neural network model may be models executable on the GPU 100b capable of inference and learning, and the third neural network model may be a model executable on the neural processing unit 100a of the edge device 1000 capable of inference only. In other words, the third neural network model may be a neural network model improved for inference. Thus, the edge device 1000 may receive the third neural network model from the neural network model optimization unit 1500. The third neural network model may be a compiled neural network model, which may be referred to as binary code, machine code, or the like. The third neural network model may be stored in memory 200a of edge device 1000. The third neural network model is configured to run on the neural processing unit 100a of the edge device 1000.

FIG. 14C and Equation 7 are examples of convolutions of a third neural network model to illustrate an example of the present disclosure. The convolution of the third neural network model may be represented by FIG. 14C and Equation 7. FIG. 14C illustrates a graph module Conv corresponding to the convolution. Each graph module has input parameters set. The input/output parameters of the graph module of FIG. 14C may refer to Equation 7. The graph modules shown in FIG. 14C may comprise a directed acyclic graph (DAG).

FIG. 14C illustrates an example of a quantized convolution of a third neural network model. A processing element (not shown) of the neural processing unit 100a of the edge device 1000 may be a circuit configured to process the convolution of the third neural network model. The processing element may be a circuit configured to receive an integer parameter as an input and output an integer parameter. The processing element may be an operator configured to process a multiply and accumulation (MAC) operation. For example, the plurality of processing elements (not shown) of the neural processing unit 100a may correspond to the plurality of processing elements 110 shown in FIGS. 3, 4A, and 5. The neural processing unit 100 illustrated in FIGS. 3, 4A, and 5 may correspond to the neural processing unit 100a included in the edge device 1000 of FIG. 6.

$${feature\_out}_{int} = {feature\_in}_{int} ⊗ {weight}_{int} \qquad Equation 7$$

where feature_outᵢₙₜ represents the output feature map in a form of integer, feature_inᵢₙₜ represents the input feature map in a form of integer, weightᵢₙₜ represents the weight in a form of integer, and ⊗ means convolution. Equation 7 and FIG. 14C express substantially the same operation. For example, feature_inᵢₙₜ may be input to the first input of the first processing element PE1 of FIG. 4A. Here, feature_inᵢₙₜ may be a parameter quantized to 8-bit. However, the present disclosure is not limited thereto, and the bitwidth of feature_inᵢₙₜ may be from 2 to 16 bit.

The feature_inᵢₙₜ of Equation 7 may be quantized via Equation 2. Alternatively, the feature_inᵢₙₜ may be configured to be provided by a sensor, such as an image sensor, microphone, radar, lidar, or the like, connected via interface 400a of edge device 1000. Here, the value of feature_inᵢₙₜ may be stored in memory 200b via interface 400a of edge device 1000 in real-time (e.g., frame-by-frame, line-buffer-by-line, and the like). For example, feature_inᵢₙₜ may be an RGB image with a resolution of 8-bit output from a camera. Thus, the edge device 1000 can process the computation of the third neural network model with the feature map in quantized integer format.

weightᵢₙₜ may be fed to the second input of the first processing element PE1 of FIG. 4A. Here, weightᵢₙₜ may be a parameter quantized to 8-bit. However, the present disclosure is not limited thereto, and weightᵢₙₜ may have a bitwidth of 2 to 16 bit.

Additionally, the weightᵢₙₜ of Equation 7 may be pre-calculated using Equation 3. If training of the weight parameters of the second neural network model is completed, weight_{fp} and s_{w} in Equation 3 become constants whose values do not change. Therefore, the compiler 300b-10 can pre-calculate the value of weightᵢₙₜ and store it in the memory 200b as a constant. Further, the quantized weightᵢₙₜ may be passed to the memory 200a of the edge device 1000. Thus, the edge device 1000 can process the computation of the third neural network model with weights in quantized integer format.

According to an example of the present disclosure, the bitwidth of the input parameters (e.g., input feature maps) and output parameters (e.g., output feature maps) of the convolution graph module of the graph module of the third neural network model may be different.

Referring to FIG. 4A, for example, the bitwidth X of the feature_inᵢₙₜ may be 8-bit, and the bitwidth X of the feature_outᵢₙₜ may be 24-bit. Note that values may accumulate in the convolution, and if feature_outᵢₙₜ is an 8-bit integer, an overflow may occur. Therefore, to prevent overflow, the bitwidth X bit of the output feature map may be set appropriately.

Furthermore, the magnitude of the accumulated value in the accumulator 113 may have a larger bitwidth (e.g., the bitwidth X in FIG. 4A) than the bitwidth of the input integer parameters (e.g., the bitwidth N and M in FIG. 4A), depending on the amount of computation of the convolution. For example, the bitwidth of an input parameter (e.g., an input feature map) of a convolution graph module of a graph module of the third neural network model may be smaller than the bitwidth of an output parameter (e.g., an output feature map). The bitwidth of an output parameter (e.g., an output feature map) of a convolution graph module of the graph module of the third neural network model may be larger than the bitwidth of an input parameter (e.g., an input feature map).

FIG. 14D and Equations 8 to 10 are examples of convolution, dequantization, and quantization of a third neural network model to illustrate an example of the present disclosure.

The dequantization and quantization after convolution of the third neural network model may be represented by FIG. 14D and Equations 8 to 10. FIG. 14D shows a graph module corresponding to convolution Conv, graph modules corresponding to dequantization (Mul(dequant), Add(dequant)), and graph modules corresponding to quantization (Sub(o_{f}), Div(s_{f}), Round, Clip). Each graph module is parameterized with inputs. The parameters of the graph modules of FIG. 14D may refer to Equations 8 through 10. The graph modules shown in FIG. 14D can form a directed acyclic graph (DAG).

After convolution of the third neural network model (the convolution may refer to Equation 8), the parameters quantized as integers may need to be converted to floating point, depending on the graph modules that may be included in the third neural network model.

Accordingly, FIG. 14D illustrates an example of convolution, dequantization, and quantization of a third neural network model.

A processing element (not shown) of the neural processing unit 100a of the edge device 1000 may be a circuit configured to process a convolution of the third neural network model. The processing element may be a circuit configured to receive an integer parameter as an input and output an integer parameter. The processing element may be an operator configured to perform a multiply and accumulate (MAC) operation. The convolution of FIG. 14D may be substantially the same as the convolution of FIG. 14C. For example, the plurality of processing elements (not shown) of the neural processing unit 100a may correspond to the plurality of processing elements 110 shown in FIGS. 3, 4A, and 5. The neural processing unit 100 shown in FIGS. 3, 4A, and 5 may correspond to the neural processing unit 100a included in the edge device 1000 of FIG. 6.

The SFU (not shown) of the neural processing unit 100a of the edge device 1000 may be configured to include circuitry configured to process dequantization and quantization of the third neural network model. For example, the SFU (not shown) of the neural processing unit 100a of the edge device 1000 may correspond to the SFU 150 shown in FIGS. 3, 4B, and 5. The neural processing unit 100 illustrated in FIGS. 3, 4B, and 5 may correspond to the neural processing unit 100a included in the edge device 1000 of FIG. 6.

Specifically, for example, the dequantization circuit of the SFU 150 may be a circuit designed to process the dequantization of Equations 8 and 9, and the quantization circuit of the SFU 150 may be a circuit designed to process the quantization of Equation 2. That is, the dequantization circuit takes integer parameters as input, converts them to floating-point parameters, and outputs them. The quantization circuit takes floating-point parameters as input, converts them to integer parameters, and outputs them.

That is, the convolution graph module Conv of the third neural network model shown in FIG. 14D may be set to be processed in a processing element of a neural processing unit according to an example of the present disclosure, the dequantization graph modules (Mul(dequant), Add(dequant)) of the third neural network model may be configured to be processed in the dequantization circuit of the neural processing unit according to one example of the present disclosure, and the quantization graph modules (Sub(o_{f}), Div(s_{f}), Round, Clip) of the third neural network model may be configured to be processed in the quantization circuit of the neural processing unit according to an example of the present disclosure.

Referring to Equations 8 to 10 below, convolution, dequantization, and quantization are described. In the SFU 150 of FIG. 4B, the activation function circuit and the batch normalization circuit may be configured to receive a floating-point parameter.

$$\begin{matrix}{feature\_out}_{int} & = ⌊ \frac{\{ ( {feature\_in}_{int} ⊗ {weight}_{int} ) \times {dequant}_{mul} + {dequant}_{add} \} - {o}_{f} )}{( {s}_{f} )} ⌋ \\ & = ⌊ \frac{1}{{s}_{f}} ( {feature\_out}_{int} \times {dequant}_{m u l} + {dequant}_{add} ) - {o}_{f} ⌋ \\ & = ⌊ \frac{{feature\_out}_{fp} - {o}_{f}}{{s}_{f}} ⌋\end{matrix} \qquad Equation 8$$

The feature_outᵢₙₜ in Equation 8 represents the output feature map of the integer parameter. In Equation 8, feature_inᵢₙₜ represents the input feature map of the integer parameter, weightᵢₙₜ represents the weight of the integer parameter, and represents a convolution, which is substantially the same as in Equation 7. The dequantₘᵤₗ in Equation 8 is defined in Equation 9, and the dequant_{add} in Equation 8 is defined in Equation 10. Equation 8 and Equation 9 can be used to perform dequantization, i.e., applying dequantₘᵤₗ and dequant_{add} to Equation 7 can convert feature_outᵢₙₜ to feature_out_{fp}. The s_{f} and o_{f} in Equation 8 can be computed via Equation 1. The feature_outᵢₙₜ is then dequantized to a feature_out_{fp} via dequantₘᵤₗ and dequant_{add}, and then the feature_out_{fp} may be provided to a corresponding functional unit of the SFU 150 to process the necessary operations. Equation 8 and FIG. 14D represent substantially the same operation. Thus, the feature_out_{fp} may be provided to the SFU 150 to serve a particular functional unit that require floating-point arithmetic processing.

$${dequant}_{mul} = {s}_{f} \times {s}_{w} \qquad Equation 9$$

In Equation 9, dequantₘᵤₗ is a floating-point constant parameter, and s_{f} and s_{w} are floating-point constant parameters. Additionally, s_{f} and s_{w} may be calculated in the second conversion unit 300b-15 of the compiler 300b-10. Also, since s_{f} and s_{w} are constants, dequantₘᵤₗ can be calculated in advance. Thus, dequantₘᵤₗ can be a constant parameter of the pre-calculated third neural network model. Thus, dequantₘᵤₗ can be stored in the memory 200a of the edge device 1000, and the operation of Equation 9 may be omitted at the neural processing unit 100a. Thus, the operation of the neural processing unit 100a that processes the third neural network model can be accelerated, power consumption can be reduced, and the amount of memory 200a required for the operation of the Equation 9 can be reduced.

$${dequant}_{add} = {o}_{f} ⊗ clip \{ round ( \frac{{weight}_{fp}}{{s}_{w}} ) , {Q}_{min} , {Q}_{max} \times {s}_{w} = {o}_{f} ⊗ ⌊ \frac{{weight}_{fp}}{{s}_{w}} ⌋ \times {s}_{w} = {0}_{f} ⊗ {weight}_{int} \times {s}_{w} \qquad Equation 10$$

In Equation 10, dequantada is the floating-point constant parameter, and of and s_{w} are the floating-point constant parameters. Dequant_{add} can be tensor data. Additionally, of, weightᵢₙₜ, and s_{w} may be calculated in the second conversion unit 300b-15 of the compiler 300b-10. Also, since of, weightᵢₙₜ, and s_{w} are constants, dequant_{add} may be pre-calculated. Thus, dequantada can be a pre-calculated constant parameter of third neural network model. Accordingly, dequantada can be stored in the memory 200a of the edge device 1000, and the operation of Equation 10 can be omitted in the neural processing unit 100a. Thus, the operation of the neural processing unit 100a that processes the third neural network model can be accelerated, power consumption can be reduced, and the amount of memory 200a for performing the operation of the Equation 10 can be reduced.

FIG. 14D illustrates how integer parameters and floating-point parameters of a third neural network model executable in the neural processing unit 100a operate in each of the corresponding circuits of the neural processing unit 100a.

Describing an example of the present disclosure in terms of integer parameters, integer parameters quantized to a specific bitwidth can be fed to a plurality of processing elements of the neural processing unit to process a convolution or matrix multiplication. In particular, the convolution or matrix multiplication accounts for the largest portion of the total computation of the neural network model, and the convolution or matrix multiplication is relatively less sensitive to quantization errors than other operations of the neural network model. Thus, by providing a neural processing unit including processing elements configured to process the convolution or matrix multiplication with quantized integer parameters, and a neural network model compiled to accelerate and execute inference operations specialized for the neural processing unit, an edge device can be provided that achieves accelerated computation speed at low power.

Describing an example of the present disclosure in terms of floating-point parameters, a convolution or matrix multiplication result of integer parameters may be input to a SFU of a neural processing unit, and a corresponding circuit in the SFU may convert the integer parameters to floating point parameters to process certain operations of the neural network model. In particular, certain operations of the neural network model are vulnerable to quantization errors of quantized integer parameters. Therefore, by providing an SFU configured to selectively convert and process quantized integer parameters output from the processing element into floating point parameters for operations that are sensitive to quantization errors, and a neural network model compiled to accelerate and execute inference operations specialized for the neural processing unit, it is possible to provide an edge device that can achieve accelerated computation speed with low power while substantially suppressing deterioration of inference accuracy due to quantization errors.

The extraction unit 300b-18 may convert the third neural network model into a format compatible with the neural processing unit 100a within the edge device 1000. The format may be, for example, machine code, binary code, or a model in open neural network exchange (ONNX™) format. However, the extraction unit 300b-18 of the present disclosure are not limited to any particular format and may be configured to convert the third neural network model to any format compatible with the neural processing unit on which the third neural network model is executed.

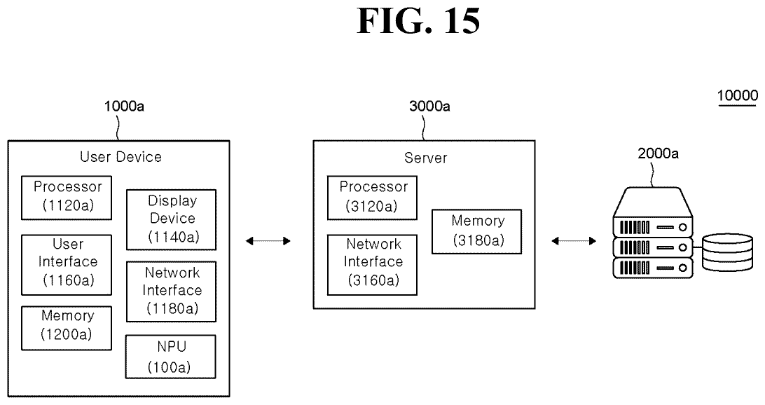

FIG. 15 is a block diagram of an NN model performance evaluation system 10000, according to another example of the present disclosure. Referring to FIG. 15, a NN model performance evaluation system 10000 according to another example of the present disclosure may include a user device 1000a, a neural network model processing device 2000a, and a server 3000a.

The NN model performance evaluation system 10000 may include, among other components, a user device 1000a, an NN model processing device 2000a, and a server 3000a between the user device 1000a and the NN model processing device 2000a. The NN model performance evaluation system 10000 of FIG. 15 may process a particular NN model on the NN model processing device 2000a and provide processing performance evaluation results of the NN model processing device 2000a to a user via the user device 1000a.

The user device 1000a may be a device used by a user to obtain processing performance evaluation result information of an NN model processed on the NN model processing device 2000a. The user device 1000a may include a smartphone, tablet PC, PC, laptop, or the like that can be connected to the server 3000a and may provide a user interface for viewing information related to the NN model. The user device 1000a may access the server 3000a, for example, via a web service, an FTP server, a cloud server, or an application software executable on the user device 1000a. These are merely examples, and various other known communication technologies or technologies to be developed may be used instead to connect to the server 3000a. The user may utilize various communication technologies to transmit the NN model to the server 3000a. Specifically, the user may upload an NN model and a particular evaluation dataset to the server 3000a via the user device 1000a for evaluating the processing performance of a NPU that is a candidate for the user's purchase.

In addition, the user device 1000a may include the neural processing unit 100a, and an updated NN model may be provided by the NN model processing device 2000a for use in the user's neural processing unit 100a.

The evaluation dataset refers to an input for feeding to the NN model processing device 2000a for performing performance evaluation by the NN model processing device 2000a.

The user device 1000a may receive from the NN model processing device 2000a a performance evaluation result of the NN model processing device 2000a for the NN model, and may display the result. The user device 1000a may be any type of computing device that may perform one or more of the following: (i) uploading the NN model to be evaluated by the NN model performance evaluation system 10000 to the server 3000a, (ii) uploading an evaluation dataset for evaluating an NN model to the NN model performance evaluation system 10000, and (iii) uploading a training dataset for retraining the NN model to the NN model performance evaluation system 10000. In other words, the user device 1000a may function as a data transmitter for evaluating the performance of the NN model and/or a receiver for receiving and displaying the performance evaluation result of the NN model.

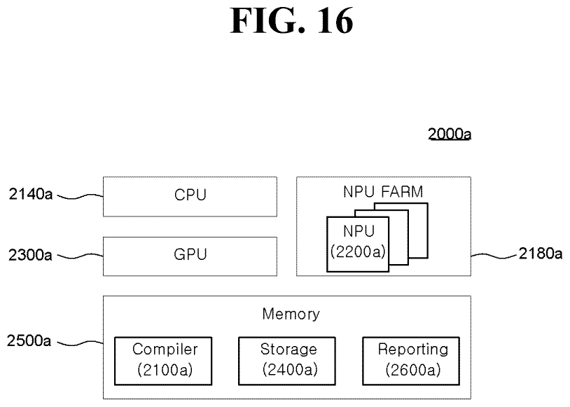

For this purpose, the user device 1000a may include, among other components, a processor 1120a, a display device 1140a, a user interface 1160a, a network interface 1180a and memory 1200a. The display device 1140a may present options for selecting one or more NPUs for instantiating the NN model, and also present options for compiling the NN model, as described below in detail with reference to FIGS. 16A and 16B. Memory 1200a may store software modules (e.g., web browser) executable by processor 1120a to access server 3000a, and also store NN model and performance evaluation data set for sending to the NN model processing device 2000a via the server 3000a. The user interface 1160a may include keyboard and mouse, and enables the user to provide user inputs associated with, among others, making selections on the one or more NPUs for instantiating the NN model and compilation options associated with compiling of the NN model. The network interface 3160a is a hardware component (e.g., network interface card) that enables the user device 1000a to communicate with the server 3000a via a network.

The NN model processing device 2000a may include NPU farm 2180a for instantiating NN models received the user device 1000a via the server 3000a. The NN model processing device 2000a may also compile the NN models for instantiation on one or more NPUs in the NPU farm 2180a, assess the performance of the instantiated NN models, and report the performance result to the user device 1000a via the server 3000a, as described below in detail with reference to FIG. 15.

The server 3000a is a computing device that communicates with the user device 1000a to manage access to the NN model processing device 2000a for testing and evaluating one or more NPUs in the NPU farm 2180a. The server 3000a may include, among other components, a processor 3120a, a network interface 3160a, and memory 3180a. The network interface 3160a enables the server 3000a to communicate with the user device 1000a and the NN model processing device 2000a via networks. Memory 3180a stores instructions executable by processor 3120a to perform one or more of the following operations: (i) manage accounts for a user, (ii) authenticate and permit the user to access the NN model processing device 2000a to evaluate the one or more NPUs, (iii) receive the NN model, evaluation datasets, the user's selection on NPUs to be evaluated, and the user's selection on compilation choices, (iv) encrypt and store data received from the user, (v) send the NN model and user's selection information to the NN model processing device 2000a via a network, and (vi) forward a performance report on the selected NPUs and recommendation on the NPUs to the user device 1000a via a network. The server 3000a may perform various other services such as providing a marketplace to purchase NPUs that were evaluated by the user.

To enhance the security of the data (e.g., the user-developed NN model, the training dataset, the evaluation dataset) received from the user, the server 3000a may enable users to securely login to their account, and perform data encryption, differential privacy, and data masking.

Data encryption protects the confidentiality of data by encrypting user data. Differential privacy uses statistical techniques to desensitize user data to remove personal information. Data masking protects user data by masking parts of it to hide sensitive information.

In addition, access control by the server 3000a limits which accounts can access user data, audit logging records on accounts that have accessed user data, and maintains logs of system and user data access to track who accessed the model and when, and to detect unusual activity. In addition, the uploading of training datasets and/or evaluation datasets may further involve signing a separate user data protection agreement to provide legal protection for the user's NN model, training dataset, and/or evaluation dataset.

FIG. 16 is a block diagram of the NN model processing device 2000a, according to another example of the present disclosure.

The NN model processing device 2000a may include, among other components, a central processing unit (CPU) 2140a, an NPU farm 2180a (including a plurality of NPUs 2200a), a graphics processing unit (GPU) 2300a, and memory 2500a. These components may communicate with each other via one or more communication buses or signal lines (not shown).

The CPU 2140a may include one or more operating processors for executing instructions stored in memory 2500a. Memory 2500a may store various software modules including, but not limited to, compiler 2100a, storage device 2400a, and reporting program 2600a. Memory 2500a can include a volatile or non-volatile recording medium that can store various data, instructions, and information. For example, memory 2500a may include a storage medium of at least one of the following types: flash memory type, hard disk type, multimedia card micro type, card type memory (e.g., SD or XD memory), RAM, SRAM, ROM, EEPROM, PROM, network storage, cloud, and blockchain database.

The CPU 2140a or the GPU 2300a in the neural network model processing device 2000a may load and execute a compiler 2100a stored in memory 2500a. Here, the compiler 2100a may be a semiconductor circuit, or it may be software stored in the memory 2500b and executed by the CPU 2140b.

The compiler 2100a may translate a particular NN model into machine code or instructions that can be executed by a plurality of NPUs 2200a. In doing so, the compiler 2100a may take into account different configurations and characteristics of NPUs 2200a selected for instantiating and executing the NN model. Because each type of NPUs may have different number of processing elements (or cores), different internal memory size, and channel bandwidths, the compiler 2100a generates the machine code or instructions that are compatible with the one or more NPUs 2200a selected for instantiating and executing the NN model. For this purpose, the compiler 2100a may store configurations or capabilities of each type of NPUs available for evaluation and testing.

The compiler 2100a may perform compilation based on various compilation options as selected by the user. The compilation options may be provided as user interface (UI) elements on a screen of the user device 1000a. The compiler 2100a may set the plurality of compilation options differently for each NPU selected for performance evaluation to generate compatible machine code or instructions. The plurality of compilation options may vary for different types of NPUs 2200a, so that even for the same NN model, the compiled machine code or instructions may vary for different types of NPUs 2200a of different configurations.

The storage device 2400a may store various data used by the NN model processing device 2000a. That is, the storage device 2400a may store NN models compiled into the form of machine code or instructions for configuring selected NPUs 2200a, one or more training datasets, one or more evaluation dataset, performance evaluation results and output data from the plurality of neural processing units 2200a.

The reporting program 2600a may determine whether the compiled NN model is operable by the plurality of NPUs 2200a. If the compiled NN model is inoperable by the plurality of NPUs 2200a, the reporting program 2600a may report that one or more layers of the NN model are inoperable by the selected NPUs 2200a, or that a particular operation associated with the NN model is inoperable. If the compiled NN model is executable by a particular NPU, the reporting program 2600a may report the processing performance of that particular NPU.

The performance may be indicated by performance parameters such as a temperature profile, power consumption (Watt), trillion operations per second per watt (TOPS/W), frames per second (FPS), inference per second (IPS), and inference accuracy. Temperature profile refers to the temperature change data of a NPU measured over time when the NPU is operating. Power consumption refers to power data measured when the NPU is operating. Because power consumption depends on the computational load of the user-developed NN model, the user's NN model may be provided and deployed for accurate power measurement. Trillion operations per second per watt (TOPS/W) is a metric that measures the efficiency of AI accelerator, meaning the number of operations that can be performed for one second per watt. TOPS/W is an indicator of the energy efficiency of the plurality of NPUs 2200a, as it represents how many operations the hardware can perform per unit of power consumed. Inference Per Second (IPS) is an indicator of the number of inference operations that the plurality of NPUs 2200a can perform in one second, thus indicating the computational processing speed of the plurality of NPUs 2200a. IPS may also be referred to as frame per second (FPS). Accuracy refers to the inference accuracy of the plurality of NPUs 2200a, as an indicator of the percentage of samples correctly predicted out of the total. As further explained, the accuracy of the plurality of NPUs 2200a and the inference accuracy of the graphics processing unit 230 may differ. This is because the parameters of the NN model inferred by the graphics processing unit 230 may be in a form of floating-point, while the parameters of the NN model inferred by the plurality of NPUs 2200a may be in a form of integers. Further, various optimization algorithms may be optionally applied. Thus, the parameters of the NN models inferred by the plurality of NPUs 2200a may have differences in values calculated by various operations, and thus may have different inference accuracies from the NN models inferred by the graphics processing unit 230. The difference in inference accuracy may depend on the structure and parameter size characteristics of the NN model, and in particular, the shorter the length of the bitwidth of the quantized parameter, the greater the degradation in inference accuracy due to excessive quantization. For example, the quantized bitwidth can be from 2-bit to 16-bit. The degradation of inference accuracy due to excessive pruning also tends to be larger.

The reporting program 2600a may analyze the processing performance of the NN model compiled according to each of the compilation options, and recommend one of the plurality of compilation options. The reporting program 2600a may also recommend a certain type of NPU for instantiating the NN model based on the performance parameters of different NPUs. Different types or combinations of NPUs may be evaluated using the evaluation dataset to determine performance parameters associated with each type of NPU or combinations of NPUs. Based on the comparison of the performance parameters, the reporting program 2600a may recommend the type of NPU or combinations of NPUs suitable for instantiating the NN model.

Memory 2500a may also store software components not illustrated in FIG. 15. For example, memory 2500a may store instructions that combine outputs from multiple selected NPUs. When multiple NPUs are selected to generate their own outputs that are subsequently combined or processed to generate an output of a corresponding NN model, the combining or the processing of the outputs from the NPUs may be performed by the CPU 2140a. Alternatively, such operations may be performed by GPU 2300a or one of the selected NPUs.

The NPU farm 2180a may include various families of NPUs of different performance and price points sold by a particular company. The NPU farm 2180a may be accessible online via the server 3000a to perform performance evaluation of user-developed NN models. The NPU farm 2180a may be provided in the form of cloud NPUs. The plurality of NPUs 2200a may receive an evaluation dataset as an input and receive a compiled NN model for instantiation and performance evaluation. The plurality of NPUs 2200a may include various types of NPUs. In one or more embodiments, the NPUs 2200a may include different types of NPUs available from a manufacture.

More specifically, the plurality of NPUs 2200a may be categorized based on processing power. For example, a first NPU may be a NPU for a smart CCTV. The first NPU may have the characteristics of ultra-low power, low-level inference processing power (e.g., 5 TOPS of processing power), very small semiconductor package size, and very low price. Due to performance limitations, the first NPU may not support certain NN models that include certain operations and require high memory bandwidth. For example, the first NPU may have a model name “DX-V1” and may compute NN models such as ResNet, Mobilenet v1/v2, SSD, YOLOv5, YOLOv7, and the like.

On the other hand, the second NPU may be a NPU for image recognition, object detection, and object tracking of a robot. The second NPU may have the characteristics of low power, moderate inference processing power (e.g., 16 TOPS of processing power), small semiconductor package size, and low price. The second NPU may not support certain NN models that require high memory bandwidth. For example, the second NPU may have a model name “DX-V2” and may compute NN models such as ResNet, Mobilenet v1/v2, SSD, YOLOv5, YOLOv7, and the like.

The third NPU may be a NPU for image recognition, object detection, object tracking, and generative AI services for autonomous vehicles. The third NPU may have low power, high level inference processing power (e.g., 25 TOPS of processing power), medium semiconductor package size, and medium price. For example, the third NPU may have a model name “DX-M1” that may compute NN models such as ResNet, MobileNet v1/v2/v3, SSD, EfficientNet, EfficientDet, YOLOv5, YOLOv7, YOLOv8, DeepLabv3, PIDNet, ViT, Generative adversarial network, Stable diffusion, and the like. The fourth NPU may be a NPU for CCTV control rooms, control centers, large language models, and generative AI services.

The fourth NPU may have low power, high level inference processing power (e.g., 400 TOPS of processing power), large semiconductor package size, and high price characteristics. For example, the fourth NPU may have a model name “DX-H1”, and may compute NN models such as ResNet, Mobilenet v1/v2, SSD, YOLOv5, YOLOv7, YOLOv8, DeepLabv3, PIDNet, ViT, Generative adversarial network, Stable diffusion, and large LLM. In other words, each NPU can have different computational processing power, different semiconductor chip die sizes, different power consumption characteristics, and the like. However, the types of the plurality of NPUs 2200a are not limited thereto and may be categorized by various classification criteria.

The GPU 2300a is hardware that performs complex computational tasks in parallel. The GPUs are widely used in graphics and image processing but have expanded their uses to processing various machine learning operations. Although GPU 2300a is illustrated as a single device, it may be embodied as a plurality of graphics processing units connected by a cloud GPU, NVLink, NVSwitch, or the like. The graphics processing unit 230 may include a plurality of cores that process multiple tasks in parallel. Thus, the graphics processing unit 230 can perform large-scale data processing tasks such as scientific computation and deep learning.

Specifically, the GPU 2300a may be used to train deep learning and machine learning models on large datasets. Deep learning models have a large number of parameters, making training time-consuming. The GPU 2300a can perform operations in parallel to generate or update the parameters, and thereby speed up training. When a user selects a particular NPU from the plurality of NPUs 2200a and performs retraining of the NN model through various compilation options, the GPU 2300a may be used to retrain of the NN model according to each compilation option. Furthermore, when a layer of the NN model is not compatible for instantiating on an NPU, the GPU 2300a may be used instead to instantiate (off-loading) the layer and perform processing of the instantiated layer.

In one or more embodiments, a plurality of NPUs 2200a and one or more GPUs 2300a may be implemented in the form of an integrated chip (IC), such as a system on chip (SoC) that incorporates various computing devices, or a printed circuit board on which the integrated chip is mounted.

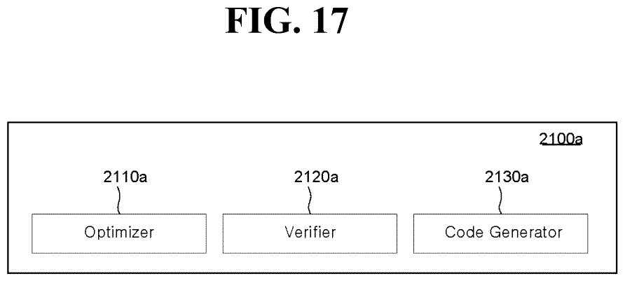

FIG. 17 is a block diagram illustrating the compiler 2100a of the NN model processing device 2000a, according to another example of the present disclosure.

The compiler 2100a may compile an NN model into machine code or instructions based on a plurality of compilation options. The compiler 2100a may be provided with hardware data of a NPU selected from the plurality of NPUs 2200a. The hardware data of the NPU may include the size of the NPU internal memory, a hierarchical structure of the NPU internal memory, information about the number of processing elements (or cores), information about special function units, and the like. The compiler 2100a may determine a processing order for each layer based on the hardware data of the NPU and the graph information of the NN model to be compiled. The machine code or the instructions may be fed to one or more selected NPUs 2200a to configure them to instantiate the NN model. The compiler 2100a may include, among other components, an optimization module 2110a, a verification module 2120a, and a code generator module 2130a.

The optimization module 2110a may perform the task of modifying the NN model represented by a directed acyclic graph (DAG) to increase one or more of efficiency, accuracy and speed. The user may select at least one of various updating options provided by the optimization module 2110a online via the user device 1000a. For example, the optimization module 2110a may provide an option to convert to parameters of a particular bitwidth to parameters of another bitwidth. The specific bitwidth may be between 2-bit and 16-bit. For example, the optimization module 2110a may convert the NN model based on floating-point parameters to an NN model based on integer parameters when the one or more selected NPUs 2200a are designed to process integer parameters. The optimization module 2110a may also convert an NN model based on nonlinear trigonometric operations to an NN model based on piecewise linear function approximation when the one or more selected NPUs 2200a are designed to process the piecewise linear function approximation operations. The optimization module 2110a may also apply various optimization algorithms to reduce the size of parameters such as weights, feature maps, and the like of the NN model. For example, the optimization module 2110a can improve the accuracy degradation problem of an modified neural network model by using various retraining algorithms.

The verification module 2120a may perform validation to determine whether the user's NN model is operable on the one or more selected NPUs 2200a. The verification module 2120a determines whether the NN model is executable by analyzing the structure of the modified NN model and determining whether the operations at each layer are supported by the hardware of the one or more selected NPUs 2200a. If the operations are not executable, a separate error report file can be generated and reported to the user.

The code generator module 2130a may generate machine code or instructions for instantiating and executing the NN model, as modified by the optimization module 2110a, on each of the selected NPUs 2200a. In one embodiment, such generation of machine code or instructions may be performed only on the NN models determined to be operable on the one or more selected NPUs 2200a by the verification module 2120a. The generated machine code can be provided to program one or more selected NPUs 2200a to instantiate the modified NN model. For example, first through fourth machine code or instruction set corresponding to the modified NN model may be generated and fed to the first through fourth NPUs, respectively.

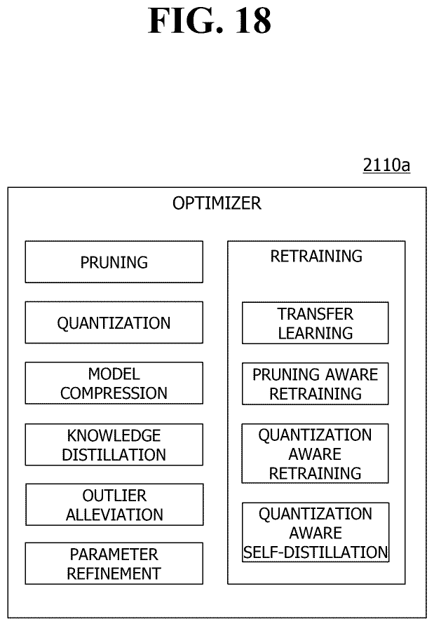

FIG. 18 is a block diagram illustrating the optimization module 2110a, according to another example of the present disclosure.

The optimization module 2110a can modify the NN model based on a plurality of compilation options to enhance the NN model in terms of at least one of the efficiency, speed and accuracy. The compilation options may be set based on hardware information of the NPU 2200a being used to instantiate the NN model. In addition or alternatively, the optimization module 2110a may automatically set the plurality of compilation options taking into account characteristics or parameters of the NN model (e.g., size of weights and size of feature maps) and characteristics of inference accuracy degradation. The plurality of compilation options set using the optimization module 2110a may be at least one of a quantization option, a pruning option, a retraining option, a model compression option, a knowledge distillation option, a parameter refinement option, an outlier alleviation option, and an AI based model optimization option.

Activation of the pruning option may provide techniques for reducing the computation of an NN model. The pruning algorithm may replace small, near-zero values with zeros in the weights of all layers of the NN model, and thereby sparsify the weights. The plurality of NPUs 2200a can skip multiplication operations associated with zero weights to speed up the computation of convolutions, reduce power consumption, and reduce the parameter size in the machine code of the NN model with the pruning option. Zeroing out a particular weight parameter by pruning is equivalent to disconnecting neurons corresponding to that weight data in a neural network. The pruning options may include a value-based first pruning option that removes smaller weights or a percentage-based second pruning option that removes a certain percentage of the smallest weights.

Activation of the quantization option may provide a technique for reducing the size of the parameters of the NN model. The quantization algorithm may selectively reduce the number of bits in the weights and the feature maps of each layer of the NN model. When the quantization option reduces the number of bits in a particular feature map and particular weights, it can reduce the overall parameter size of the machine code of the NN model. For example, a 32-bit parameter of a floating-point can be converted to a parameter of 2-bit through 16-bit integer when the quantization option is active.

Activation of the model compression option applies techniques for compressing the weight parameters, feature map parameters, and the like of an NN model. The model compression technique can be implemented by utilizing known compression techniques in the art. This can reduce the parameter size of the machine code of an NN model with the model compression option. The model compression option may be provided to a NPU including a decompression decoder.

Activation of the knowledge distillation option applies a technique for transferring knowledge gained from a complex model (also known as a teacher model) to a smaller, simpler model (also known as a student model). In a knowledge distillation algorithm, the teacher model typically has larger parameter sizes and higher accuracy than the student model. For example, in the retraining option described later, the accuracy of the student model can be improved with a knowledge distillation option in which an NN model trained with floating-point 32-bit parameters may be set as the teacher model and an NN model with various optimization options may be set as the student training model. The student model may be a model with at least one of the following options selected: pruning option, quantization option, model compression option, and retraining option.

Activation of the parameter refinement option may provide a technique for reducing quantization error. The parameter refinement option may be provided in conjunction with the quantization option. In order to reduce the error that may occur according to quantization, and to increase the computational performance due to quantization while maintaining the accuracy of the neural network model, optimization of the parameters required for the quantization process can be performed. According to the parameter refinement option, optimal values can be calculated for each of the scale and offset values for quantization of the floating-point parameters of the neural network model.

Activation of the outlier alleviation option may provide a technique for reducing quantization error. The outlier alleviation option may be provided in the same way as the quantization option. The input values and weights of the neural network model may contain outliers according to the actual data, which can cause amplification of errors during the quantization process. For effective quantization, it is necessary to properly compensate for outliers. According to the outlier mitigation option, an adjustment value for outlier adjustment may be used to adjust the outliers contained in the input parameters and weight parameters before the MAC operation.

Activation of the retraining option applies a technique that can compensate for degraded inference accuracy when applying various optimization options. For example, when applying a quantization option, a pruning option, or a model compression option, the accuracy of an NN model inferred by the plurality of NPUs 2200a may decrease. In such cases, an option may be provided to retrain the pruned, quantized, and/or model-compressed neural network model online to recover the accuracy of the inference. Specifically, the retraining option may include a transfer learning option, a pruning aware retraining option, a quantization aware retraining option, and a quantization aware self-distillation option.

Activation of the quantization-aware retraining (QAT) option incorporates quantization into the retraining phase of the neural network model, where the model fine-tunes the weights to reflect quantization errors. The quantization-aware retraining algorithm can include the loss function, gradient calculation, and optimization algorithm modifications. The quantization-aware retraining option can compensate for quantization errors by quantizing the trained neural network model and then performing fine-tuning to retrain it in a way that minimizes the loss due to quantization.

Activation of the quantization aware self-distillation option may be performed with QAT so as to avoid underfitting problems during retraining. The quantization aware self-distillation option enables retraining to minimize the loss between the predicted values resulting from running the model and the label values of the training data, while also taking into account the loss between the predicted values and the results of running a simulated quantization model on the same parameters. In one example, according to the quantization-aware self-destabilization option, when the difference between the predicted value of a pre-trained model with a parameter represented by a 32-bit floating point and the actual result value is a first loss, and the difference between the predicted value of a quantization simulation model and the predicted value of the pre-trained model for the same parameter is a second loss, the first loss and the second loss are combined to perform retraining so that the overall loss is minimized. The overall loss can be determined such that the sum of the first loss and the second loss is equal to one. For example, the first loss and second loss can be reflected in a 1:1 ratio. Alternatively, the first loss can be n % and the second loss can be 1-n %. In order to avoid the problem of applying QAT to a pre-trained model that has already been trained using data augmentation, the regularization may be excessive, resulting in underfitting, and thus decreasing accuracy accordingly, quantization-aware self-destabilization can be performed. According to quantization-aware self-destabilization, the difference between the predicted value of the quantization simulation using the same parameters and the predicted value of the pre-trained model can be reflected to suppress the accuracy drop caused by excessive regularization.

Activation of the pruning-aware retraining (PAT) option identifies and removes less important weights from the trained neural network model and then fine-tunes the active weights. Pruning criteria can include weight value, activation values, and sensitivity analysis. The pruning-aware retraining option may reduce the size of the neural network model, increase inference speed, and compensate overfitting problem during retraining.

Activation of the transfer learning option allows an NN model to learn by transferring knowledge from one task to another related task. Transfer learning algorithms are effective when there is not enough data to begin with, or when training a neural network model from scratch that requires a lot of computational resources.

Without limitation, the optimization module 2110a can apply an artificial intelligence-based optimization to the NN model. An artificial intelligence-based optimization algorithm may be a method of generating a reduced size of the NN model by applying various algorithms from the compilation options. This may include exploring the structure of the NN model using an AI-based reinforcement learning method or a method that is not based on a reduction method such as a quantization algorithm, a pruning algorithm, a retraining algorithm, a model compression algorithm, and a model compression algorithm, but rather a method in which an artificial intelligence integrated in the optimization module 2110a performs a reduction process by itself to obtain an improved reduction result.

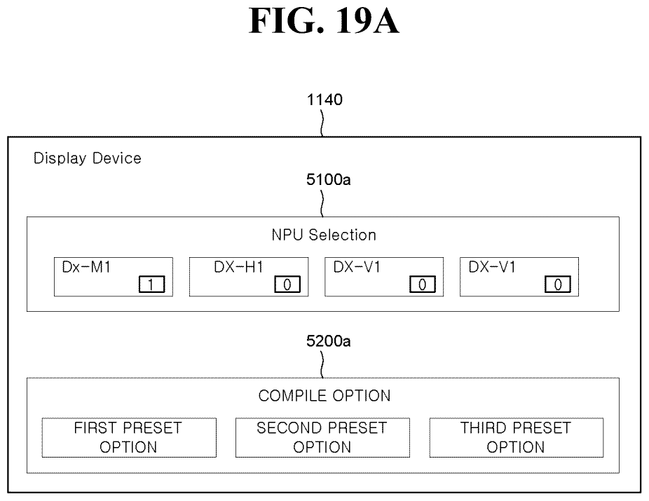

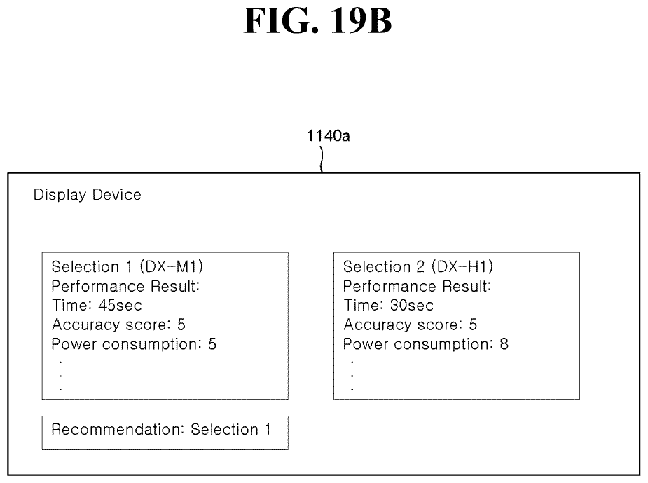

FIG. 19A is a user interface diagram for selecting one or more neural processors and selecting a compilation option, according to another example of the present disclosure.

The user interface may be presented on display device 1140a of the user device 1000a after the user accesses the server 3000a using the user device 1000a.

The user interface diagram displays two sections, a NPU selection section 5100a and a compile option section 5200a. The user may select one or more NPUs in the NPU selection section 5100a to run simulation on the NN model using one or more evaluation datasets. In the example, four types of NPUs are displayed for selection, DX-M1, DX-H1, DX-V1 and DX-V2. The user may identify the number of NPUs to be used in the online-simulation for evaluation the performance. In the example of FIG. 19A, one DX-M1 is selected for testing and evaluation. By providing non-zero numbers for multiple types of the NPUs in the NPU selection section 5100a, a combination of different types of NPUs may be used in the online-simulation and evaluation.

The compile option section 5200a displays preset options to facilitate the user's selection of the compile choices. In the example of FIG. 19A, the compile option section 5200a displays a first preset option, a second preset option, and a third preset option. In one embodiment, each of the preset options may be the most effective quantization preset option from a particular perspective. A user may select at least one preset option by considering the features of each preset option.

For example, the first preset option is an option that only performs a quantization algorithm to convert 32-bit floating-point data of a trained NN model to 8-bit integer data. In other examples, the converted bit data may be determined by the hardware configuration of the selected NPU. The first preset option may be referred to as post training quantization (PTQ) since the quantization algorithm is executed after training of the NN model. The first preset option has the advantage of performing quantization quickly, typically completing within a few minutes. Therefore, it is advantageous to quickly check the results of the power consumption, computational processing speed, and the like of the NN model provided by the user on the NPU selected by the user. A first preset option including a first quantization option may be provided to a user as an option called “DXNN Lite.” The retraining of the NN model may be omitted in the first preset option.

The second preset option may perform a quantization algorithm that converts 32-bit floating-point data of the NN model to 8-bit integer data, and then performs an algorithm for layer wise retraining of the NN model. As in the first preset option, the converted bit data may depend on the hardware configuration of the selected NPU. Selecting the second preset option may cause performing of a layer-by-layer retraining algorithm using the NN model that performed the first preset option as an input model. Thus, the second preset option may be a combination of the quantization algorithm and an algorithm from one of the various retraining options provided by the optimization module 2110a. In the second preset option, data corresponding to a portion of layers in the NN model is quantized and its quantization loss function is calculated. Then, the data corresponding to another portion of the plurality of layers of the NN model is quantized, and its quantization loss function is calculated. Such operations are repeated to enhance the quantization by reducing the quantization loss of some layers. The second preset option has the advantage that retraining can be performed in a manner that reduces the difference between the floating-point data (e.g., floating-point 32) and the integer data (e.g., integer 8) in the feature map for each layer, and hence, retraining can be performed even if there is no training dataset. The second preset option has the advantage that quantization can be performed in a reasonable amount of time, and typically completes within a few hours. The accuracy of the user-provided NN model on the user-selected NPU of the plurality of NPUs 2200a tend to be better than the one obtained using the first preset option. The second preset option comprising a second quantization option may be provided to a user under the service name “DXNN pro.” The second quantization option may involve a retraining step of the NN model because it performs a layer-by-layer retraining of the NN model.

The third preset option performs a quantization algorithm to convert 32-bit data representing a floating-point of the NN model to 8-bit data representing an integer, and then perform a quantization aware training (QAT) algorithm. In other words, the third preset option may further perform a quantization aware retraining algorithm using the NN model that performed the first preset option as an input model. Thus, the third preset option may be a combination of the quantization algorithm and an algorithm from one of the various retraining options provided by the optimization module 2110a. In the third preset option, the quantization-aware retraining algorithm performs fine-tuning by quantizing the trained NN model and then retraining it in a way that reduces the degradation of inference accuracy due to quantization. However, in order to retrain in a way that reduces the degradation of inference accuracy due to quantization, the user may provide the training dataset of the neural network model.

Furthermore, an evaluation dataset may be used to suppress overfitting during retraining. Specifically, the quantization-aware retraining algorithm inputs the machine code and the training dataset of the quantized NN model into a corresponding NPU to retrain it and compensate for the degradation of inference accuracy due to quantization errors.

The third preset option has the advantage of ensuring relatively higher inference accuracy than the first and second preset options, but typically takes a few days to complete and is suitable when the accuracy has a higher priority. The third preset option comprising a third quantization option may be provided to users under the service name “DXNN master.” The third quantization option may involve a retraining step of the NN model because the retraining algorithm is performed based on the inference accuracy of the NN model. For the quantization-aware retraining algorithm of the third quantization option, a training dataset and/or an evaluation dataset of the NN model may be received from the user in the process of retraining in a direction that reduces the loss due to quantization. The training dataset is the used for quantization-aware retraining. The evaluation dataset is optional data that can be used to improve the overfitting problem during retraining.

FIG. 19B is a user interface diagram for displaying a performance report and recommendation on selection of the one or more neural processing units, according to another example of the present disclosure.

In the example of FIG. 19B, the results of performing the simulation/evaluation using two different types of NPUs are displayed. The upper left box shows the result of using DX-M1 NPU whereas the upper fight box shows the result of using DX-H1 NPU. The bottom box shows the recommended selection of NPU based on the performance parameters of the two different NPUs.

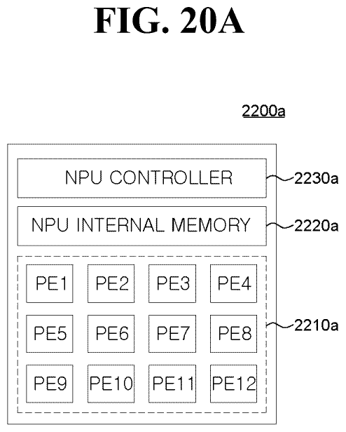

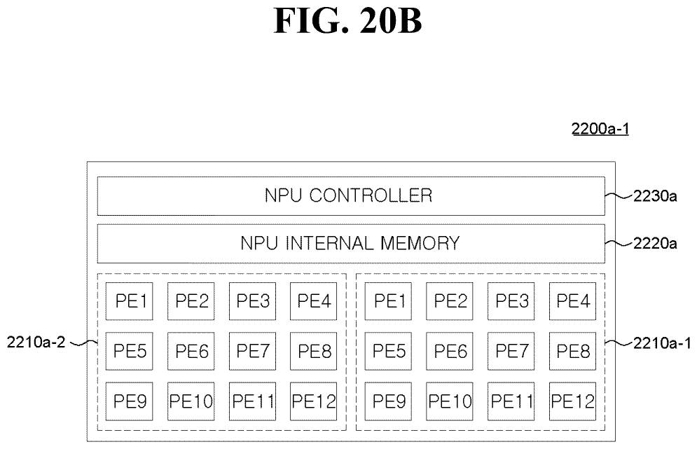

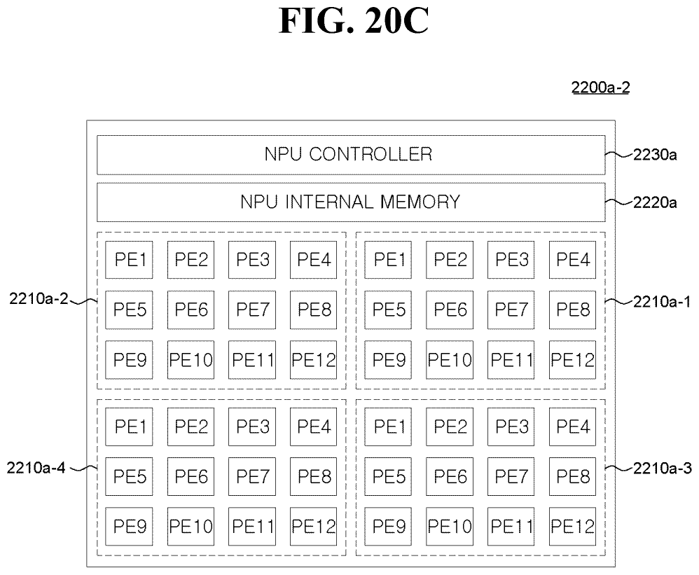

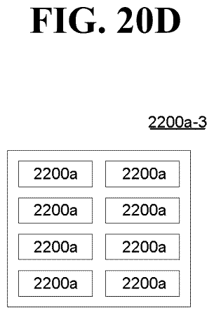

FIGS. 20A through 20D are block diagrams illustrating configurations of various NPUs in NPU farm 2180a, according to another example of the present disclosure.

Specifically, FIG. 20A illustrates an internal configuration of a first NPU 2200a, FIG. 20B illustrates an internal configuration of a second NPU 2200a-1, FIG. 20C illustrates an internal configuration of a third NPU 2200a-2, and, FIG. 20D illustrates an internal configuration of a fourth NPU 2200a-3

The first NPU 2200a of FIG. 19A may include a processing element array 2210a (also referred to as “processor core array 2210a”), an NPU internal memory 2220a, and an NPU controller 2230a. The first NPU 2200a may include the processing element array 2210a, an NPU internal memory 2220a, and an NPU controller 2230a that controls the processing element array 2210a and the NPU internal memory 2220a.

The NPU internal memory 2220a may store, among other information, parameters for instantiating part of an NN model or an entire NN model on the processing element array 2210a, intermediate outputs generated by each of the processing elements, and at least a subset of data of the NN model. The NN model with various optimization options applied may be compiled into machine code or instructions for execution by various components of the first NPU 2200a in a coordinated manner.

The NPU controller 2230a controls operations of the processing element array 2210a for inference operations of the first NPU 2200a as well as read and write sequences of the NPU internal memory 2220a. The NPU controller 2230a may also configure the processing elements and the NPU internal memory according to programmed modes if these components support multiple modes. The NPU controller 2230a also allocates tasks processing elements in the processing element array 2210a, instructs the processing elements to read data from the NPU internal memory 2220a or write data to the NPU internal memory, and also coordinates receiving data from storage device 2400a or writing data to the storage device 2400a according to the machine code or instructions generated as the result of compilation. Thus, the NPU can sequentially process operations for each layer according to the structure of the NN model. The NPU controller 2230a may obtain a memory address where the feature map and weights of the NN model are stored or determine a memory address to be stored.

Processing element array 2210a may include plurality of processing elements (or cores) PE1 to PE12 arranged in the form of an array. Each processing element may include multiply and accumulate (MAC) circuits and/or an arithmetic logic unit (ALU) circuits. However, other circuits may be included in addition or in lieu of MAC circuits and ALU circuits in the processing element. For example, a processing element may have a plurality of circuits implemented as multiplier circuits and/or adder tree circuits operating in parallel, replacing the MAC circuits within a single processing element. In such cases, the processing element array 2210a may be referred to as at least one processing element comprising a plurality of circuits.

The processing element array 2210a may include a plurality of processing elements PE1 to PE12. The plurality of processing elements PE1 to PE12 shown in FIG. 20A are for the purpose of illustration, and the number of the plurality of processing elements PE1 to PE12 is not limited to the example in FIG. 20A. The number of the plurality of processing elements PE1 to PE12 may determine the size or number of processing elements array 2210a. The processing element array 2210a may be in the form of an N×M matrix, where N and M are integers greater than zero.

The arrangement and the number of the processing element array 2210a can be designed to take into account the characteristics of the NN model. In particular, the number of processing elements may be determined by considering the data size of the NN model to be operated, the required inference speed, the required power consumption, and the like. The data size of the NN model may correspond to the number of layers of the NN model and the weight parameter size of each layer. As the number of processing elements in the processing element array 2210a increases, the parallel computational capability of the operating NN model also increases, but the manufacturing cost and physical size may increase as well. For example, as shown in FIG. 20B, the second NPU 2200a-1 may include two processing element arrays 2210a-1 and 2210a-2. Two processing element arrays 2210a-1 and 2210a-2 may be grouped and each array may include a plurality of processing elements PE1 to PE12. In another example, as shown in FIG. 20C, the third NPU 2200a-2 may include four processing element arrays 2210a-1, 2210a-2, 2210a-3, and 2210a-4. Four processing element arrays 2210a-1, 2210a-2, 2210a-3, and 2210a-4 may be grouped and each array may include a plurality of processing elements PE1 to PE12.

In another example, as shown in FIG. 20D, the fourth NPU 2200a-3 may include eight smaller first NPUs 2200a as shown in FIG. 20A. Each of the eight first NPUs 2200a is assigned to process part of the operations of the NN model to further improve the speed of the NN model. Further, some of the first NPUs 2200a may be inactivated during operations to save the power consumption of the fourth NPU 2200a-3. For these purposes, the fourth NPU 2200a-3 may further include a higher level NPU controller (not shown) in addition to NPU controllers 223 in each of the first NPUs 2200a to allocate the operations of the each of eight neural processing units and coordinate their operations.

Characteristics and processing models of the first to fourth neural processing units are described above.

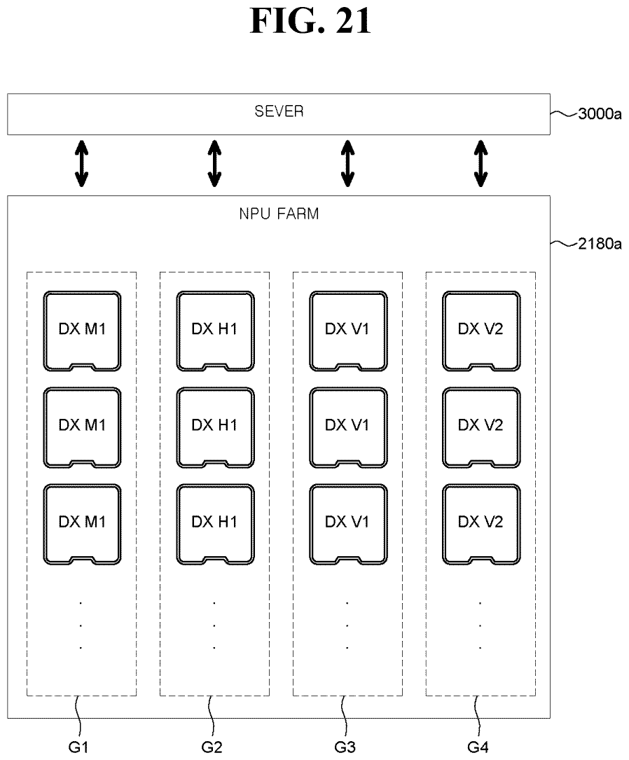

FIG. 21 is a block diagram illustrating the configuration of a plurality of NPUs in the NPU farm 2180a, according to another example of the present disclosure.

The plurality of NPUs 2200a may include different types of NPUs. At least one NPU of the same type may also be included in the NPU farm 2180a. For example, a plurality of “DX-M1” NPUs may be arranged to form a first group G1, a plurality of “DX-H1” NPUs may be arranged to form a second group G2, a plurality of “DX-V1” NPUs may be arranged to form a third group G3, and a plurality of “DX-V2” NPUs may be arranged to form a fourth group G4. The NPU farm 2180a may be a cloud-based NPU system configured to respond in real time to performance evaluation requests from a plurality of users received via online communications. The plurality of NPUs 2200a included in the first to fourth groups G1 to G4 may all be used for performance evaluation, or a subset of these NPUs 2200a may be used for performance evaluation, depending on the user's choice.

Security-sensitive user data may be stored in the server 3000a, in the storage device 2400a of the NN model processing device 2000a or both in the server 3000a and in the storage device 2400a of the NN model processing device 2000a.

The at least one NPU 2200a used for computation may communicate with the server 3000a to receive the at least one particular NN model for performance evaluation of the NPU and the at least one particular evaluation dataset that is fed to the NN model. In other words, the NPU 2200a may process the user data for performance evaluation.

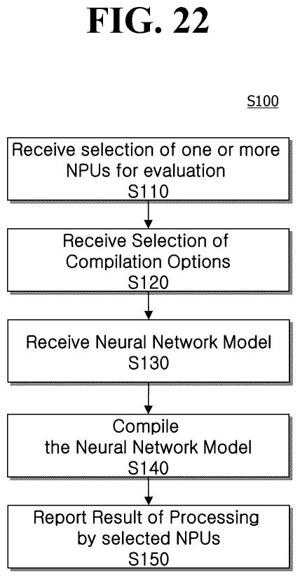

FIG. 22 is a flowchart illustrating a method of evaluating performance of a neural network model instantiated on one or more NPUs, according to another example of the present disclosure.

Referring to FIG. 22, an NN model performance evaluation method S100 may include step S110 of receiving selection of one or more NPUs for evaluation, step S120 of receiving selection of compilation options, step S130 of receiving an NN model at the server 3000a, step S140 of compiling the NN model for instantiating on the one or more selected NPUs according to the compilation options, and step S150 of reporting result of the processing by the one or more selected NPUs.

In the NPU type selection step S110, a user may select a type of NPU for performance evaluation. The type of NPU may vary depending on the product line-up of NPUs sold by a particular company. In the example of FIG. 21, a plurality of “DX-M1” NPUs may be arranged to form a first group G1, a plurality of “DX-H1” NPUs may be arranged to form a second group G2, a plurality of “DX-V1” NPUs may be arranged to form a third group G3, and a plurality of “DX-V2” NPUs may be arranged to form a fourth group G4. In this case, the user selects one or more NPUs for evaluation from “DX-M1” NPUs, “DX-H1” NPUs, “DX-V1” NPUs, and “DX-V2” NPUs. The user may select only a single type of NPU or NPUs for evaluation, or select a combination of different types of NPUs for evaluation.

Then, in the compilation option selection step S120, at least one of a plurality of compilation options for the NN model to be processed is selected with respect to the selected at least one NPU. More specifically, in the compilation option selection step S120, a compilation option may be set based on hardware information of the NPU 2200a. Furthermore, in the compilation option selection step, a plurality of compilation options can be set based on the user's selection. In one or more embodiments, a description of the advantages and disadvantages of each compilation option can be displayed on the user device 1000a. Thus, the user may customize the various compilation options to suit the user's needs. In other words, the performance evaluation system 10000 may provide compilation options that are user-customized, rather than preset options, to meet the specific needs of the user. As described above, the compilation option may be at least one of a pruning algorithm, a quantization algorithm, a parameter refinement algorithm, an outlier alleviation algorithm, a model compression algorithm, a knowledge distillation algorithm, a retraining algorithm, and an AI based model optimization algorithm. Alternatively, the compile option may be configured to select one of the predefined preset options.

Then, in the NN model receiving step S130, at least one particular NN model for evaluating the performance of the selected NPU is received at the server 3000a from the user device 1000a. This may also be referred to as user data upload step.

Then, in the NN model compilation step S140, the received NN model is compiled according to the selected compilation options for instantiating on the one or more selected NPUs. Machine code or instructions are generated as the result of compilation, and are fed to the one or more NPUs to run the simulation.

In step S150 of reporting result, it is first determined whether the compiled NN model is capable of being processed by the plurality of neural processing units 2200a. If the compiled NN model cannot be processed by the plurality of neural processing units 2200a, the NN model processing result reporting step S150 may report a layer of the plurality of layers of the NN model that cannot be processed by the plurality of neural processing units 2200a. Then, the layer that cannot be processed by the plurality of neural processing units 2200a may be processed by the graphics processing unit 230. If the compiled NN model can be processed by the plurality of neural processing units 2200a, the NN model processing result reporting step S150 may report the processing performance of the plurality of neural processing units 2200a.

The parameters of processing performance may be a temperature profile of the neural processing unit, power consumption (Watt), trillion operations per second per Watt (TOPS/W), frame per second (FPS), inference per second (IPS), accuracy, and the like.

If the user does not provide an evaluation data set, the NN model performance evaluation system 10000 may analyze the size of the input data of the NN model to generate corresponding dummy data, and may utilize the generated dummy data to perform performance evaluation. For example, the size of the dummy data may be (224×224×3), (288×288×3), (380×380×3), (515×512×3), (640×640×3), or the like, but is not limited to these sizes. In other words, even if a dataset for evaluating inference performance is not provided from a user, it may be possible to generate performance evaluation results such as power consumption, TOPS/W, FPS, IPS, and the like of a neural processing unit. However, in such cases, inference accuracy evaluation results may not be provided since the dummy data may not be accompanied by accurate inference answers.

According to another example of the present disclosure, a user can quickly determine whether a user's NN model is operable on a particular NPU before purchasing the particular NPU.

According to another example of the present disclosure, a user can quickly determine, prior to purchasing a particular NPU, how a user's NN model will perform when instantiated and executed on a particular NPU.

According to an example of the present disclosure, if each NPU is connected via a server for each type of NPU, the user can evaluate the user's NN model online and receive a result for each NPU available for purchase. Thus, the performance evaluation system 10000 can provide the user with information on the performance and price of the neural processing unit required to implement the AI service developed by the user, which can help the user make a quick purchase decision.

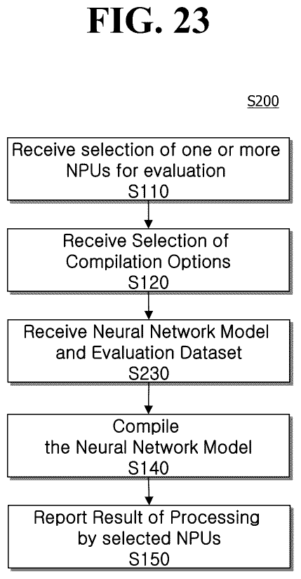

FIG. 23 is a flowchart illustrating evaluating performance of an NN model instantiated on one or more NPUs, according to another example of the present disclosure. Referring to FIG. 23, an NN model performance evaluation method S200 may include step S110 of receiving selection of one or more NPUs for evaluation, step S120 of receiving selection of compilation options, step S230 of receiving an NN model and an evaluation dataset at the server 3000a, step S140 of compiling the NN model for instantiating on the one or more selected NPUs according to the compilation options, and step S150 of reporting result of the processing the evaluation dataset using the one or more selected NPUs.

In the NPU type selection step S110, a user may select a type of NPU for performance evaluation. The type of NPU may vary depending on the product line-up of NPUs sold by a particular company. In the example of FIG. 21, a plurality of “DX-M1” NPUs may be arranged to form a first group G1, a plurality of “DX-H1” NPUs may be arranged to form a second group G2, a plurality of “DX-V1” NPUs may be arranged to form a third group G3, and a plurality of “DX-V2” NPUs may be arranged to form a fourth group G4. In this case, the user selects one or more NPUs for evaluation from “DX-M1” NPUs, “DX-H1” NPUs, “DX-V1” NPUs, and “DX-V2” NPUs. The user may select only a single type of NPU or NPUs for evaluation, or select a combination of different types of NPUs for evaluation.

Then, in the compilation option selection step S120, at least one of a plurality of compilation options for the NN model to be processed is selected with respect to the selected at least one NPU. More specifically, in the compilation option selection step S120, a compilation option may be set based on hardware information of the NPU 2200a. Furthermore, in the compilation option selection step, a plurality of compilation options can be set based on the user's selection. In one or more embodiments, a description of the advantages and disadvantages of each compilation option can be displayed on the user device 1000a. Thus, the user may customize the various compilation options to suit the user's needs. In other words, the performance evaluation system 10000 may provide compilation options that are user-customized, rather than preset options, to meet the specific needs of the user. As described above, the compilation option may be at least one of a pruning algorithm, a quantization algorithm, a parameter refinement algorithm, an outlier alleviation algorithm, a model compression algorithm, a knowledge distillation algorithm, a retraining algorithm, and an AI based model optimization algorithm. Alternatively, the compile option may be configured to select one of the predefined preset options.

Then, in step S230, at least one particular NN model for evaluating the performance of the selected NPU and at least one particular evaluation dataset are received at server 3000a from the user device 1000a. This may also be referred to as user data upload step. The particular evaluation dataset described refers to an evaluation dataset that is fed to the at least on particular NN model instantiated by the NN model processing device 2000a for performance evaluation of the NN model processing device 2000a.

Then, in the NN model compilation step S140, the received NN model is compiled according to the selected compilation options for instantiating on the one or more selected NPUs. Machine code or instructions are generated as the result of compilation, and are fed to the one or more NPUs to run the simulation.

In the NN model processing result reporting step S150, the performance evaluation result of the neural processing unit that processed the compiled NN model can be reported. The performance evaluation result report may be stored in the user's account or sent to the user's email address. However, the performance evaluation result can be provided to users in a variety of other ways. A performance evaluation result is also treated as user data and may be subject to the security policies that apply to the user data.

In the NN model processing result reporting step S150, it is first determined whether the compiled NN model may be processed by the plurality of neural processing units 2200a. If the compiled NN model cannot be processed by the plurality of neural processing units 2200a, the NN model processing result reporting step S150 may report a layer of the plurality of layers of the NN model that cannot be processed by the plurality of neural processing units 2200a. Then, the layer that cannot be processed by the plurality of neural processing units 2200a may be processed by the graphics processing unit 230. If the compiled NN model can be processed by the plurality of neural processing units 2200a, the NN model processing result reporting step S150 may report the processing performance of the plurality of neural processing units 2200a.

The parameters of processing performance may be a temperature profile of the neural processing unit, power consumption (Watt), trillion operations per second per Watt (TOPS/W), frame per second (FPS), inference per second (IPS), accuracy, and the like.

According to another example of the present disclosure, a user can quickly determine, prior to purchasing a particular NPU, how a user's NN model will perform when instantiated and executed on a particular NPU.

According to an example of the present disclosure, if each NPU is connected via a server for each type of NPU, the user can evaluate the user's NN model online and receive a result for each NPU available for purchase. Thus, the performance evaluation system 10000 can provide the user with information on the performance and price of the neural processing unit required to implement the AI service developed by the user, which can help the user make a quick purchase decision.

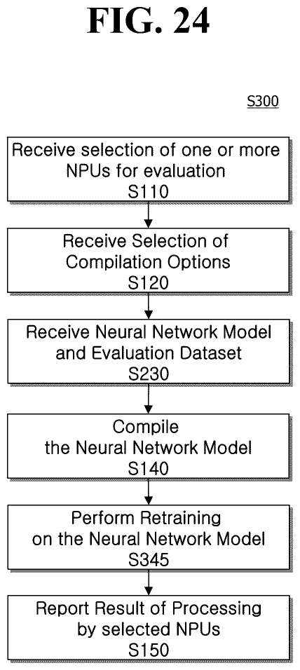

Referring to FIG. 24, a method for evaluating the performance of an NN model according to another example of the present disclosure with a retraining step will be described.

FIG. 24 is a flowchart illustrating evaluating performance of an NN model instantiated on one or more NPUs, according to another example of the present disclosure. Referring to FIG. 24, an NN model performance evaluation method S300 may include step S110 of receiving selection of one or more NPUs for evaluation, step S120 of receiving selection of compilation options, step S230 of receiving an NN model and an evaluation dataset at the server 3000a, step S140 of compiling the NN model for instantiating on the one or more selected NPUs according to the compilation options, step S345 of performing retraining on the NN model, and step S150 of reporting result of the processing the evaluation dataset using the one or more selected NPUs.

In the NPU type selection step S110, a user may select a type of NPU for performance evaluation. The type of NPU may vary depending on the product line-up of NPUs sold by a particular company. In the example of FIG. 21, a plurality of “DX-M1” NPUs may be arranged to form a first group G1, a plurality of “DX-H1” NPUs may be arranged to form a second group G2, a plurality of “DX-V1” NPUs may be arranged to form a third group G3, and a plurality of “DX-V2” NPUs may be arranged to form a fourth group G4. In this case, the user selects one or more NPUs for evaluation from “DX-M1” NPUs, “DX-H1” NPUs, “DX-V1” NPUs, and “DX-V2” NPUs. The user may select only a single type of NPU or NPUs for evaluation, or select a combination of different types of NPUs for evaluation.

Then, in the compilation option selection step S120, at least one of a plurality of compilation options for the NN model to be processed is selected with respect to the selected at least one NPU. More specifically, in the compilation option selection step S120, a compilation option may be set based on hardware information of the NPU 2200a. Furthermore, in the compilation option selection step, a plurality of compilation options can be set based on the user's selection. In one or more embodiments, a description of the advantages and disadvantages of each compilation option can be displayed on the user device 1000a. Thus, the user may customize the various compilation options to suit the user's needs. In other words, the performance evaluation system 10000 may provide compilation options that are user-customized, rather than preset options, to meet the specific needs of the user. As described above, the compilation option may be at least one of a pruning algorithm, a quantization algorithm, a parameter refinement algorithm, an outlier alleviation algorithm, a model compression algorithm, a knowledge distillation algorithm, a retraining algorithm, and an AI based model optimization algorithm. Alternatively, the compile option may be configured to select one of the predefined preset options.

Then, in step S230, at least one particular NN model for evaluating the performance of the selected NPU and at least one particular evaluation dataset are received at server 3000a from the user device 1000a. This may also be referred to as user data upload step. The particular evaluation dataset described refers to an evaluation dataset that is fed to the at least on particular NN model instantiated by the NN model processing device 2000a for performance evaluation of the NN model processing device 2000a.

Then, in the NN model compilation and processing step S140, the input NN model is compiled according to the selected compilation option, and the compiled machine code and the evaluation dataset are input to the selected neural processing unit within the NPU farm for processing.

If a retraining option is selected in the compilation option, retraining of the NN model may be performed in retraining step S345. During the retraining, the performance evaluation system 10000 may assign the graphics processing unit 230 to perform retraining on the NN model processing unit 200. For example, in the retraining step S345 of the NN model, the graphical processing unit 230 may receive an NN model applied with the pruning algorithm and/or the quantization algorithm and a training dataset as input to perform retraining. The retraining may be performed on an epoch-by-epoch basis, and several to hundreds of epochs may be performed on the graphics processing unit 230. The retraining option may include a quantization aware retraining option, a quantization aware self-distillation option, a pruning aware retraining option, and a transfer learning option.

In the NN model processing result reporting step S150, the performance evaluation result of the neural processing unit that processed the compiled NN model can be reported. The performance evaluation result report may be stored in the user's account or sent to the user's email address. However, the performance evaluation result can be provided to users in a variety of ways. A performance evaluation result is also treated as user data and may be subject to the security policies that apply to the user data.

In the NN model processing result reporting step S150, it is first determined whether the compiled NN model is capable of being processed by the plurality of neural processing units 2200a. If the compiled NN model cannot be processed by the plurality of neural processing units 2200a, the NN model processing result reporting step S150 may report a layer of the plurality of layers of the NN model that cannot be processed by the plurality of neural processing units 2200a. Then, the layer that cannot be processed by the plurality of neural processing units 2200a may be processed by the graphics processing unit 230. If the compiled NN model can be processed by the plurality of neural processing units 2200a, the NN model processing result reporting step S150 may report the processing performance of the plurality of neural processing units 2200a.

The parameters of processing performance may be a temperature profile of the neural processing unit, power consumption (Watt), trillion operations per second per Watt (TOPS/W), frame per second (FPS), inference per second (IPS), accuracy, and the like.

According to another example of the present disclosure, a user can quickly determine whether a user's NN model is operable on a particular NPU before purchasing the particular NPU.

According to another example of the present disclosure, a user can quickly determine, prior to purchasing a particular NPU, how a user's NN model will perform when running on a particular NPU.

According to another example of the present disclosure, if each NPU is connected via a server for each type of NPU, the user can evaluate the user's NN model online and receive a result for each NPU available for purchase.

According to another example of the present disclosure, an NN model retraining algorithm optimized for a particular neural processing unit can be performed online via the performance evaluation system 10000. In this case, user data can be separated and protected from the operator of the performance evaluation system 10000 by the security policies described above.

Thus, the performance evaluation system 10000 can provide the user with information on the performance and price of the neural processing unit required to implement the AI service developed by the user, which can help the user make a quick purchase decision.

According to an example of the present disclosure, a neural network (NN) system may be provided. The NN system may comprise: a plurality of neural processors comprising a first neural processor of a first configuration and a second neural processor of a second configuration different from the first configuration; one or more operating processors; and memory storing instructions thereon, the instructions when executed by the one or more operating processors cause the one or more operating processors to: receive an NN model, first selection of one or more neural processors including at least one of the first neural processor or the second neural processor for instantiating the NN model, and compilation options, instantiate at least one layer of the NN model on the first one or more selected neural processors by compiling the NN model according to the compilation options, perform processing on one or more evaluation datasets by the first one or more selected neural processors instantiating the at least one layer of the NN model, and generate one or more first performance parameters associated with processing of the one or more evaluation datasets by the first one or more selected neural processors instantiating at least one layer of the NN model.

The NN system may comprise a computing device, the computing device may comprise: one or more processors, and memory storing instruction thereon, the instructions causing the one or more processors to: receive the first selection of the one or more neural processors, the one or more evaluation datasets, and the compilation options from a user device via a network, send the first selection of the one or more neural processors, the one or more evaluation datasets, and the compilation options to the one or more operating processors, receive the one or more first performance parameters from the one or more operating processors, and send the received one or more first performance parameters to the user device via the network.

The instructions may cause the one or more processors to protect the one or more evaluation datasets by at least one of data encryption, differential privacy, and data masking.

The compilation options may comprise selection on using at least one of a quantization algorithm, a parameter refinement algorithm, an outlier alleviation algorithm, a pruning algorithm, a retraining algorithm, a model compression algorithm, an artificial intelligence (AI) based model optimization algorithm, or a knowledge distillation algorithm to improve performance of the NN model.

At least the first neural processor may comprise internal memory and a multiply-accumulator, and wherein the instructions further cause the one or more operating processors to automatically set the at least one of the compilation options based on the first configuration.

The instructions may further cause the one or more processors to: determine whether at least another of layers in the NN model is operable using the first one or more selected neural processors.

The instructions may further cause the one or more processors to: generate an error report responsive to determining that at least the other of the layers in the NN model is inoperable using the first one or more selected neural processors.

The NN system may further comprise a graphics processor configured to process the at least other of the layers in the NN model that is determined to be inoperable using the one or more selected neural processors.

The graphics processor may be further configured to perform retraining of the NN model for instantiation on the first one or more selected neural processors.

The one or more first performance parameters may comprise at least one of: temperature profile, power consumption, a number of operations per second per watt, frame per second (FPS), inference per second (IPS), and accuracy of inference or prediction, of the first one or more selected neural processors.

Instructions may further cause the one or more operating processors to: receive second selection of one or more neural processors including at least one of the first neural processor or the second neural processor for instantiating the NN model, instantiate the at least one layer of the NN model on the second one or more selected neural processors by compiling the NN model; perform processing on the one or more evaluation datasets by the second one or more selected neural processors instantiating the at least one layer of the NN model, and generate one or more second performance parameters associated with processing of the one or more evaluation datasets by the second one or more selected neural processors instantiating the at least one layer of the NN model.

Instructions may further cause the one or more operating processors to: generate recommendation on the first selection of one or more neural processors or the second selection of one or more neural processors by comparing the one or more first performance parameters and the one or more second performance parameters, and send the recommendation to a user terminal.

The received compilation options may represent one of a plurality of preset options representing combinations of applying of (i) a post training quantization (PTQ), (ii) a layer-wise retraining of the NN model, and (iii) a quantization aware retraining (QAT).

According to an example of the present disclosure, a method may be provided. The method may comprise: receiving, by one or more operating processors, a neural network (NN) model, selection of one or more neural processors including at least one of the first neural processor or the second neural processor for instantiating the NN model, and compilation options via a network, the first neural network processor of a first configuration and the second neural processor of the second configuration different from the first configuration; instantiating at least one layer of the NN model on the first one or more selected neural processors by compiling the NN model according to the compilation options; performing processing on one or more evaluation datasets by the first one or more selected neural processors instantiating the at least one layer of the NN model; generating one or more first performance parameters associated with processing of the one or more evaluation datasets by the first one or more selected neural processors instantiating at least one layer of the NN model; and sending the generated one or more first performance parameters via the network.

The method may further comprise: receiving, by a computing device, the first selection of the one or more neural processors, the one or more evaluation datasets, and the compilation options from a user device; sending the first selection of the one or more neural processors, the one or more evaluation datasets, and the compilation options to the one or more operating processors; receiving the one or more first performance parameters sent from the one or more operating processors, and sending the received one or more first performance parameters to the user device via the network.

The method may further comprise: performing at least one of data encryption, differential privacy, and data masking on the one or more evaluation datasets by the computing device.

The compilation options may comprise selection on using at least one of a quantization algorithm, a parameter refinement algorithm, an outlier alleviation algorithm, a pruning algorithm, a retraining algorithm, a model compression algorithm, an artificial intelligence (AI) based model optimization algorithm, or a knowledge distillation algorithm to improve performance of the NN model.

The method may further comprise automatically setting the at least one of the compilation options based on the first configuration or the second configuration.

The method may further comprise: generating an error report responsive to determining that at least another of the layers in the NN model is inoperable using the first one or more selected neural processors.

The method may further comprise: processing at least another of the layers in the NN model by a graphics processor responsive to the other of the layers determined to be inoperable using the one or more selected neural processors.

The method may further comprise: performing, by a graphics processor, retraining of the NN model for instantiation on the first one or more selected neural processors.

The one or more first performance parameters may comprise at least one of: temperature profile, power consumption, a number of operations per second per watt, frame per second (FPS), inference per second (IPS), and accuracy of inference or prediction, of the first one or more selected neural processors.

The method may further comprise: receiving, by the one or more operating processors, second selection of one or more neural processors including at least one of the first neural processor or the second neural processor for instantiating the NN model, instantiating the at least one layer of the NN model on the second one or more selected neural processors by compiling the NN model; performing processing on the one or more evaluation datasets by the second one or more selected neural processors instantiating the at least one layer of the NN model, and generating one or more second performance parameters associated with processing of the one or more evaluation datasets by the second one or more selected neural processors instantiating the at least one layer of the NN model.

The method may further comprise: generating recommendation on the first selection of one or more neural processors or the second selection of one or more neural processors by comparing the one or more first performance parameters and the one or more second performance parameters, and sending the recommendation to a user terminal.

The compilation options may represent one of a plurality of preset options representing combinations of applying of (i) a post training quantization (PTQ), (ii) a layer-wise retraining of the NN model, and (iii) a quantization aware retraining (QAT).

According to an example of the present disclosure, a method may be provided. The method may comprise: displaying options for selecting one or more neural processors including a first neural processor of a first configuration and a second neural processor of a second configuration different from the first configuration; receiving a first selection of the one or more neural processors for instantiating at least one layer of a neural network (NN) model from a user; displaying compilation options associated with compilation of the NN model for instantiation the at least one layer; receiving first selection of the compilation options from the user; sending the first selection, the selected compilation options, and one or more evaluation datasets to a computing device coupled to the one or more neural processors; receiving one or more first performance parameters associated with processing of the one or more evaluation datasets by the first selection of one or more neural processors instantiating at least one layer of the NN model using the first selected compilation options; and displaying the one or more first performance parameters.

The method may further comprise: receiving second selection of the one or more neural processors from the user; receiving second selection of the compilation options from the user; sending the second selection and the selected compilation options to the computing device coupled to the one or more neural processors; and receiving one or more second performance parameters associated with processing of the one or more evaluation datasets by the second selection of one or more neural processors instantiating at least one layer of the NN model using the second selected compilation options.

The method may further comprise: receiving recommendation on use of the first selection of the one or more neural processors or the second selection of the one or more neural processors; and displaying the recommendation.

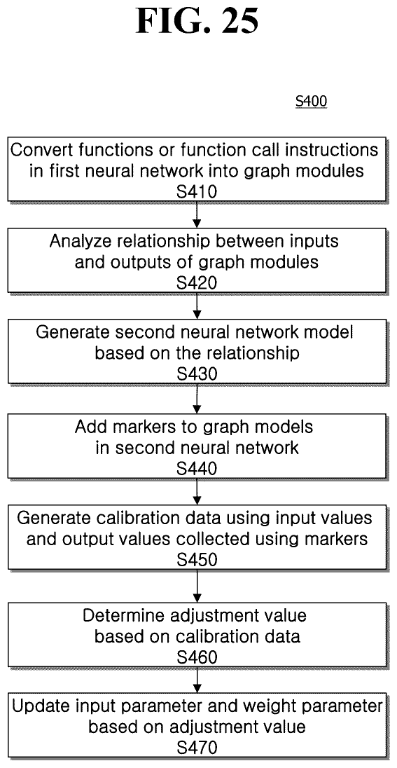

FIG. 25 is a flowchart illustrating a method S400 of updating a neural network model for improved performance, according to another example of the present disclosure. Functions or function call instructions of a first neural network (NN) model may be converted S410 into graph modules.

The relationship between inputs and outputs of the graph modules is analyzed S420. A second neural network (NN) model in a form of a directed acyclic graph (DAG) is generated S430 using the plurality of graph modules corresponding to the first NN model, by mapping the one or more inputs and the one or more outputs of the plurality of graph modules to each other based on the relationship.

Markers are added S440 to the graph modules in the second NN model. A calibration data is generated S450 by collecting input values and output values of each of the graph modules using the markers. An adjustment value for outlier alleviation for each of the graph modules is determined S460 based on the calibration data. For each graph module of the second NN model, an input parameter and a weight parameter are updated S470 based on the adjustment value.

Various modifications may be made to the method of FIG. 25. For example, steps of converting S410 the function or function call instructions may be performed in parallel with analyzing S420 the relationship between the inputs and the outputs of the graph modules.

The plurality of graph modules may include a multiply and accumulate (MAC) operation with the input parameter and the weight parameter as operands.

A MAC operation result of each of the plurality of graph modules may be the same as a MAC operation result with an updated input parameter and an updated weight parameter as operands.

The method may include calculating the adjustment value using a maximum of absolute values for each channel of the input parameter and a maximum of absolute values for each channel of the weight parameter. The adjustment value may be a set comprising a plurality of constant values for the input parameter and the weight parameter. A number of elements in the set of the adjustment value may correspond to a number of channels of the input parameter and the weight parameter.

The adjustment value may be obtained by a mathematical formula:

$$adPi = \sqrt{\frac{\vert {Amax}_{i} \vert}{\vert {Wmax}_{i} \vert}} ,$$

wherein adPi may be an adjustment value for channel i, Amaxi may mean a maximum value among absolute values of all elements of the channel i of the input parameter, and Wmaxi may means a maximum value among absolute values of all elements of the channel i of the weight parameter.

The updating, for each graph module of the second NN model, an input parameter and a weight parameter based on the adjustment value may be configured to multiply the input parameter of each graph module by a reciprocal of the adjustment value, and multiply the weight parameter by the adjustment value.

The method may include generating a second calibration data by collecting input values and output values of each of the plurality of graph modules according to a dataset for calibration using the plurality of markers, and determining a scale value and an offset value applicable to the second neural network model based on the second calibration data.

The scale value and the offset value may be obtained by an equation below,

$$scale = \frac{max - min}{{2}^{bitwidth} - 1} , offset = \frac{- min}{scale} ,$$

where max may mean a maximum value among the input values and output values collected for the second calibration data, min may mean a minimum value among the input values and output values collected for the second calibration data, and bitwidth may mean a target quantization bitwidth.

A convolution operation in the second NN model may be expressed as:

$${feature\_out}_{fp} = ( ⌊ \frac{{feature\_in}_{fp} - {o}_{f}}{{s}_{f}} ⌋ \times {s}_{f} + {o}_{f} ) ⊗ ⌊ \frac{{weight}_{fp}}{{s}_{w}} ⌋ \times {s}_{w}$$

where feature_in_{fp} may represent an input feature map parameter in a form of floating-point, weight_{fp} may represent a weight parameter in a form of floating-point, of may represent the offset value for an input feature map, s_{f} may represent the scale value for the input feature map, s_{w} may represent the scale value for a weight, and └ ┘ may represent round and clip operations.

The method may include generating, based on the scale value and the offset value, a third neural network (NN) model comprising a quantized weight parameter in a form of integer, based on the second NN model.

A convolution operation in the third NN model may be expressed as:

$${feature\_out}_{int} = {feature\_in}_{int} ⊗ {weight}_{int}$$

where feature_outᵢₙₜ may represent an output feature map parameter in a form of integer, feature_inᵢₙₜ may represent an input feature map parameter in a form of integer, and weightᵢₙₜ may represent a weight parameter in a form of integer.

According to one example of the present disclosure, a method may be provided. The method may include adding a plurality of markers to a plurality of graph modules included in a neural network (NN) model in a form of a directed acyclic graph (DAG), collecting input values and output values of each of the plurality of graph modules using the plurality of markers so as to generate calibration data, calculating, based on the calibration data, an adjustment value for outlier adjustment for each of the plurality of graph modules, and updating, for each graph module of the NN model, an input parameter and a weight parameter based on the adjustment value.

The plurality of graph modules may include a multiply and accumulate (MAC) operation with the input parameter and the weight parameter as operands.

A MAC operation result of each of the plurality of graph modules may be the same as a MAC operation result with an updated input parameter and an updated weight parameter as operands.

The method may include calculating the adjustment value using a maximum of absolute values for each channel of the input parameter and a maximum of absolute values for each channel of the weight parameter.

The adjustment value may be a set comprising a plurality of constant values for the input parameter and the weight parameter, and a number of elements in the set of the adjustment value may correspond to a number of channels of the input parameter and the weight parameter.

The adjustment value may be obtained by a mathematical formula:

$$adPi = \sqrt{\frac{\vert {Amax}_{i} \vert}{\vert {Wmax}_{i} \vert}} ,$$

wherein adPi may be an adjustment value for channel i, Amaxi may mean a maximum value among absolute values of all elements of the channel i of the input parameter, and Wmaxi may mean a maximum value among absolute values of all elements of the channel i of the weight parameter.

The updating, for each graph module of the NN model, an input parameter and a weight parameter based on the adjustment value may be configured to multiply the input parameter of each graph module by a reciprocal of the adjustment value, and multiply the weight parameter by the adjustment value.

According to one example of the present disclosure, a non-volatile computer-readable storage medium storing instructions may be provided. The non-volatile computer-readable storage medium storing instructions, the instructions, when executed by one or more processors, causing the one or more processors to perform steps may comprise adding a plurality of markers to a plurality of graph modules included in a neural network (NN) model in a form of a directed acyclic graph (DAG), collecting input values and output values of each of the plurality of graph modules using the plurality of markers so as to generate calibration data, determining, based on the calibration data, calculate an adjustment value for outlier adjustment for each of the plurality of graph modules, and updating, for each graph module of the NN model, an input parameter and a weight parameter based on the adjustment value.

According to the present disclosure a method may be provided. The method may comprise: converting a plurality of functions or function call instructions of a first neural network (NN) model into a plurality of graph modules; analyzing a relationship between one or more inputs and one or more outputs of the plurality of graph modules; generating a second neural network (NN) model in a form of a directed acyclic graph (DAG) using the plurality of graph modules corresponding to the first NN model, by mapping the one or more inputs and the one or more outputs of the plurality of graph modules to each other based on the relationship; adding a plurality of markers to the plurality of graph modules in the second NN model; generating calibration data by collecting input values and output values of each of the plurality of graph modules using the plurality of markers; determining, based on the calibration data, a scale value and an offset value applicable to the second NN model; and determining, for each graph module of the second NN model, an updated value for the scale value or the offset value by performing a quantization simulation for one or more candidates among update candidates of the scale value or the offset value.

The method may further comprise determining the updated value for the scale value or the offset value from a first graph module to a last graph module of the plurality of graph modules, based on the relationship between each graph module included in the second NN model.

The method may further comprise first determining the updated value for the offset value for the plurality of graph modules included in the second NN model, and then determining the updated value for the scale value for the second NN model reflecting the updated value for the offset value for each of the plurality of graph modules.

The method may further comprise: calculating a cosine similarity of a first computation result value of each graph module of the second NN model and a second computation result value of performing the quantization simulation using each candidate included in the update candidates, and selecting the candidate with a highest cosine similarity value included in the update candidates as the updated value.

The cosine similarity may be calculated after performing dequantization on a result of the quantization simulation using each of the update candidates.

The update candidates for the scale value may be selected according to a predetermined number within a certain range comprising the scale value.

The update candidates for the offset value may be selected from a predetermined number within a certain range comprising the offset value.

The update candidates for the scale value may include the scale value and the update candidates for the offset value may include the offset value.

The scale value may be generated for an input parameter, an output parameter, and a weight parameter of the plurality of graph modules, respectively.

The offset value may be generated for the input parameter and the output parameter of the plurality of graph modules, respectively.

The scale value and the offset value may be obtained by an equation below,

$$scale = \frac{max - min}{{2}^{bitwidth} - 1} , offset = \frac{- min}{scale} ,$$

where max means the maximum value among the input values and output values collected for the calibration data, min means the minimum value among the input values and output values collected for calibration data, and bitwidth means a target quantization bitwidth.

A convolution operation in the second NN model may be expressed as:

$${feature\_out}_{fp} = ( ⌊ \frac{{feature\_in}_{fp} - {o}_{f}}{{s}_{f}} ⌋ \times {s}_{f} + {o}_{f} ) ⊗ ⌊ \frac{{weight}_{fp}}{{s}_{w}} ⌋ \times {s}_{w}$$

where feature_in_{fp} represents an input feature map parameter in a form of floating-point, weight_{fp} represents a weight parameter in a form of floating-point, of represents the offset value for the input feature map, s_{f} represents the scale value for the input feature map, s_{w} represents the scale value for the weight, and └ ┘ represents the round and clip operations.

The method may further comprise: generating, based on the updated values of the scale value and the offset value, a third neural network (NN) model comprising a quantized weight parameter in a form of integer, based on the second NN model.

A convolution operation in the third NN model may be expressed as:

$${feature\_out}_{int} = {feature\_in}_{int} ⊗ {weight}_{int}$$

where feature_outᵢₙₜ represents an output feature map parameter in a form of integer, feature_inᵢₙₜ represents an input feature map parameter in a form of integer and weightᵢₙₜ represents a weight parameter in a form of integer.

According to the present disclosure a method may be provided. The method may comprise: adding a plurality of markers to a plurality of graph modules included in a neural network (NN) model in a form of a directed acyclic graph (DAG); collecting input values and output values of each of the plurality of graph modules using the plurality of markers so as to generate calibration data; determining, based on the calibration data, a scale value and an offset value applicable to the NN model; and determining an updated value for the scale value or the offset value by performing a quantization simulation of one or more candidates among update candidates for the scale value or the offset value for each graph module of the NN model.

The method may further comprise: determining the updated value for the scale value or the offset value from a first graph module to a last graph module of the plurality of graph modules, based on a connective relationship between each graph module included in the second NN model.

The method may further comprise: first determining the updated value for the offset value for the plurality of graph modules included in the NN model, and then determining the updated value for the scale value for the NN model reflecting the updated value for the offset value for each of the plurality of graph modules.

The method may further comprise: calculating a cosine similarity of a first computation result value of each graph module of the NN model and a second computation result value of performing the quantization simulation using each candidate included in the update candidates, and selecting the candidate with a highest cosine similarity value included in the update candidates as the updated value.

The cosine similarity may be calculated after performing dequantization on a result of the quantization simulation using each of the update candidates.

The update candidates for the scale value may be selected according to a predetermined number within a certain range comprising the scale value.

The update candidates for the offset value may be selected from a predetermined number within a certain range comprising the offset value.

The scale value may be generated for an input parameter, an output parameter, and a weight parameter of the plurality of graph modules, respectively.

The offset value may be generated for the input parameter and the output parameter of the plurality of graph modules, respectively.

According to the present disclosure, a non-volatile computer-readable storage medium storing instructions may be provided. The instructions, when executed by one or more processors, causing the one or more processors to perform steps may comprise: adding a plurality of markers to a plurality of graph modules included in a neural network (NN) model in a form of a directed acyclic graph (DAG); collecting input values and output values of each of the plurality of graph modules using the plurality of markers so as to generate calibration data; determining, based on the calibration data, a scale value and an offset value applicable to the NN model; and determining an updated value for the scale value or the offset value by performing a quantization simulation of one or more candidates among update candidates for the scale value or the offset value for each graph module of the NN model.
[National R&D Project Supporting This Invention]
[Project Identification Number] 1711195792
[Task Number] 00228938
[Name of Ministry] Ministry of Science and ICT
[Name of Task Management (Specialized) Institution] Institute of Information & Communications Technology Planning & Evaluation
[Research Project Title] Development of Unified Software Flatform of Semiconductor Technology Applicable for Artificial Intelligence
[Research Task Name] Development of Software Flatform to develop a Semiconductor in form of System On-Chip (SoC) for Commercial Edge Artificial Intelligence (AI)
[Contribution rate] 1/1
[Name of the organization performing the task] DeepX Co., Ltd.
[Research Period] 2023.04.01˜2023.12.31

What is claimed is:

1. A method comprising:
converting one or more functions or function call instructions of a first neural network (NN) model into one or more graph modules, one or more inputs and outputs of the one or more graph modules being traceable;
analyzing a relationship between the one or more inputs and the one or more outputs of the one or more graph modules;
generating a second neural network (NN) model including the one or more graph modules as one or more nodes of a directed acyclic graph (DAG) by coupling the one or more inputs and outputs of the graph modules according to the relationship;
adding one or more markers for collecting values from at least part of the one or more inputs and outputs of the one or more graph modules in the second NN model;
generating a first calibration data by analyzing the collected values;
determining, based on the first calibration data, an adjustment value to mitigate outliers for at least one of the graph modules; and
updating an input parameter and a weight parameter for the at least one of the graph modules of the second NN model into an updated input parameter and an updated weight parameter based on the adjustment value to improve performance of the second NN model.

2. The method of claim 1, wherein the at least one of the graph modules performs a multiply and accumulate (MAC) operation using the updated input parameter and the updated weight parameter as operands.

3. The method of claim 2, wherein a result of the MAC operation by the at least one of the graph modules using the input parameter and the weight parameter as operands and is the same as the MAC operation result using the updated input parameter and the updated weight parameter as operands.

4. The method of claim 1, wherein the adjustment value is determined using a maximum of absolute values for each channel of the input parameter and a maximum of absolute values for each channel of the weight parameter.

5. The method of claim 4,
wherein the adjustment value is a set comprising a plurality of constant values for the input parameter and the weight parameter, and
wherein a number of elements in the set of the adjustment value corresponds to a number of channels of the input parameter and the weight parameter.

6. The method of claim 4,
wherein the adjustment value is obtained by a mathematical formula:
$$adPi = \sqrt{\frac{\vert {Amax}_{i} \vert}{\vert {Wmax}_{i} \vert}} ,$$
wherein adPi is an adjustment value for channel i, Amaxi represents a maximum value among absolute values of all elements of the channel i of the input parameter, and Wmaxi represents a maximum value among absolute values of all elements of the channel i of the weight parameter.

7. The method of claim 6, wherein the updated input parameter is multiplication of the input parameter by a reciprocal of the adjustment value, and the updated weight parameter is multiplication of the weight parameter by the adjustment value.

8. The method of claim 1, further including:
generating a second calibration data by collecting input values and output values of the at least one of the graph modules according to a dataset for calibration using corresponding ones of the one or more markers; and
determining a scale value and an offset value applicable to the second NN model based on the second calibration data.

9. The method of claim 8,
wherein the scale value and the offset value are obtained by an equation below,
$$scale = \frac{max - min}{{2}^{bitwidth} - 1} , offset = \frac{- min}{scale} ,$$
where max represents a maximum value among the input values and output values collected for the second calibration data, min represents a minimum value among the input values and output values collected for the second calibration data, and bitwidth represents a target quantization bitwidth.

10. The method of claim 1, wherein a convolution operation in the second NN model is expressed as:
$${feature\_out}_{fp} = ( ⌊ \frac{{feature\_in}_{fp} - {o}_{f}}{{s}_{f}} ⌋ \times {s}_{f} + {o}_{f} ) ⊗ ⌊ \frac{{weight}_{fp}}{{s}_{w}} ⌋ \times {s}_{w}$$
where feature_in_{fp} represents an input feature map parameter in a form of floating-point, weight_{fp} represents a weight parameter in a form of floating-point, of represents an offset value for an input feature map, s_{f} represents a scale value for the input feature map, s_{w} represents the scale value for a weight, and └ ┘ represents a round and clip operation.

11. The method of claim 8, further comprising:
generating, based on the scale value and the offset value, a third neural network (NN) model comprising a quantized weight parameter in as an integer, based on the second NN model.

12. The method of claim 11, wherein a convolution operation in the third NN model is expressed as:
$${feature\_out}_{int} = {feature\_in}_{int} ⊗ {weight}_{int}$$
where feature_outᵢₙₜ represents an output feature map parameter as an integer, feature_inᵢₙₜ represents an input feature map parameter as an integer, and weightᵢₙₜ represents a weight parameter as an integer.

13. A method comprising:
adding at least one marker to at least one input or output of graph modules included in a neural network (NN) model as nodes of a directed acyclic graph (DAG);
collecting input values or output values by the at least one marker to generate calibration data;
determining, based on the calibration data, an adjustment value to mitigate outliers for the graph modules; and
updating an input parameter and a weight parameter of at least one of the graph modules into an updated input parameter and an updated weight parameter based on the adjustment value.

14. The method of claim 13, wherein the at least one of the graph modules perform a multiply and accumulate (MAC) operation with the updated input parameter and the updated weight parameter as operands.

15. The method of claim 14, wherein a result of the MAC operation by the at least one of the graph modules using the input parameter and the weight parameter as operands and is the same as the MAC operation result using the updated input parameter and the updated weight parameter as operands.

16. The method of claim 13, wherein the adjustment value is determined using a maximum of absolute values for each channel of the input parameter and a maximum of absolute values for each channel of the weight parameter.

17. The method of claim 16,
wherein the adjustment value is a set comprising a plurality of constant values for the input parameter and the weight parameter, and
wherein a number of elements in the set of the adjustment value corresponds to a number of channels of the input parameter and the weight parameter.

18. The method of claim 16, wherein the adjustment value is obtained by a mathematical formula:
$$adPi = \sqrt{\frac{\vert {Amax}_{i} \vert}{\vert {Wmax}_{i} \vert}} ,$$
wherein adPi is an adjustment value for channel i, Amaxi represents a maximum value among absolute values of all elements of the channel i of the input parameter, and Wmaxi represents a maximum value among absolute values of all elements of the channel i of the weight parameter.

19. The method of claim 18, wherein the updated input parameter is multiplication of the input parameter by a reciprocal of the adjustment value, and the updated weight parameter is multiplication of the weight parameter by the adjustment value.

20. A non-transitory computer-readable storage medium storing instructions, the instructions, when executed by one or more processors, causing the one or more processors to perform steps comprising:
adding at least one marker to at least one input or output of graph modules included in a neural network (NN) model as nodes of a directed acyclic graph (DAG);
collecting input values or output values by the at least one marker to generate calibration data;
determining, based on the calibration data, an adjustment value to mitigate outliers for the graph modules; and
updating an input parameter and a weight parameter of at least one of the graph modules into an updated input parameter and an updated weight parameter based on the adjustment value.
